(19) United States
(12) Patent Application Publication
(10) Pub. No.: US 2025/0105752 A1
(43) Pub. Date: Mar. 27, 2025

(54) Systems and Methods for Power Conversion Using Controllable Converters

(71) Applicant: The Trustees of Columbia University in the City of New York, New York, NY (US)

(72) Inventors: Matthias PREINDL, New York, NY (US); Youssef Amr FAHMY, New York, NY (US); Noah Hillock SILVERMAN, New York, NY (US); Matthew JAHNES, New York, NY (US); Liwei ZHOU, New York, NY (US)

(73) Assignee: The Trustees of Columbia University in the City of New York, New York, NY (US)

(21) Appl. No.: 18/975,635

(22) Filed: Dec. 10, 2024

Related U.S. Application Data
(63) Continuation of application No. PCT/US2023/025142, filed on Jun. 13, 2023.
(60) Provisional application No. 63/351,620, filed on Jun. 13, 2022.
(60) Provisional application No. 63/351,573, filed on Jun. 13, 2022.
(60) Provisional application No. 63/351,630, filed on Jun. 13, 2022.

(51) Int. Cl. H02M 3/335; H02M 1/00

(52) U.S. Cl. CPC H02M 3/33576; H02M 1/0043; H02M 3/33571

(57) ABSTRACT

Disclosed are methods, systems, devices, and other implementations, including a voltage converter system that includes two or more Active Half Bridge (AHB) converter circuits, each of the two or more AHB converter circuits connected to one or more windings of a transformer, with each AHB converter circuit including one or more switches and one or more energy storage devices. The voltage converter system further includes one or more controllers to control electrical behavior of the two or more AHB converter circuits according to normalized switching functions representing the switching states of the switches of the two or more AHB converter circuits.

### CROSS-REFERENCE TO RELATED APPLICATIONS

This application is a continuation of International Application No. PCT/US2023/025142, entitled “Systems and Methods for Power Conversion Using Controllable Converters,” and filed Jun. 13, 2023, which claims the benefit of, and priority to, U.S. Provisional Application No. 63/351,573, entitled “Systems and Methods for Power Conversion Using Multi Active Half Bridge Converters,” and filed Jun. 13, 2022, U.S. Provisional Application No. 63/351,630, entitled “Systems and Methods for a Fully Balanced Vertically Stacked Multilevel Power Conversion” and filed Jun. 13, 2022, and U.S. Provisional Application No. 63/351,620, entitled “Systems And Methods For A Stacked Multilevel Power Delivery System To Power A Load” and filed Jun. 13, 2022, the contents of all of which are incorporated herein by reference in their entireties.

### BACKGROUND

There are several known power conversion configurations or topologies that are used for DC-DC, AC-AC, AC-DC, or DC-AC power conversion. One class of converters includes the Dual Active Bridge (DAB) converters, which are a common choice for bidirectional, isolated DC/DC converters as they can be used in both high and low power applications. DAB converters can also be used for AC to AC power conversion and/or DC-AC power conversion. DABs often utilize soft switching and control optimization techniques to maximize efficiency and power density. Dual Active Half Bridge (DAHBs) converters are a simpler subset of DAB converters that include four capacitors paired with four switches connected by a high frequency transformer. These characteristics lend the DAHB towards efficient operation and wide applications as stand-alone devices and as subcircuits in more complex circuits such as in multilevel converters. In standalone applications, DAHB are often used in low power circuits because, for a given power, fewer paralleled switches lead to higher current per switch when compared with a full bridge. This does not, however, preclude their use in higher power systems. DAHBs have been applied as components of electric vehicle charging circuits, in battery charging applications, microgrids, and auxiliary power sources, making them a useful tool in the effort to electrify infrastructure as a means to mitigate the worst effects of climate change.

Another class of power conversion systems includes multilevel power converters. Increasing the voltage of a power converter up to a certain limit is a straightforward process. Typical (buck, boost, buck/boost) or more exotic (Cuk, SEPIC) single-level topologies can be used until the voltage levels within the converter increase to the limit of what the individual circuit components can handle. Beyond this voltage a multilevel topology is required, as these types of topologies serve to bridge the gap between lower voltage components and higher voltage applications. Multilevel power converters have favorable advantages when compared to single-level power converters. For example, they can operate with higher voltages than individual converters and can also output higher quality waveform signals. For example, by distributing the full voltage across multiple discrete levels, a higher quality output waveform is achieved when switching between multiple discrete levels as opposed to a topology that has only one switched level. However, multilevel converters often have complicated circuit topologies and can have unstable voltage balancing (which refers to the ability of the circuit to maintain a constant desired voltage between levels or across capacitors) across their circuit components. Addressing these two common issues can greatly advance the integration of multilevel power converters into high power technologies, such as electric vehicle charging and electric grids.

### SUMMARY

Disclosed are implementations (including hardware, software, and hybrid hardware/software implementations) directed to controlled voltage conversion and power transfer and/or power delivery based on a voltage conversion topology that includes a stacked arrangement of energy storage elements (e.g., stacked arrangement of capacitors). Control of the transfer of power between elements in the stack (e.g., between various capacitors) is achieved through switch-based controllers (global or dedicated controllers for individual voltage conversion cells), and the controlled actuation (resulting in, for example, varying duty cycles) of the switches in a way that achieved a desired electrical behavior at various point on the stack (e.g., maintaining voltage balance through the series of capacitors, achieving some pre-specified or desired voltage distribution at different points on the stack, adjusting the voltages to generate periodical signaling to control a motor, etc.)

Thus, in some variations, a first voltage converter system is provided that includes two or more Active Half Bridge (AHB) converter circuits, each of the two or more AHB converter circuits connected to one or more windings of a transformer, with each AHB converter circuit including one or more switches and one or more energy storage devices, and one or more controllers to control electrical behavior of the two or more AHB converter circuits according to normalized switching functions representing switching states of switches of the two or more AHB converter circuits.

In some variations, a first voltage conversion method is provided that includes measuring electrical characteristics of a voltage conversion system comprising two or more Active Half Bridge (AHB) converter circuits, with each of the two or more AHB converter circuits connected to one or more windings of a transformer, and with each AHB converter circuit including one or more switches and one or more energy storage devices. The voltage conversion system whose electrical characteristics are being measured also includes one or more controllers coupled to the two or more AHB converter circuits. The first method additionally includes controlling, using the one or more controllers, electrical behavior of the two or more AHB converter circuits according to normalized switching functions representing switching states of switches of the two or more AHB converter circuits.

In some variations, a second voltage converter system is provided that includes a stacked plurality of voltage converter cells, each of the plurality of voltage converter cells comprising at least one capacitor, with the stacked plurality of voltage converter cells defining a configuration of series-connected capacitors, with the at least one capacitor of a first voltage converter cell from the stacked plurality of voltage converter cells being electrically linked to the at least one capacitor of at least a second voltage converter cell from the stacked plurality of voltage converter cells to define at least one power transfer link, and with the first voltage converter cell and the second voltage converter cell being configured to controllably transfer power from the at least one capacitor of the first voltage converter cell, through the power transfer link, to the at least one capacitor of the second voltage converter cell to maintain voltage balance in the stacked plurality of voltage converter cells. The second voltage converter system further includes one or more controllers in communication with the stacked plurality of voltage converter cells, with the one or more controllers being configured to control electric power behavior of the stacked plurality of voltage converters cells to produce a specified output voltage at an output terminal of at least one of the stacked plurality of voltage converter cells.

In some variations, a second voltage conversion method is provided that includes measuring electrical properties of a voltage conversion system comprising a stacked plurality of voltage converter cells, each of the plurality of voltage converter cells comprising at least one capacitor, with the stacked plurality of voltage converter cells defining a configuration of series-connected capacitors, with the at least one capacitor of a first voltage converter cell from the stacked plurality of voltage converter cells being electrically linked to the at least one capacitor of at least a second voltage converter cell from the stacked plurality of voltage converter cells to define at least one power transfer link, and with the first voltage converter cell and the second voltage converter cell being configured to controllably transfer power from the at least one capacitor of the first voltage converter cell, through the power transfer link, to the at least one capacitor of the second voltage converter cell to maintain voltage balance in the stacked plurality of voltage converter cells. The voltage conversion system whose electrical properties are being measured also includes one or more controllers in communication with the stacked plurality of voltage converter cells. The second voltage conversion method further includes controlling, using the one or more controllers, electric power behavior of the stacked plurality of voltage converters cells to produce a specified output voltage at an output terminal of at least one of the stacked plurality of voltage converter cells.

In some variations, a power delivery system is provided that includes multiple stacks of voltage converter cells, each of the multiple stacks comprises one or more voltage converter cells comprising at least one energy storage device, and one or more controllers in communication with the multiple stacks of voltage converter cells, the one or more controllers configured to control electric power behavior of the respective one or more voltage converter cells of the multiple stacks to cause controlled delivery of electric power by the multiple stacks of voltage converter cells. The power delivery system further includes an interactive system (e.g., a multi-phase electrical motor) electrically connected to outputs of the multiple stacks of voltage converter cells, the multiple stacks of voltage converter cells configured for controllable bidirectional power flow to cause the multiple stacks of voltage converter cells to controllably deliver or receive electric power to or from the interactive system.

In some variations, a power delivery method is provided that includes measuring electrical properties of a power delivery system comprising multiple stacks of voltage converter cells, each of the multiple stacks comprises one or more voltage converter cells comprising at least one energy storage device, one or more controllers in communication with the multiple stacks of voltage converter cells, and an interactive system electrically connected to outputs of the multiple stacks of voltage converter cells, with the multiple stacks configured for controllable bidirectional power flow to cause the multiple stacks of voltage converter cells to controllably deliver or receive electric power to or from the interactive system. The method further includes controlling, using the one or more controllers, electric power behavior of the respective one or more voltage converter cells of the multiple stacks to cause controlled bidirectional delivery of electric power between the multiple stacks of voltage converter cells and the interactive system.

Embodiments and variations of any of first and second voltage conversion system, the power delivery system, the first and second voltage conversion method, and the power delivery method may include at least some of the features described in the present disclosure, including at least some of the features described above in relation to the systems and the methods, and all related implementations (computer-readable media, devices, apparatus, etc.) Furthermore, any of the above variations and embodiments of the system and/or methods may be combined with any of the features of any other of the variations of the systems and the methods described herein, and may also be combined with any other of the features described herein.

Other features and advantages of the invention are apparent from the following description, and from the claims.

### BRIEF DESCRIPTION OF THE DRAWINGS

These and other aspects will now be described in detail with reference to the following drawings.

FIG. 1 is a circuit diagram of a dual active half bridge (DAHB) converter and its power flows.

FIG. 2 are waveform plots showing the electrical behavior of various components of a DAHB converter circuit.

FIG. 3 is a table summarizing the DAHB switching timing sequences, including 3D tetrahedron representations of timing sequences.

FIG. 4 includes graphs comparing the modeling as implemented on MATLAB and the Simulink simulation.

FIG. 5 includes a table with graphs showing how the switch mode model described herein is used to predict the capacitor currents and voltages in various switching modes.

FIG. 6 is a circuit diagram of an example converter system with multiple active half bridge circuits (with N>2).

FIG. 7 includes circuit diagrams illustrating a π (PI) 3D-DAHB converter circuit decomposed into two half-bridge converter circuits and a traditional DAHB circuit.

FIG. 8 includes a table summarizing switching sequences of a half bridge topology.

FIG. 9 includes graphs showing half bridge model tracking the current endpoints and beginning of each period, the capacitor currents, and the resulting voltages calculated from the change in charge levels.

FIG. 10 includes graphs showing the model predicting each transition point of the DAHB leakage current waveform, as well as the resulting voltage in each capacitor.

FIG. 11 is a diagram of an example controller to control operation of various voltage converter topologies.

FIG. 12 is a flowchart of an example voltage conversion procedure.

FIG. 13 includes circuit diagrams for a stacked 2-capacitor topology.

FIG. 14 include circuit diagrams showing a buck-boost converter combined with a stacked capacitor topology to effectively transfer power between C1 and C2.

FIG. 15 includes a diagram showing how a 2-capacitor 2-level converter is split into a 4-capacitor 4-level converter.

FIG. 16 is a circuit diagram of an example N-level converter.

FIG. 17 is a graph illustrating Pₜᵣₐₙₛ/Pₒ ratio as a function of voltage conversion ratio Vₒ/Vₛ.

FIG. 18A is a circuit diagram of an 8-capacitor iteration of the stacked-proposed topology using DAHBs to transfer power between capacitances.

FIG. 18B includes a circuit diagram of a Multilevel Full-Bridge (MFB) implementation with DAHBs used as the capacitive power transfer mechanism.

FIG. 19A includes graphs of the performance results of an implementation based on the converter configuration of FIG. 18A.

FIG. 19B includes graphs of the performance results of an implementation based on the converter configuration of FIG. 18B.

FIG. 20 are graphs of Vₒ and I_{Lk} for an 8-capacitor converter with conversion ratio Vₒ/Vₛ=0.4.

FIG. 21 are diagrams of canonical switching cells.

FIG. 22 includes a table listing input and output configurations of canonical switching cells.

FIG. 23 includes a circuit diagram illustrating a reconfiguration of an isolated canonical switching cell into a stacked multilevel non-isolated topology, and a diagram of a canonical switching cell equivalent.

FIG. 24 includes circuit diagrams illustrating the stacking of non-isolated canonical switching cells to achieve a multilevel converter.

FIG. 25 includes circuit diagrams illustrating the transforming/re-configuring of N-level converter circuits into canonical equivalent circuits.

FIG. 26 includes circuit diagrams of multilevel converter circuits for which the canonical switching-cell-based topology was tested.

FIG. 27 includes circuit diagram of Manhattan configuration multilevel topological converters.

FIG. 28 includes diagrams of an 8-level half-bridge (HB) implementation of the Manhattan converter configuration.

FIG. 29 includes diagrams of an 8-level dual active half-bridge (DAHB) implementation of the Manhattan converter configuration.

FIG. 30 includes diagrams showing power flows within the dual active full-bridge (DAFB) and within a dual active half-bridge (DAHB).

FIG. 31 includes diagrams of an 8-level dual active full-bridge (DAFB) implementation of the Manhattan converter configuration.

FIG. 32 includes diagrams of an 8-level dual active half-bridge (DAFB) implementation of the Manhattan converter configuration with a common inductive bus.

FIG. 33 includes circuit diagrams of the DAHB unit cell used for the proposed multilevel topology.

FIG. 34 includes circuit diagrams with examples showing the stacking of unit cells to create a multilevel topology (for use with different control architectures).

FIG. 35 includes diagrams of allowable couplings for stacked unit cells.

FIG. 36 includes diagrams for various circuit representations of a 9-level DAHB converter.

FIG. 37 includes circuit diagrams for example inductive coupling converters.

FIG. 38 includes circuit diagrams for various implementations based on a Manhattan topology.

FIG. 39 includes diagrams of a fully controllable example Manhattan topology comprising three half-bridge capacitive power transfer links.

FIG. 40 includes diagrams of a partially controllable example Manhattan topology comprising two dual-active-full-bridge (DAFB) capacitive power transfer links.

FIG. 41 includes diagrams of a modified partially controllable Manhattan topology (to render the configuration fully controllable) with two dual active full bridge and one half-bridge capacitive transfer links.

FIG. 42 includes graphs of the capacitors' voltage levels and module duty cycles of the controllable Manhattan configuration of FIG. 39.

FIG. 43 includes graphs of the capacitors' voltage levels and the normalized phase difference ϕ of the two DAFB modules during operation of the partially controllable Manhattan configuration of FIG. 40.

FIG. 44 includes graphs of the capacitors' voltage levels and the normalized phase difference ϕ of the two DAFB modules during operation of the modified fully controllable Manhattan configuration of FIG. 41.

FIG. 45 is a flowchart of an example controllable voltage conversion procedure.

FIG. 46 includes diagrams of Manhattan multilevel converters, including a generalized topology with K cells and N levels.

FIG. 47 is a schematic diagram of a software-defined stacked control system for a motor application.

FIG. 48 is a schematic diagram of a top-level stack controller to control operation of a motor.

FIG. 49 is an example 5-cell stacked configuration converter.

FIG. 50 is a flowchart of an example power delivery procedure.

FIG. 51 includes circuit diagrams of the stacked Dual-Active-Half-Bridge Differential Power Converter.

FIG. 52 is a diagram of the control topology of a stacked DAHB DC/DC converter.

FIG. 53 includes graphs showing steady-state waveforms of the stacked DAHB converter, and graphs showing the transient Vₒ step of 10V-90V.

Like reference symbols in the various drawings indicate like elements.

### DESCRIPTION

### A) Power Conversion Using Multi Active Half Bridge Converters

Disclosed are systems, methods, and other implementations (including hardware, software, and hybrid hardware/software implementations) directed to controlling and operating multi active half bridge converters. While the discussion below describes a proposed model for a Dual Active Half Bridge (DAHB) converter that is built up from four switching functions, the model can be extended to a converter system that includes N active half bridges, with N being any integer, in which some of the N active half bridges are arranged as primary side converter circuits (i.e., upstream of a transformer), and the remainder of the N active half bridges arranged as secondary side circuits (i.e., downstream the transformer). For example, a converter system may be implemented using ten active half bridge circuits (i.e., N=10), with five of those circuits arranged as a primary side active half bridge circuits, and five circuits arranged as a secondary side active half bridge circuits.

The switching functions for the DAHB (and for any N active half bridge converter) describe the input signals to the gates of the power transistors. The proposed model(s) discussed herein yields normalized signals that are used to determine voltage values which are then further manipulated to produce a state space model of the inductor and capacitor voltages and currents, two key sets of parameters in describing the DAHB. The model can be generalized to describe all possible switching states, which are defined by the relative order of the turn-on and turn-off switching instances. A matrix-based description of the 24 identified modes is created in which q pairs of binary matrices, along with the inputs and states are used to identify circuit behavior in each mode. In some embodiments of the approaches described herein, additional modes of operation are identified by allowing both the primary and secondary phase shifts to vary.

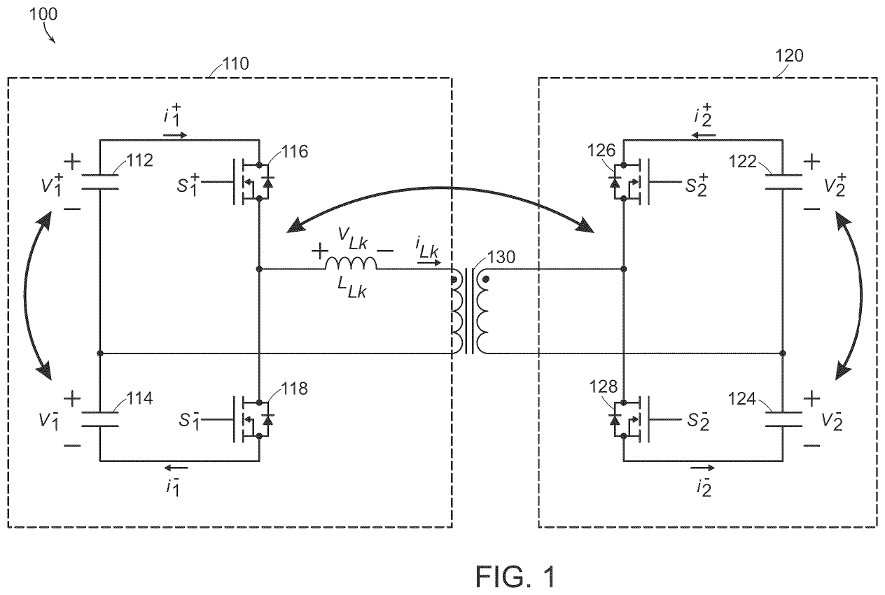

With reference to FIG. 1, a circuit diagram of a dual active half bridge (DAHB) converter 100, and its power flows, are shown. In the dual active half bridge configuration of FIG. 1, the converter includes two active half bridges (AHB) converter circuits with a primary side 110 and a secondary side 120 separated from the primary side by a transformer 130. The primary side includes two primary side capacitors 112 and 114, two primary side controllable switching devices 116 and 118 (actuated by a signal controller that is not shown in FIG. 1), and the secondary side includes two secondary side capacitors 122 and 124, and two secondary side switching devices 126 and 128. The dual active half bridge converter is a special case of the more general converter configuration that includes more than two active half bridge circuits, with some of the AHB circuits being electrically coupled to the primary side windings of a transformer, and the other AHB circuits being electrically coupled to the secondary side windings of the transformer (such as the transformer 130 of FIG. 1).

In the DAHB converter 100, the arrangements of the two switching devices on either side of the transformer 130 define switching stacks of the converter 100. A change in state at a specific time, such as by a switch, can be represented by the function γ(t) which is defined as follows:

$$γ ( t ) = \{ \begin{matrix}0 , & t < 0 \\ 1 & t \geq 0\end{matrix} \qquad ( A 1 )$$

The above expression is known as the Heaviside step function. In power electronic circuits, where switches tend to be arranged in a series stack, the upper and lower switches are assumed to be complementary i.e., when one is on the other is off. To create pulse wave modulated (PWM) or similar signals that will be used to control the AHB-based converter (be it a dual AHB or otherwise), the switching period, T, is defined to have two switching events per stack. The switching sequence for a switching stack ξ can be expressed functionally as follows:

$${s}_{ξ} ( t , {t}_{ξ}^{+} , {t}_{ξ}^{-} ) = γ ( t - {t}_{ξ}^{+} ) - γ ( t - {t}_{ξ}^{-} ) + γ ( {t}_{ξ}^{+} - {t}_{ξ}^{-} ) , \qquad ( A2 )$$

where t_{ξ}⁺∈[0, T] is the upper switch's turn on instance and t_{ξ}⁻ is its turn off instance.

The last term in the above equation ensures that the value of the switching function is always between zero and one by providing an offset only when the sequence of switching events is ON-OFF-ON. When it is OFF-ON-OFF, the sequence naturally lies in the appropriate range. The above definition of the switching function assumes that there are negligible dead, rise, and fall times, meaning the above function fully describes the behavior of a switching stack over one period.

When a switch is high, the voltage across the corresponding capacitor is shorted through it. If the capacitor is large enough the voltage across it will not change much over one period and can be approximated as constant in that range. Given the arrangement of a single stack, the voltage at the output alternates two times in one period between two different values: the positive voltage of the upper capacitor and the negative voltage of the lower capacitor. The output voltage is therefore the waveform:

$${v}_{ξ} ( t , {t}_{ξ}^{+} , {t}_{ξ}^{-} ) = {V}_{ξ}^{+} {s}_{ξ} ( t , {t}_{ξ}^{+} , {t}_{ξ}^{-} ) - {V}_{ξ}^{-} ( 1 - {s}_{ξ} ( t , {t}_{ξ}^{+} , {t}_{ξ}^{-} ) ) \qquad ( A3 )$$

In the case of the DAHB, there are two sets of complementary switches, meaning there are four switching events that divide the period into five generally unequal segments. Since there are an even number of events, there will be at most just four distinct voltages; the value of the first and last will always be the same. If the magnetizing inductance of the transformer is neglected, which can be assumed for well magnetically coupled circuits with ferric cores, the capacitors' voltages are applied to opposite sides of the transformer leakage inductance. The leakage inductance voltage values are given by the difference in the primary and secondary side switching stack, represented as the difference:

$${v}_{Lk} ( t ) = {V}_{1}^{+} {s}_{1} ( t , {t}_{1}^{+} , {t}_{1}^{-} ) - {V}_{1}^{-} ( 1 - {s}_{1} ( t , {t}_{1}^{+} , {t}_{1}^{-} ) ) - ( {V}_{2}^{+} {s}_{2} ( t , {t}_{2}^{+} , {t}_{2}^{-} ) - {V}_{2}^{-} ( 1 - {s}_{2} ( t , {t}_{2}^{+} , {t}_{2}^{-} ) ) ) . \qquad ( A4 )$$

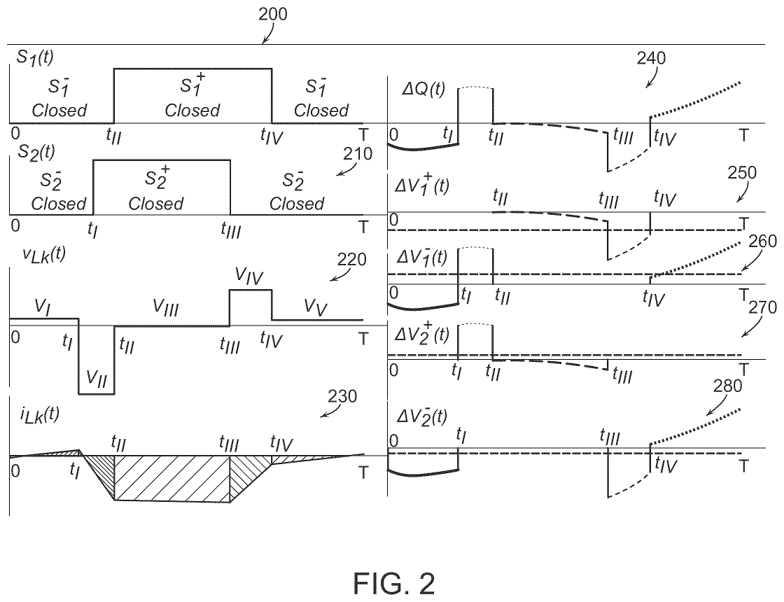

An example of the two switching functions and the resulting leakage inductor voltage is given in FIG. 2 that includes plots 200 and 210 showing how the function s₁ and s₂ are scaled and subtracted to form the leakage inductor voltage waveform. The voltage waveform represented by Equation (A4) can be integrated over the period to generate the leakage inductor current. The Inductor current resulting from the switching functions forms the following piecewise affine function:

$${i}_{Lk} ( t ) = {i}_{Lk} ( 0 ) + {\int }_{0}^{t} {v}_{Lk} ( t ) dt = \{ \begin{matrix}{i}_{Lk} ( 0 ) + \frac{1}{{L}_{Lk}} \frac{{V}_{I}}{{L}_{Lk}} t , & 0 < t \leq {t}_{I} \\ {i}_{Lk} ( {t}_{I} ) + \frac{{V}_{II}}{{L}_{Lk}} ( t - {t}_{I} ) , & {t}_{I} < t \leq {t}_{II} \\ {i}_{Lk} ( {t}_{II} ) + \frac{{V}_{III}}{{L}_{Lk}} ( t - {t}_{II} ) , & {t}_{II} < t \leq {t}_{III} \\ {i}_{Lk} ( {t}_{III} ) + \frac{{V}_{IV}}{{L}_{Lk}} ( t - {t}_{III} ) , & {t}_{III} < t \leq {t}_{IV} \\ {i}_{Lk} ( {t}_{IV} ) + \frac{{V}_{V}}{{L}_{Lk}} ( t - {t}_{Iv} ) , & {t}_{IV} < t \leq T\end{matrix} \qquad ( A5 )$$

where L_{Lk} is the leakage inductance (an example of which is illustrated in plot 230), t_{I} is the first switching instance, V_{I} is the leakage inductor voltage that precedes it (as shown in plot 220 of FIG. 2), and i_{Lk}(0) is the leakage inductor current at the start of the period.

The above currents are piecewise continuous in the inductor but drop to zero in the capacitors when their corresponding switches are not conducting. This can be represented by multiplying the calculated inductor current by the switching function of interest, as follows:

$${i}_{ξ}^{+} ( t ) = {s}_{ξ} ( t , {t}_{ξ}^{+} , {t}_{ξ}^{-} ) {i}_{Lk} ( t ) \qquad ( A6 )$$

$${i}_{ξ}^{-} ( t ) = ( 1 - {s}_{ξ} ( t , {t}_{ξ}^{+} , {t}_{ξ}^{-} ) ) {i}_{Lk} ( t )$$

where i_{ξ}⁺(t) and i_{ξ}⁻(t) are the currents in the upper and lower capacitors respectively of voltage stack ξ. Since the ideal DAHB has two stacks, the current flowing out of one capacitor on the primary side (ξ=1) of the transformer will equal that going into one of the upper or lower capacitors on the secondary side (ξ=2). The calculated currents are now time integrated again to produce the charge moved in each capacitor over one period, shown as

$$Δ {q}_{ξ}^{+} ( t ) = {\int }_{0}^{t} {i}_{ξ}^{+} ( t ) dt \qquad ( A7 )$$

$$Δ {q}_{ξ}^{-} ( t ) = {\int }_{0}^{t} {i}_{ξ}^{-} ( t ) dt$$

resulting in a piecewise quadratic function of time with five segments over the same ranges as in Equation (A5) above. The charge moved corresponds to the shaded areas in the plot 230 for the i_{LK}(t) plot of FIG. 2. These shaded areas form the piecewise quadratic function shown at the top of the second column of FIG. 2 (plot 240). The change in voltage that would occur during the period can be calculated as:

$${Δ V}_{ξ}^{+} = \frac{Δ {q}_{ξ}^{+}}{C} \qquad ( A8 )$$

$${Δ V}_{ξ}^{-} = \frac{Δ {q}_{ξ}^{-}}{C}$$

The individual capacitor voltages are shown in the plots 250-280 of FIG. 2. The capacitor currents, as well as the charges these currents move, can be pictured by selecting the same pieces present on the capacitor voltage waveforms. When controlling the voltage discretely, the net change in voltage per capacitor is taken and applied at the end of each period using a zero order hold. This is shown by the dotted line in each of the capacitor voltage plots.

The above equations are based on the assumption that the order of the switching events is fixed. While true for a single period, over the course of many periods the relative locations of the instances may change as the circuit is controlled. This behavior can be captured by a model that is based om permutation matrices. An initial vector of switching instances for switching stacks S₁ and S₂ is defined as follows:

$${t}_{i} = [ \begin{matrix}{t}_{1}^{+} \\ {t}_{1}^{-} \\ {t}_{2}^{+} \\ {t}_{2}^{-}\end{matrix} ] \qquad ( A9 )$$

where t_{ξ}⁺, t_{ξ}⁻∈[0, T]. These values can be converted from phase shifts and duty cycles of the switches, ϕ_{ξ},θ_{ξ}∈[0,T]. For an OFF-ON-OFF sequence, t_{ξ}⁺=Tϕ_{ξ}, and t_{ξ}⁻=T (ϕ_{ξ}−θ_{ξ}). However, for an ON-OFF-ON sequence, the turn off instance becomes t_{ξ}⁻=T(ϕ_{ξ}+θ_{ξ}−1).

The complementary nature of the switches means that there are four possible combinations of capacitor voltages across the transformer given by:

$${V}_{LK} = \{ \begin{matrix}{V}_{1}^{+} - {V}_{2}^{+} & {S}_{1}^{+} , {S}_{2}^{+} = ON \\ {V}_{1}^{+} - {V}_{2}^{-} & {S}_{1}^{+} , {S}_{2}^{1} = ON \\ - {V}_{1}^{+} - {V}_{2}^{+} & {S}_{1}^{-} , {S}_{2}^{+} = ON \\ - {V}_{1}^{-} - {V}_{2}^{-} & {S}_{1}^{-} , {S}_{2}^{-} = ON\end{matrix} \qquad ( A10 )$$

In order to quantitatively ensure that all possible voltage orderings are achieved, the different switching sequences of the DAHB are identified by considering all permutations of the switching instances. The permutations rearrange the relative locations of the four switching instances given above for tᵢ in 4!=24 ways. The arrangement can be done by applying a permutation matrix Pₘ to the initial ordering, above, of tᵢ, thus providing:

$${t}_{m} = [ \begin{matrix}{t}_{I} \\ {t}_{II} \\ {t}_{III} \\ {t}_{IV}\end{matrix} ] = {P}_{m} {t}_{i} \qquad ( A11 )$$

where m refers to one of 24 switching modes, tₘ is the arranged timing sequence for that mode, and Pₘ∈B^{4×4}, the set of binary 4×4 matrices. No matter the order of the timing instances, the first element of tₘ is always referred to as t_{I}, the second as t_{II}, etc. The permutation matrices are such that P₁=I₄, the 4×4 identity matrix, and all of the other Pₘ matrices are permutations of the rows of the first matrix, resulting in 24 distinct timing vectors.

The tₘ vectors, by definition, satisfy −J₅tₘ≤e₅, where,

$${J}_{5} = [ \begin{matrix}1 & 0 & 0 & 0 \\ - 1 & 1 & 0 & 0 \\ 0 & - 1 & 1 & 0 \\ 0 & 0 & - 1 & 1 \\ 0 & 0 & 0 & - 1\end{matrix} ] , \qquad ( A12 )$$

$${e}_{5} = [ \begin{matrix}0 \\ 0 \\ 0 \\ 0 \\ 1\end{matrix} ]$$

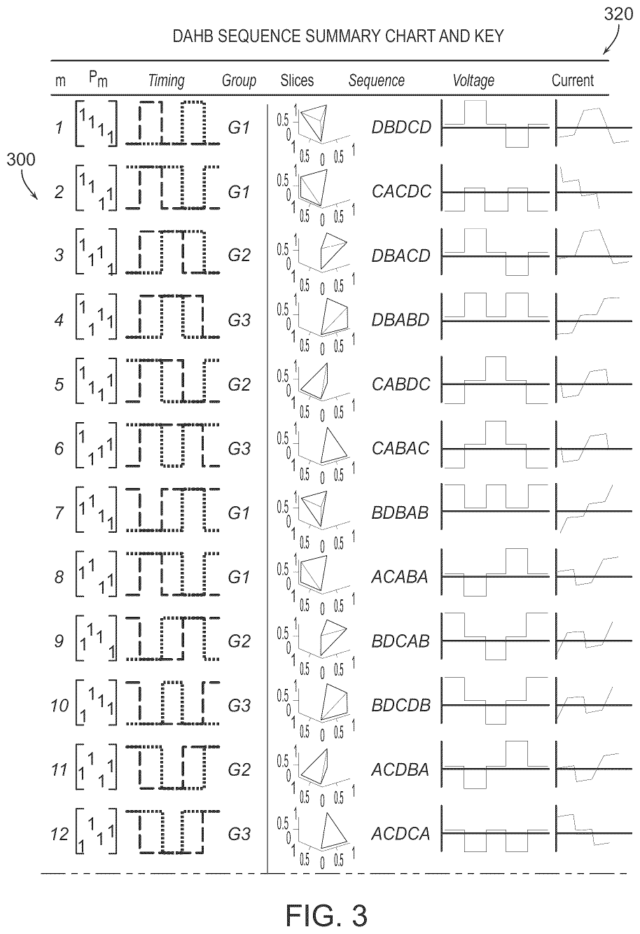

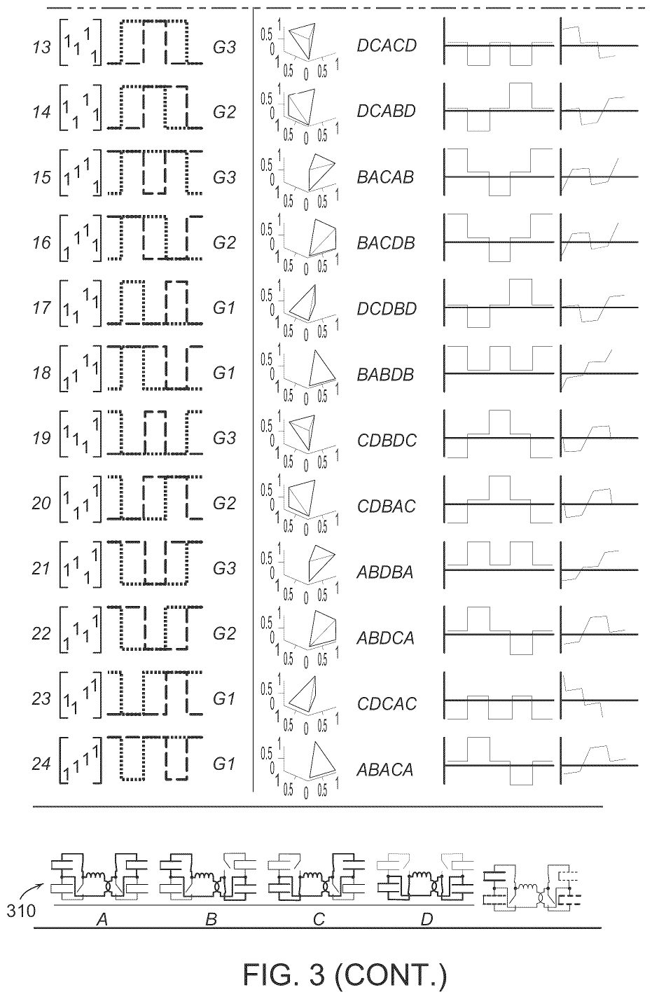

These inequalities are derived by examining the relative positions of the switching instances in each sequence. When the inequality is violated, the DAHB has moved out of that operating mode and into another. For example, by noting the positions of the instances of the waveforms in FIG. 2 and comparing them to tᵢ, one can determine it is in mode 14. The inequalities form a simplex in the four dimensional space defined by the timing instances. This space can be projected into three dimensions where it forms a tetrahedron. Examples of these projections are shown in the “Slices” column of table 300 of FIG. 3.

The lengths of the five durations can be calculated by taking the differences between adjacent time instances as:

$${\tilde{t}}_{m} = {J}_{5} {t}_{m} + {e}_{5} T \qquad ( A13 )$$

where, it is noted, that all of the values of \tilde{t}ₘ are greater than zero since by definition the values of tₘ are in ascending order. In a similar manner to Equation (A13), the voltages and currents can be derived from Equation (A10), above, to form Vₘ=PₘVᵢ and Iₘ=PₘIᵢ, respectively.

Unfortunately, the ordered voltage values Vₘ cannot simply be used to create a vector of leakage inductor voltages because the inductor voltage is a more complex function of the capacitor voltages. Instead, the capacitor voltages need to be additionally arranged to create the leakage inductor voltages. To do this, the matrix Gₘ is applied to the ordered voltage vector as follows:

$${V}_{Lk , m} = {G}_{m} {KV}_{m} , where \qquad ( A14 )$$

$$K = [ \begin{matrix}1 & 0 & 0 & 0 \\ 0 & - 1 & 0 & 0 \\ 0 & 0 & - 1 & 0 \\ 0 & 0 & 0 & 1\end{matrix} ]$$

The matrix Gₘ∈B^{5×4} can be decomposed into the sum of a constant portion G_{c} and one of three variable portions Gᵥ shown as Gₘ=G_{c}+Gₓ. The variable portions bin the sequences into three groups and are given by:

$${G}_{c} = [ \begin{matrix}{e}_{4}^{T} \\ {I}_{4}\end{matrix} ] = \{ \begin{matrix}[ \begin{matrix}0 & 1 & 0 & 0 \\ 0 & 0 & 0 & 1 \\ 0 & 0 & 0 & 1 \\ 0 & 1 & 0 & 0 \\ 0 & 1 & 0 & 0\end{matrix} ] & Group\_ 1 \\ [ \begin{matrix}0 & 0 & 1 & 0 \\ 0 & 0 & 0 & 1 \\ 1 & 0 & 0 & 0 \\ 0 & 1 & 0 & 0 \\ 0 & 0 & 1 & 0\end{matrix} ] & Group\_ 2 \\ [ \begin{matrix}0 & 0 & 1 & 0 \\ 0 & 0 & 1 & 0 \\ 1 & 0 & 0 & 0 \\ 1 & 0 & 0 & 0 \\ 0 & 0 & 1 & 0\end{matrix} ] & Group\_ 3\end{matrix} \qquad ( A15 )$$

These groups can be thought of as equivalent classes in the space of timing sequences. The first group involves sequences whose timings are distinct and separate between the primary and secondary sides, i.e., a 1-1-2-2 or 2-2-1-1 patterns where 1 refers to a primary side time instance and 2 to a secondary side one. The second group's timings alternate between the primary and secondary side, that is, the pattern becomes 1-2-1-2 or 2-1-2-1. In the final group, the timings occur in a 1-2-2-1 or 2-1-1-2 pattern. This is seen in the “Timing” and “Group” columns in table 300 of FIG. 3. The similarity of the switching sequences extends to the shapes of the derived inductor voltages and currents. In Group 1, the voltage values in segments I, III, and V are the same, meaning one combination of voltages is never reached. In Group 2, all four values are reached and only the first and last values are the same. Finally, in Group 3, the voltage sequence is symmetric where in addition to segments I and V being the same, segments II and IV are also identical. This directly leads to similarities in the currents; both similarities can be seen in the final two columns of the table 300. While the general patterns hold true in these groups, which voltages fit the patterns changes between modes. These different combinations of voltages demonstrate the benefit of considering all four timing instances rather than fixing one to be zero.

Using the arranged leakage inductor voltage vector, the points at which the leakage current changes slope can be calculated by scaling and integrating (A15) then evaluating at the inequality endpoints to form:

$${I}_{pts} = [ \begin{matrix}{i}_{Lk} ( 0 ) \\ {i}_{Lk} ( {t}_{I} ) \\ {i}_{Lk} ( {t}_{II} ) \\ {i}_{Lk} ( {t}_{III} ) \\ {i}_{Lk} ( {t}_{IV} )\end{matrix} ] = [ \begin{matrix}{i}_{Lk} ( {T}^{-} ) \\ {i}_{Lk} ( 0 ) \\ {i}_{Lk} ( {t}_{I} ) \\ {i}_{Lk} ( {t}_{II} ) \\ {i}_{Lk} ( {t}_{III} )\end{matrix} ] + \frac{1}{{L}_{Lk}} [ \begin{matrix}0 \\ {τ}_{m} {V}_{,}\end{matrix} ] \qquad ( A16 )$$

where τₘ=diag(\tilde{t}ₘ)∈□^{5×5}. Here Iₚₜₛ is the sum of a recursively defined vector where each element depends on the one before it and a zero padded vector of the change in capacitor current and where i_{LK}(T⁻) is the value of the inductor current at the end of the previous period which is given by

$${i}_{Lk} ( T ) = {i}_{Lk} ( {t}_{IV} ) \frac{{v}_{V} {\tilde{t}}_{v}}{{L}_{Lk}} .$$

The inductor current is L_{Lk} assumed to initialize at zero. The currents are piecewise affine functions and can be integrated again to form a vector of charges. These charges can be arranged into

$$Δ {Q}_{m} = [ \begin{matrix}Δ {Q}_{I} \\ Δ {Q}_{II} \\ Δ {Q}_{III} \\ Δ {Q}_{IV} \\ Δ {Q}_{V}\end{matrix} ] = {τ}_{m} ( {I}_{pts} - \frac{{τ}_{m} {V}_{Lk , m}}{2 {L}_{Lk}} ) , \qquad ( A17 )$$

where each of the elements of ΔQₘ represents the charge moved over a particular segment.

A coupled state space model can now be developed. As mentioned, each of the elements of ΔQₘ represents the charge moved during one linear segment of the inductor current. The matrix Gₘ can be reused to assign these values to a particular capacitor, which may be conducting one to three segments per period. By scaling the charge moved in each segment by the capacitance, C, the change in voltage per capacitor can be calculated with the usual relation as in

$$Δ {V}_{m} = \frac{1}{C} {G}_{m}^{T} Δ {Q}_{m} . \qquad ( A18 )$$

This can be expanded out to form the state space equation:

$$Δ {V}_{m} = \frac{1}{C} {G}_{m}^{T} ( {τ}_{m} [ \begin{matrix}{i}_{Lk} ( {T}^{-} ) \\ {i}_{Lk} ( 0 ) \\ {i}_{Lk} ( {t}_{I} ) \\ {i}_{Lk} ( {t}_{II} ) \\ {i}_{Lk} ( {t}_{III} )\end{matrix} ] + \frac{1}{{L}_{Lk}} [ \begin{matrix}0 \\ {τ}_{m} {V}_{m}\end{matrix} ] - {τ}_{m}^{2} {G}_{m} {KV}_{m} \frac{1}{2 {L}_{Lk}} ) , \qquad ( A19 )$$

where it can be seen that the change in state (capacitor voltage) is linear in the state itself and quadratic in the inputs, which are the values of the timing instances and are contained within the matrix τₘ.

The average capacitor voltages are found by scaling the charges in Equation (A17) as in:

$${I}_{avg} = \frac{1}{T} K Δ {Q}_{m} . \qquad ( A20 )$$

Equation (A18) on its own is not enough to calculate the entire state of the circuit. The value i_{Lk}(T⁻) is still needed (as seen in Equation (A19)). The change in inductor current over each period is the difference between the final and initial values which can be simplified down to:

$$Δ {i}_{Lk , m} = \frac{1}{{L}_{eq}} {V}_{Lk , m} {\tilde{τ}}_{m} = \frac{1}{{L}_{Lk}} {G}_{m} {KV}_{m} {\tilde{τ}}_{m} \qquad ( A21 )$$

where it is noted that this state is coupled with that of Equation (A18) and linear in the inputs but does not depend on its previous state.

With the assumed null initialization of i_{Lk}, the entire state of the DAHB converter can now be determined using the mode of operation, described by the matrices Pₘ and Gₘ, and the two states Vₘ, (the capacitor voltage) and i_{Lk,m} (the inductor current).

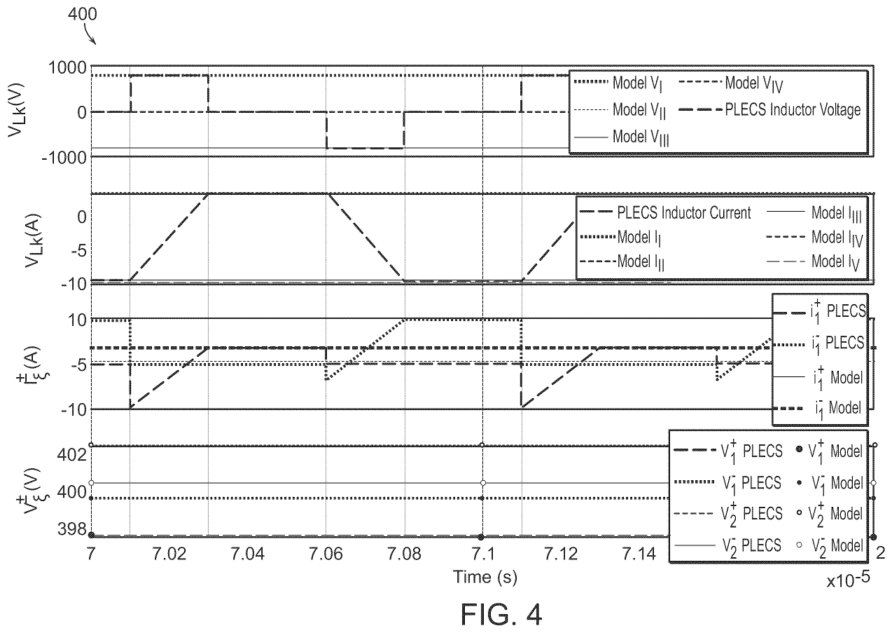

The modeling of the DAHB as discussed herein was implemented on MATLAB and compared to a high fidelity Simulink-PLECS simulation. Comparisons of the modeling as implemented on MATLAB and the Simulink simulation are provides in the graphs 400 shown in FIG. 4. The comparison results show that the state space model is able to accurately predict the leakage inductor and capacitor voltages and currents (it is noted that only two capacitor currents are shown, for clarity). In the first part of FIG. 4, the inductor voltages are calculated based on given capacitor voltages. Next, the timings, which are converted from phase shift and duty cycle inputs, are used with the voltages to calculate the endpoints of the inductor current. These are then used to evaluate the charge integral and find the average capacitor currents. Lastly, based again on the change in charge, the capacitor voltages are calculated. This verification was repeated to demonstrate the model working in different switching sequences.

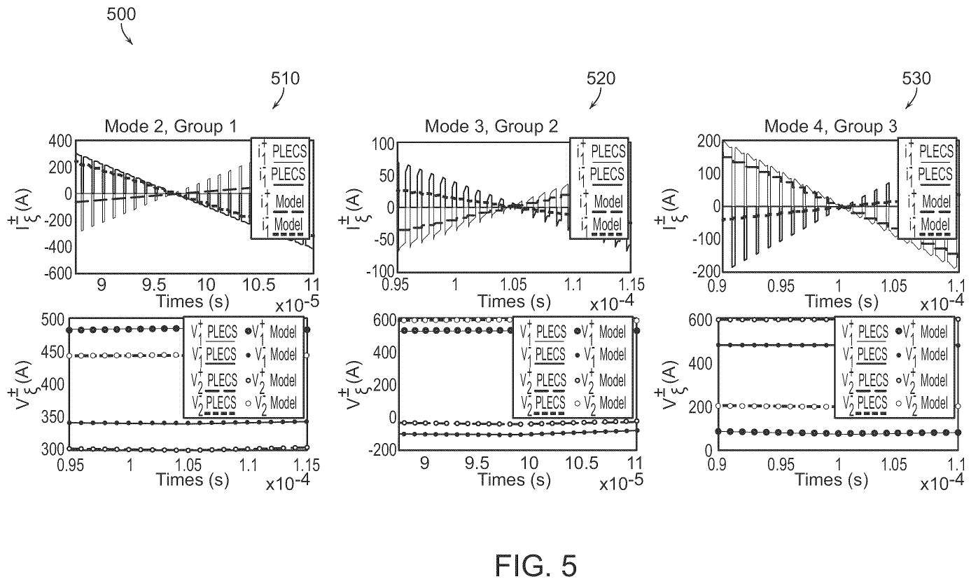

FIG. 5 includes table 500, containing graphs showing that the model described herein can predict the capacitor currents and voltages in various modes. The graphs are arranged in columns (510, 520, and 530) providing capacitor voltages and currents in Modes 2, 3, and 4, which cover Groups 1, 2, and 3, respectively. The model performs similarly across these representative cases. Despite identical parameters, the currents vary significantly between modes, and the model can predict the electrical behavior of the circuits in all cases.

Thus, as described herein, the dual active half bridge converter can be modeled as a series of switching functions that are defined by their switching time instances, and provide a foundation from which all relevant variables, including voltages and currents for both the capacitors and the inductor, are computed, and based on which control signaling to control operation of the converter is determined. The switching functions model can be expanded to include all possible switching states which are described by the permutations of the switching instances themselves. Using this, a completely general state space model, which works in all modes of operation can be used to control the behavior of a DAHB converter.

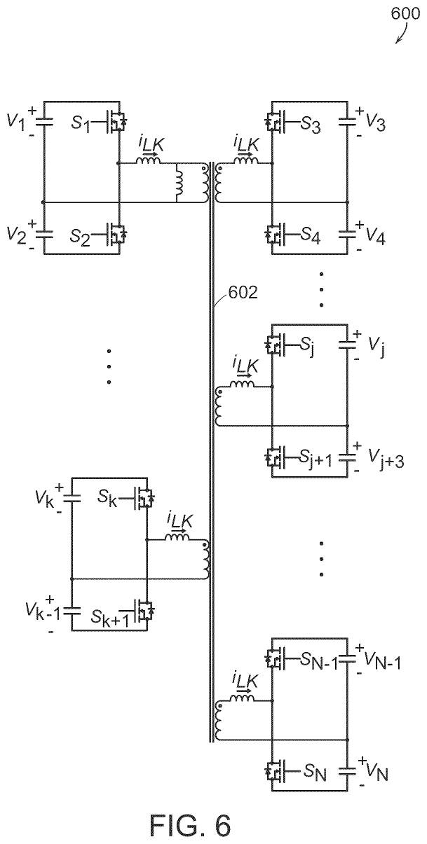

As noted, the switching state model can be extended to converters with N active half bridge circuits, with N>2, with such converters defining a multi active half bridge converter. FIG. 6 is a circuit diagram 600 of an example of a multi-active half bridge converter system comprising multiple active half bridge circuits (with N>2). The various AHB circuits can be directly coupled to windings of a transformer 602, or may be indirectly coupled (e.g., via another AHB circuit).

In additional example embodiments, analysis of the behavior of a DAHB converter is modeled as two half bridge circuits that dictate power transfer between upper and lower capacitors, and a DAHB that is restricted to power transfer across the transformer. The operating modes of each of the circuits can be analyzed by the permutations of the switching instances (in which each switching function describes two switches) which are related to the phase shifts and duty cycles of each pair of switches, in every period.

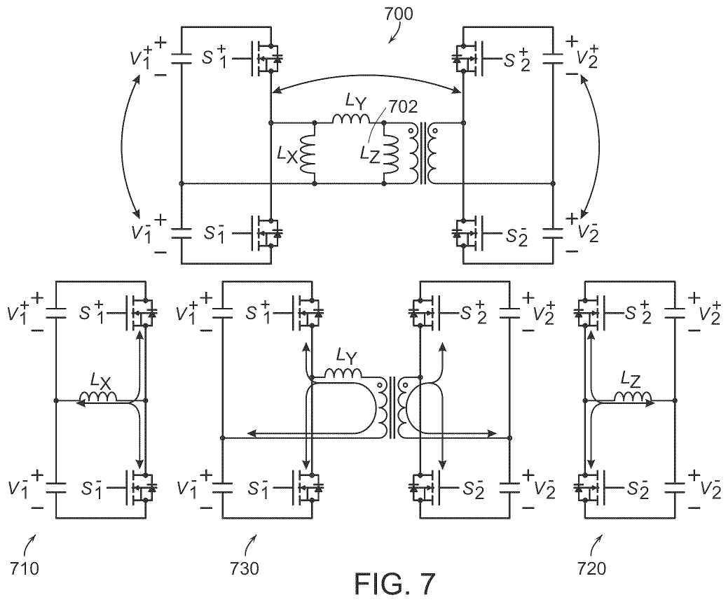

The additional example embodiments described herein provide an alternate model in which the DAHB converter is represented as a superposition of two half bridge (HB) converters and a DAHB converter without magnetizing inductance. This alternate representation split is shown in the lower section of FIG. 7, illustrating a π (PI) 3D-DAHB converter circuit 700 decomposed into two half-bridge converter circuits 710 and 720, and a traditional DAHB circuit 730 (similar to the DAHB circuits discussed in relation to FIGS. 1-6).

The switching functions described above in relation to the DAHB converter modeling can also be applied to the HB circuits. As noted, a single switching function is sufficient to describe the two circuit states. The switching modes determine the output voltage sequence, the current in the load, and the charge moved in the capacitors.

The possible values for the output voltage, which is taken across an inductor, are the positive voltage of the upper capacitor and the negative voltage of the lower capacitor. These values alternate in turn with the switching sequence such that when the sequence is high, the upper capacitor is connected to the inductor and when it is low, the inverted lower capacitor provides the output. The capacitors are assumed to be large enough that the voltage is constant over one period. These voltages can be described in terms of the switching sequence as:

$${v}_{ξ} = {V}_{ξ}^{+} {s}_{ξ} ( t , {t}_{ξ}^{+} , {t}_{ξ}^{-} ) - {V}_{ξ}^{-} ( 1 - {s}_{ξ} ( t , {t}_{ξ}^{+} , {t}_{ξ}^{-} ) ) = ( {V}_{ξ}^{+} + {V}_{ξ}^{-} ) {s}_{ξ} ( t , {t}_{ξ}^{+} , {t}_{ξ}^{-} ) - {V}_{ξ}^{-} . \qquad ( A22 )$$

The possible sequence of values of V_{L} are described with a matrix Fₘ which is related to Pₘ as in:

$${V}_{L , m} = [ \begin{matrix}{v}_{I} \\ {v}_{II} \\ {v}_{III}\end{matrix} ] = {F}_{m} {K}_{2} {P}_{m} [ \begin{matrix}{V}_{1}^{+} \\ {V}_{1}^{-}\end{matrix} ] = {F}_{m} {K}_{2} {V}_{C , m} , \qquad ( A23 )$$

$$where {F}_{m} = [ \begin{matrix}{e}_{2 N}^{T} \\ {I}_{2 N}\end{matrix} ] = [ \begin{matrix}0 & 1 \\ 1 & 0 \\ 0 & 1\end{matrix} ] , {K}_{2} = [ \begin{matrix}1 & 0 \\ 0 & - 1\end{matrix} ] , \qquad ( A24 )$$

and where N=1 for the HB.

The current i_{L,m} in the inductor of the HB converter in mode can be described by the integrals:

$${i}_{L , m} ( t ) = \{ \begin{matrix}{i}_{L} ( 0 ) + \frac{1}{L} {\int }_{0}^{t} {v}_{I} dt , & 0 < t \leq {t}_{I} \\ {i}_{L} ( {t}_{I} ) + \frac{1}{L} {\int }_{{t}_{I}}^{t} {v}_{II} dt , & {t}_{I} < t \leq {t}_{II} \\ {i}_{L} ( {t}_{II} ) + \frac{1}{L} {\int }_{{t}_{I}}^{t} {v}_{III} dt , & {t}_{II} < t \leq {t}_{T}\end{matrix} \qquad ( A25 )$$

where t_{I} and t_{II} are the first and second elements of tm. These time values will be one each of t_{ξ}⁺ or t_{ξ}⁻, depending on the mode. Equation (A25) is a linear integral with a simple evaluation.

The initial value of the first line segment, i_{L}(0) is given by the final value of the previous period and is initialized at zero. The intermediate and final values are given by evaluating the linear segments of Equation (A25) at their endpoints. When \tilde{t}ₘ is used with the evaluation of the parts of Equation (A25), the expression simplifies to

$${i}_{L} ( {t}_{x} ) = {i}_{L} ( {t}_{x} - 1 ) + \frac{{v}_{x} {\tilde{t}}_{x}}{L} \qquad ( A26 )$$

where tₓ is one of the time endpoints shown in Equation (A25) and vₓ is the corresponding voltage.

Equation (A25) can be integrated over time, as in

$${q}_{I} = {\int }_{0}^{{t}_{I}} ( {i}_{L} ( 0 ) + \frac{{v}_{I} t}{L} ) dt ,$$

to get the charge transferred in each line segment during a particular period. The three charges moved during these segments are:

$${Q}_{m} = [ \begin{matrix}{q}_{I} \\ {q}_{II} \\ {q}_{III}\end{matrix} ] = {τ}_{m} ( {i}_{pks} - \frac{{τ}_{m} {V}_{L , m}}{2 L} ) \qquad ( A27 )$$

where τₘ=diag(\tilde{τ}ₘ)∈□^{4×4} and iₚₖₛ=[i_{L}(0) i_{L}(t_{I}) i_{L}(t_{II})]^{T} is the vector of current transition points calculated from Equation (A26) and the initial value i_{L}(0).

The average capacitor currents are disaggregated from the inductor current by dividing the charge moved in each segment over time and matching it with the active capacitor; the lower capacitor current is negative with respect to the inductor. This can be written as of the HB circuit can be derived to yield:

$${i}_{c , avg} = \frac{1}{T} {K}_{2} {F}_{m}^{T} {P}_{m} {Q}_{m} \qquad ( A28 )$$

where Fₘ is the same matrix as in Equation (A24).

Based on the charges, the change in voltage during a period can be calculated in a similar way to the average current of Equation (A28). This can be shown by adapting the usual capacitor equation, Q=CΔV, as in

$$Δ {V}_{m} = {P}_{m} [ \begin{matrix}Δ {V}_{1}^{+} \\ Δ {V}_{1}^{-}\end{matrix} ] = \frac{1}{C} {P}_{m} {F}_{m}^{T} {Q}_{m} , \qquad ( A29 )$$

where ΔVₘ is the vector of changes in the capacitor voltages in one period and C is the capacitance, assumed to be large and equal for both capacitors.

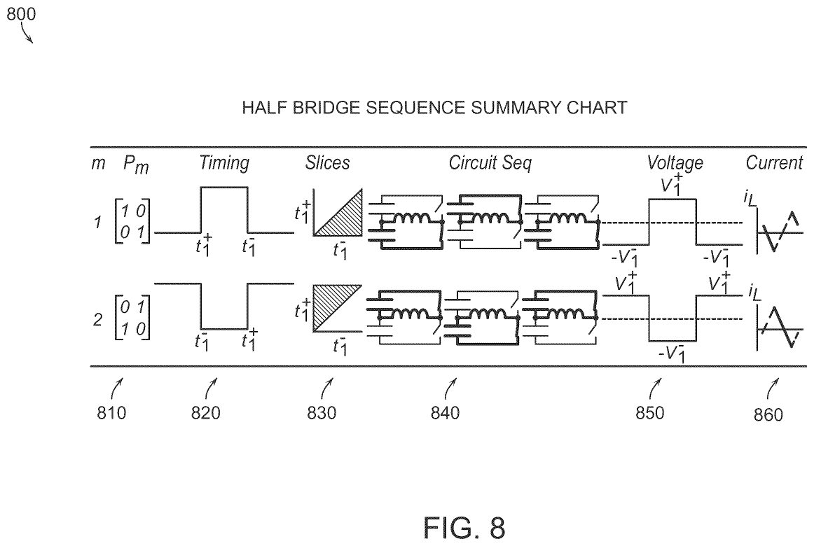

The switching sequences of the HB are summarized in table 800 included in FIG. 8 where each row depicts a switching mode. The first column 810 shows the permutation matrix that corresponds to the switching function shown in the second column. Next, a graphical representation of the switching mode is shown in columns 820 and 830, followed by diagrams of the changing conduction path in the circuit during one period, as depicted in column 840. The corresponding output voltage sequence is then shown in column 850 along with the current produced by the inductor, illustrated in column 860 (shaded according to which capacitor is active in each segment).

The analysis of the switching function-based modeling for the central DAHB converter (e.g., the DAHB converter 730 resulting from decomposition of the π 3D-DAHB converter circuit 700, as depicted in FIG. 7) is substantially the same as the analysis that was discussed in relation to FIGS. 1-6.

Thus, and as discussed herein, for the π-3D DAHB converter, the switching sequence defines the output voltage of a switching function ξ as was represented in Equation (A22). The voltage applied to an impedance that connects phases 1 and 2 is:

$${v}_{12} ( t ) = {v}_{1} ( t , {t}_{1}^{+} , {t}_{1}^{-} ) - {v}_{2}^{-} ( t , {t}_{2}^{+} , {t}_{2}^{-} ) ) = ( {V}_{1}^{+} + {V}_{1}^{-} ) {s}_{1} ( t , {t}_{1}^{+} , {t}_{1}^{-} ) - {V}_{1}^{-} - ( ( {V}_{2}^{-} + {V}_{2}^{+} ) {s}_{1} ( t , {t}_{2}^{+} , {t}_{2}^{-} ) - {V}_{2}^{-} ) . \qquad ( A30 )$$

Because the switches change four times per period, the equivalent inductor voltage will take on five values in that period. Given a vector of the capacitor voltages, \tilde{V}=[V₁⁺,V₁⁻,V₂⁺,V₂⁻]^{T}, the leakage inductor voltage is:

$${V}_{Lk , m} = [ \begin{matrix}{v}_{I} \\ {v}_{II} \\ {v}_{III} \\ {v}_{IV} \\ {v}_{V}\end{matrix} ] = {F}_{m} {K}_{4} \tilde{V} \\ where {K}_{4} = [ \begin{matrix}{K}_{2} & 0 \\ 0 & - {K}_{2}\end{matrix} ] . \qquad ( A31 )$$

V_{Lk,m} is a vector representing the leakage inductor voltage and Fₘ∈B^{5×4} is a binary matrix that properly arranges the capacitor voltages to form the inductor voltage. It is noted that the last voltage value is the same as the first as there are an even number of switching instances. However, the ON time of these voltage segments are generally not equal. The timing sequence, i.e., a permutation matrix, defines the sequence of capacitor voltages that are connected to the leakage inductor. This relationship is Fₘ=GₘPₘ where Gₘ∈B^{5×4} is a binary matrix. For the DAHB (N=2), this matrix can be broken down into a constant portion and a variable portion that divides the twenty four modes into three groups: Gₘ=G_{c}+Gᵥ, with

$${G}_{c} = [ \begin{matrix}{e}_{2 N}^{T} \\ {I}_{2 N}\end{matrix} ] = \{ \begin{matrix}[ \begin{matrix}0 & 1 & 0 & 0 \\ 0 & 0 & 0 & 1 \\ 0 & 0 & 0 & 1 \\ 0 & 1 & 0 & 0 \\ 0 & 1 & 0 & 0\end{matrix} ] & G 1 \\ [ \begin{matrix}0 & 0 & 1 & 0 \\ 0 & 0 & 0 & 1 \\ 1 & 0 & 0 & 0 \\ 0 & 1 & 0 & 0 \\ 0 & 0 & 1 & 0\end{matrix} ] & G 2 \\ [ \begin{matrix}0 & 0 & 1 & 0 \\ 0 & 0 & 1 & 0 \\ 1 & 0 & 0 & 0 \\ 1 & 0 & 0 & 0 \\ 0 & 0 & 1 & 0\end{matrix} ] & G 3\end{matrix} \qquad ( A32 )$$

The entries in the individual groups correspond to similar switching waveforms. In the first group, one switch changes state twice before the other switches. The second group has sequences where the instances alternate between the first and second switch. In the third group, one set of instances is contained within the other. These classes can be seen in the third column of table 300 of FIG. 3 with the group labels in the fourth column. The sequences of capacitors that conduct to form the voltage sequences are shown in the sixth and seventh columns of table 300, respectively. The letters correspond to the circuits shown in the lower part 310 of table 300. The voltage and current sequences have shadings representative of the capacitors that are used to form them which are also shown in the area below the main chart in table 300.

With the voltages and timings defined, the power transfer in the transformer of the DAHB converter of the deconstructed (decomposed) representation of the n-DAHB converter is dependent on the current. The inductor currents are given now by five integrals similar to those in Equation (A25) as in:

$${i}_{Lk} ( t ) = {i}_{Lk} ( {t}_{x - 1} ) + \frac{{v}_{x}}{{L}_{Lk}} ( t - {t}_{x - 1} ) , {t}_{x - 1} < t \leq {t}_{x} . \qquad ( A33 )$$

The ordering of the tₓ entries in Equation (A33) is determined by the permutation matrix as shown in Equation (A11). As in the HB circuit, the instances can be converted to durations using the relationship \tilde{t}ₘ=J₅tₘ+e₅. With the durations and Equation (A33), the inductor currents evaluate similar to the HB endpoints shown in Equation (A26) as follows:

$${i}_{Lk} ( {t}_{I} ) = {i}_{Lk} ( 0 ) + \frac{{v}_{I} {\tilde{t}}_{I}}{{L}_{Lk}} \qquad ( A34a )$$

$${i}_{Lk} ( {t}_{II} ) = {i}_{Lk} ( {t}_{I} ) + \frac{{v}_{II} {\tilde{t}}_{II}}{{L}_{Lk}} \qquad ( A34b )$$

$${i}_{Lk} ( {t}_{III} ) = {i}_{Lk} ( {t}_{II} ) + \frac{{v}_{III} {\tilde{t}}_{III}}{{L}_{Lk}} \qquad ( A34c )$$

$${i}_{Lk} ( {t}_{IV} ) = {i}_{Lk} ( {t}_{III} ) + \frac{{v}_{IV} {\tilde{t}}_{IV}}{{L}_{Lk}} \qquad ( A34d )$$

$${i}_{Lk} ( {t}_{V} ) = {i}_{Lk} ( {t}_{IV} ) + \frac{{v}_{V} {\tilde{t}}_{V}}{{L}_{Lk}} \qquad ( A34e )$$

Current waveforms are shown in the final column (320) of table 300. These depictions are examples where it is assumed that the upper capacitors have slightly greater voltages than the lower ones. This results in positively sloped currents when the capacitor voltage differences are the active transformer voltage. In a given period, the current slopes will always have at least one positive and one negative value, the other values will depend on the difference between the voltages V₁⁺−V₂⁺ and V₁⁻−V₂⁻.

The charge transferred in each of the line segments are given by the integral of the parts of Equation (A33) which reduces to:

$${Q}_{m} = [ \begin{matrix}{Q}_{I} \\ {Q}_{II} \\ {Q}_{III} \\ {Q}_{IV} \\ {Q}_{V}\end{matrix} ] = {τ}_{m} ( {I}_{pks} - \frac{{τ}_{m} {V}_{Lk , m}}{2 L} ) , \qquad ( A35 )$$

where iₚₖₛ now has five values and τₘ∈R^{5×5}. The average current is calculated in same way as in Equation (A28), above, but with a larger parity matrix.

The change in voltage in each capacitor over one period can be computed according to:

$$Δ {V}_{C , m} = {P}_{m} [ \begin{matrix}Δ {V}_{1}^{+} \\ Δ {V}_{1}^{-} \\ Δ {V}_{2}^{+} \\ Δ {V}_{2}^{-}\end{matrix} ] = \frac{1}{C} {P}_{m} {F}_{m}^{T} {Q}_{m} . \qquad ( A36 )$$

This can be used with the given initial voltage per period to predict the coming voltage value.

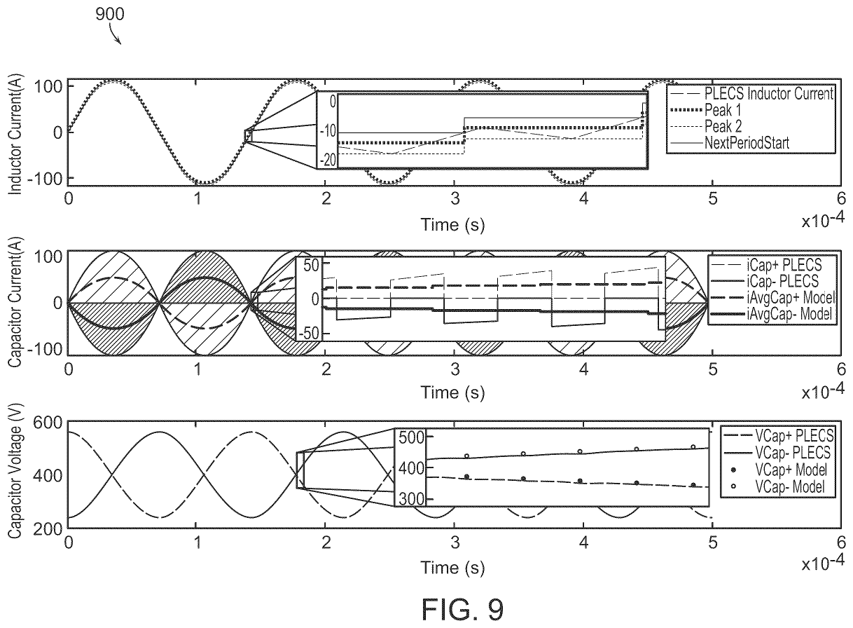

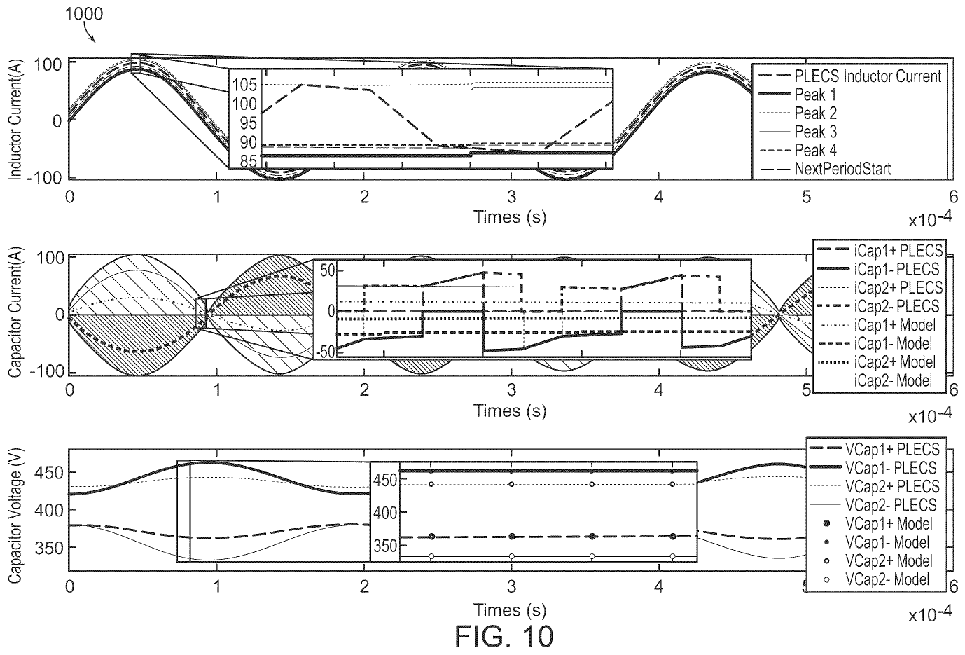

MATLAB modeling and PLECS simulations were used to verify the fidelity of both the BH and DAHB models. It was shown that at the beginning of each period, the model was able to accurately predict the peak values of the equivalent inductor current, and thus the resulting voltage that corresponds to the change in charge moved by the current. The average capacitor current per period was also produced. The model can therefore be used to predict all states of the circuit, using only the initial voltages and current values along with the timing instances. A comparison of the model's output and the PLECS simulation results are shown in FIGS. 9 and 10. FIG. 9 includes graphs 900 showing half bridge model tracking the current endpoints and beginning of each period, the capacitor currents, and the resulting voltages calculated from the change in charge. FIG. 10 includes graphs 1000 showing the model predicting each transition point of the DAHB leakage current waveform as well as the resulting voltage in each capacitor. Insets show detailed areas of interest.

In the tested/evaluated implementation of the modeling, the equivalent inductance used was 12 μH, with an 800V bus, 100 μF capacitors, and with model switching at 1 MHz. When expressing the state space model of the DAHB, the inputs were considered to be the duty cycles and phase shifts, which were used to determine the sequence mode and the timing instances tₘ. The state variables are the capacitor voltages. The coupled, discrete state equations that result are:

$$Δ {V}_{C , m} = \frac{1}{C} {P}_{m} {F}_{m}^{T} {Q}_{m} \qquad ( A37 )$$

$$and ,$$

$$Δ {i}_{L , m} = \frac{1}{{L}_{eq}} {V}_{L , m} {\tilde{t}}_{m} . \qquad ( A38 )$$

The above modeling of different switching modes that affect the behavior of DAHB converters (such as the DAHB converter 100), or AHB converters (similar to the AHB converters 710 and 720 of FIG. 7) whether or not separated by a DAHB converter (such as the traditional DAHB circuit 730 depicted in FIG. 7) can be used to control the operation of such converters. Different control techniques/schemes may be used in conjunctions with the normalized switching functions modeling discussed herein, including the controlling techniques discussed in international application No. PCT/US2022/018940, entitled “Systems and Methods for Stacked Multi-Level Power Converter Implementations with Linear Scaling” filed Mar. 4, 2022, the content of which is incorporated herein by reference in its entirety.

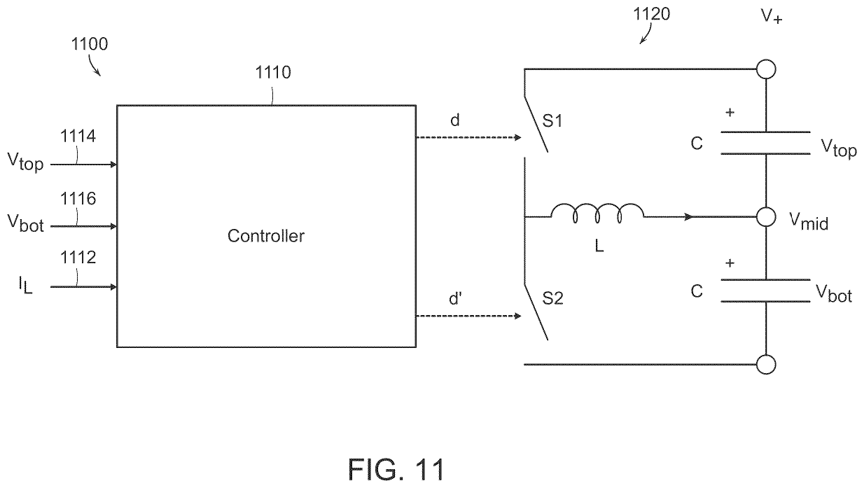

Briefly, consider, with reference to FIG. 11, a controllable converter implementation 1100 that includes a controller 1110 in electrical communication with a controllable AHB circuit (which may be similar to either of the converter circuits 710 or 720). The controller 11100 of FIG. 11 may implement a “Ref & Duty & PWM” controller to control the electrical behavior of the converter 1120 (including to control the voltage levels at the capacitors of the cell 1040) through controlled adjustment of the duty cycles and/or phase difference between activation signals for the switches S1 and S2. The diagram of FIG. 11 is a simplified picture of the switching behavior that actually takes place in practical system because the circuitry of FIG. 11 shows only a single AHB converter (comprising two switches), whereas in the situations considered for the proposed modeling, multiple circuits, each with multiple switches, may be used, thus resulting in a larger number of switching modes, each of which has a different impact on the converter operation/behavior. Because every converter circuit generally contains an inductor and/or a capacitor, which are prone to resonating if left in an open-feedback loop, this can lead to instability of the converter. To mitigate this, in some embodiments, each converter may be equipped with a local feedback loop, to obtain and provide to the controller 1100 measurements of, for example, the inductor current (i_{L}), and the voltages of the capacitors (Vₜₒₚ and V_{bot}). Additional details about techniques for switching and voltage/current control functionality (through duty cycle control) are also provided in US 2021/0126522 A1, entitled “Methods, Systems, and Devices for Soft Switching of Power Converters,” the content of which is hereby incorporated by reference in its entirety.

The controller 1110 may be implemented as a processor-based device, an application-specific integrated circuit, or according to other types of controller circuitries, configured to generate control signaling (according to measured electrical characteristics of the unit cell, and/or global control signaling (not shown in FIG. 11).

Determination of the duty cycles and phase shifts, based on which the switches of the converter circuit will be actuated, is based, in converters that include multiple circuit sections (e.g., DAHB, or HB+DAHB+HB), on using the feedback information to determine what switching mode the converter is in. For example, due to small deviations of the output values of the converter circuitry from the predicted values, the converter may have transitioned from one switching mode to another switching mode. Since the modeling developed for the framework described herein uses permutation matrices associated with the particular switching mode (for the upcoming period) to predict the circuit behavior, and determine the exact timing for the particular switching sequence selected (which in turn controls the capacitor voltages and leakage current during the period), the controller 1110 is configured, based, in part, on the feedback information, to determine the switching mode for the upcoming period. This in turn determines the applicable permutation matrix, which can then be used to determine the switching times for the upcoming period using the required capacitor voltages. As provided in Equation (A36), the relationship associates the permutation matrix (for the particular identified switching mode) for the DAHB converter with the predicted electrical circuit behavior of the circuit according to:

$$Δ {V}_{C , m} = {P}_{m} [ \begin{matrix}Δ {V}_{1}^{+} \\ Δ {V}_{1}^{-} \\ Δ {V}_{2}^{+} \\ Δ {V}_{2}^{-}\end{matrix} ] = \frac{1}{C} {P}_{m} {F}_{m}^{T} {Q}_{m} .$$

where Pₘ is the permutation matrix for the particular determined switching mode. Based on the above relationship (that associates the switching mode with expected desired electrical behavior of the converter topology in question, be it a decomposed DAHB converter of FIGS. 7-10, or the DAHB converters of FIGS. 1-7), the precise phase shift and duty cycle signaling to actuate the switches of the particular converter circuitry can be derived. The controller 1110 is configured to compensate for any measurement errors and changing conditions to dynamically adapt the switching signaling produced in order achieve the desired electrical behavior (e.g., the desired capacitor voltages) in accordance with the relationships discussed above.

Thus, in the alternate modeling of a DAHB converter (as discussed in relation to FIGS. 7-11), the DAHB converter is broken down into two half bridge converters and a dual active half bridge that only transfers power across the transformer. The switching states of the transformer define the power transfer characteristics which can be used to fully describe the converter behavior. Consequently, a controller module coupled to the DAHB converter (e.g., according to an implementation comprising HB circuits flanking a traditional DAHB converter) is configured to determine a particular switching mode that the converter operates in, and use that information (as well as information about output electrical characteristics of the converter, as may have been measured by one or more deployed sensors) to compute expected/desired electrical behavior for a next period of operation of the converter, and derive the timing information (duty cycles, phase shifts) to actuate the various switches of the converter to achieve the desired electrical behavior.

Accordingly, in some variations, a voltage converter system is provided that includes two or more Active Half Bridge (AHB) converter circuits, each of the two or more AHB converter circuits connected to one or more windings of a transformer, with each AHB converter circuit including one or more switches and one or more energy storage devices. The voltage converter system further includes one or more controllers to control electrical behavior of the two or more AHB converter circuits according to normalized switching functions representing the switching states of the switches of the two or more AHB converter circuits.

In some examples, the two or more AHB converter circuits may implement a dual active half bridge (DAHB) converter circuit comprising two primary side capacitors, two primary side controllable switching devices, two secondary side capacitors, and two secondary side switching devices. In such examples, the electrical behavior of the DAHB converter circuit may include voltages and currents behavior for the two primary side capacitors and the two secondary side capacitors, with the voltages and current behavior, and control signals to control behavior of the DAHB converter circuit, being computed as functions of values of the normalized switching functions.

In some embodiments, the normalized switching functions may define switching sequences for the two or more AHB converter circuits, and the one or more controllers may be configured to actuate the switches of the two or more AHB converter circuits according to the switching sequences. The switching sequences may be represented as permutation matrices. The one or more switching sequences for the two or more AHB converter circuits may be defined by duty cycles for the primary side and for the secondary side, and by adjustable phase shifts between switching events for switches of the primary side and for switches of the secondary side.

In some examples, each of the two or more AHB converter circuits may be represented as two half bridge converter circuits and a central dual active half bridge separating the two half bridge converter circuits, with the central dual active half bridge configured to transfer power across a transformer of the central dual active half bridge.

In various examples, the converter system may further include one or more sensors deployed in the two or more AHB converter circuits to measure electrical characteristics of components of the two or more AHB converter circuits. In such examples, the one or more controllers to control electrical behavior of the two or more AHB converter circuits may be configured to determine a switching mode, from a plurality of switching modes under which the two or more AHB converter circuits operate, based, at least in part, on feedback data measured by the one or more sensors, the feedback data representative of electrical behavior of the two or more AHB converter circuits. In some embodiments, the one or more controllers to control electrical behavior of the two or more AHB converter circuits may further be configured to derive expected electrical behavior of the two or more AHB converter circuits for a next period of operation of the two or more AHB converter circuits based, at least in part, on the determined switching mode for the two or more AHB converter circuits and at least some of the feedback data. The one or more controllers to control electrical behavior of the two or more AHB converter circuits may further be configured to determine duty cycle behavior and/or phase shift behavior for the switches during the next period of operation of the two or more AHB converter circuits based on the derived expected electrical behavior of the two or more AHB converter circuits. The feedback data representative of the electrical behavior of the two or more AHB converter circuits may include one or more of, for example, voltage levels at one or more capacitors included in a circuit comprising the two or more AHB converter circuits and/or current passing through an inductor included in the circuit comprising the two or more AHB converter circuits.

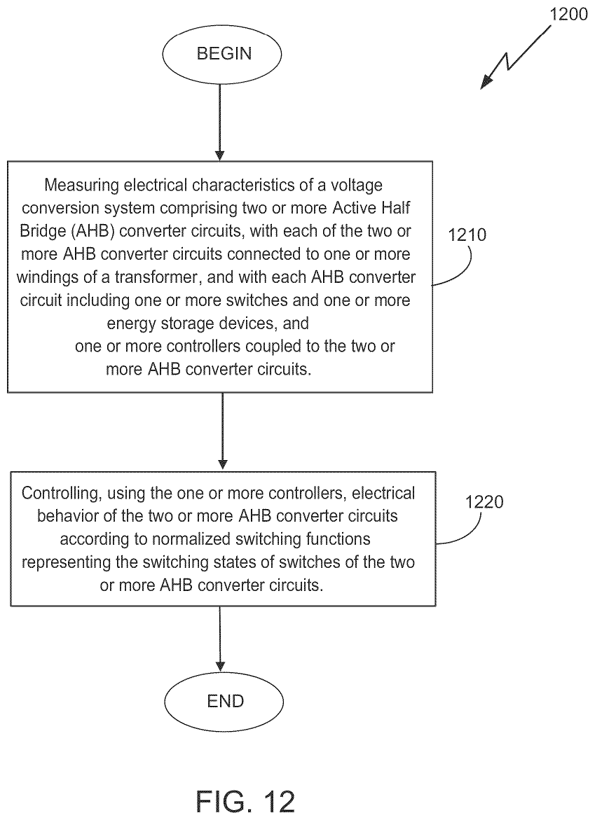

With reference next to FIG. 12, a flowchart of an example voltage conversion procedure 1200 is provided. The procedure 1200 includes measuring 1210 electrical properties of a voltage conversion system that includes two or more Active Half Bridge (AHB) converter circuits, with each of the two or more AHB converter circuits being connected to one or more windings of a transformer with multiple windings, and with each AHB converter circuit including one or more switches and one or more energy storage. The procedure 1200 further includes controlling 1220, using one or more controllers coupled to the two or more AHB converter circuits, electrical behavior of the two or more AHB converter circuits according to normalized switching functions representing the switching states of the switches of the two or more AHB converter circuits.

In various examples, controlling the electrical behavior of the two or more AHB converter circuits may include determining a switching mode, from a plurality of switching modes under which the two or more AHB converter circuits operate, based, at least in part, on feedback data measured by the one or more sensors, the feedback data being representative of the measured electrical characteristics behavior of the two or more AHB converter circuits. Controlling the electrical behavior of the two or more AHB converter circuits may further include deriving expected electrical behavior of the two or more AHB converter circuits for a next period of operation of the two or more AHB converter circuits based, at least in part, on the determined switching mode for the two or more AHB converter circuits and at least some of the feedback data. Controlling the electrical behavior of the two or more AHB converter circuits may further include determining duty cycle behavior and/or phase shift behavior for the switches during the next period of operation of the two or more AHB converter circuits based on the derived expected electrical behavior of the two or more AHB converter circuits.

The feedback data representative of the electrical behavior of the two or more AHB converter circuits may include one or more of, for example, voltage levels at one or more capacitors included in a circuit comprising the two or more AHB converter circuits, and/or current passing through an inductor included in the circuit comprising the two or more AHB converter circuits.

In various embodiments, the two or more AHB converter circuits implement a dual active half bridge (DAHB) converter circuit with a primary side and a secondary side separated from the primary side by the transformer, the primary side comprising two primary side capacitors, two primary side controllable switching devices, and the secondary side comprising two secondary side capacitors, and two secondary side switching devices. In some examples, the normalized switching functions define switching sequences for the two or more AHB converter circuits. In such examples, controlling the electrical behavior of the two or more AHB converter circuits may further include actuating the switches of the two or more AHB converter circuits according to the switching sequences. The switching sequences may be represented in permutation matrices. Each of the two or more AHB converter circuits may be represented as two half bridge converter circuits and a central dual active half bridge separating the two half bridge converter circuits, with the central dual active half bridge configured to transfer power across a transformer of the central dual active half bridge.

### B) Vertically Stacked Multilevel Power Conversion Configurations

Also disclosed herein is a voltage converter system that includes a stacked plurality of voltage converter cells, each of the plurality of voltage converter cells comprising at least one capacitor, with the stacked plurality of voltage converter cells defining a configuration of series-connected capacitors. In this series-connected configuration, the at least one capacitor of a first voltage converter cell from the stacked plurality of voltage converter cells is electrically linked to the at least one capacitor of at least a second voltage converter cell from the stacked plurality of voltage converter cells to define at least one power transfer link, with the first voltage converter cell and the second voltage converter cell being configured to controllably transfer power from the at least one capacitor of the first voltage converter cell, through the power transfer link, to the at least one capacitor of the second voltage converter cell to maintain voltage balance in the stacked plurality of voltage converter cells. The voltage converter system further includes one or more controllers in communication with the stacked plurality of voltage converter cells, the one or more controllers configured to control electric power behavior of the stacked plurality of voltage converters cell to produce a specified output voltage at an output terminal of at least one of the stacked plurality of voltage converter cells. In some examples, each of the plurality of voltage converter cells shares a capacitor with a neighboring voltage converter cell. The one or more controllers (which may constitute part of the converter cells, or may be independent of the converter cells) may be configured to controllably actuate switching devices (which may be part of the controllers' circuitry) regulating the electric power behavior of at least one of the plurality of voltage converter cells, including to determine an adjustable duty cycle behavior for the switching devices of the at least one of the plurality of voltage converter cells.

The general topology of the Manhattan stacked multi-level voltage converters includes a set of series stacked capacitors with dynamic level voltages. Level voltages are defined by the voltage of each individual capacitor and all level voltages change with the output voltage. It is linearly scalable to N-levels, which is a valuable attribute as it allows for both increased voltage handling capabilities and reduced filtering requirements. Voltage balance is maintained through energy sharing between these capacitors, with energy sharing and connectivity techniques not critical to the functionality of this topology. Several implementations of the Manhattan stacked multi-level voltage converters are discussed below.

In a first example embodiment, a converter is implemented with an N-level topology with linear component quantity and stress scaling, where voltage balance is maintained for any voltage conversion ratio. Such a converter is composed of a set of series stacked capacitors where each additional capacitor can define a voltage level. Input voltage is applied across the entirety of the voltage stack and the output can be taken at any node between capacitors. Capacitor voltage balance is maintained through any method of energy sharing between capacitances. Capacitor voltage balance can be maintained through various techniques/methods of energy sharing between capacitances. The amount of power that needs to be transferred between capacitances to maintain voltage balance is generally less than the output power of the converter.

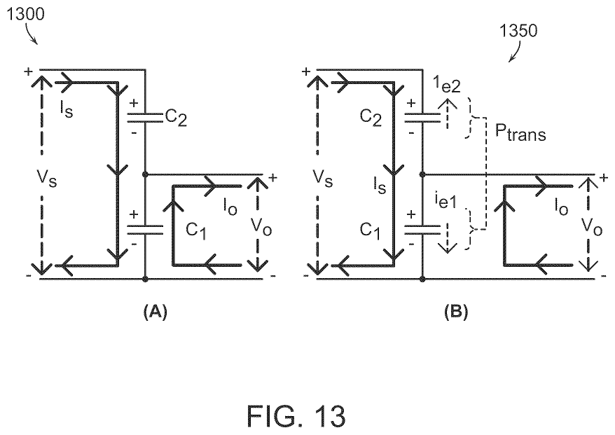

Characteristics of the proposed topologies are derived based on the 2-capacitor (k=2), 2-level (N=2) converter shown in FIG. 13, in which a circuit 1300 (also marked as circuit A) shows the basic topology, and a circuit diagram 1350 (marked as diagram B) illustrates the power transfer required to maintain voltage balance in steady state.

The topology of FIG. 13 is capable of bidirectional power conversion, but for conciseness, the behavior of the topology is discussed with respect to a step-down buck mode. The input current Iₛ and output current Iₒ can be considered external current sources. The input voltage is equal to the sum of capacitor voltages Vₛ=V_{C1}+V_{C2} and the output voltage is equal to the lower capacitor voltage Vₒ=V_{C1}.

All power converters must follow the law of conservation of energy where the input power equals the output power (assuming ideal components with negligible losses). In the context of the proposed topological framework of this example, this can be formally written as:

$${P}_{s} = {P}_{o} , and \\ {V}_{s} {I}_{s} = {V}_{o} {I}_{o} , \qquad ( B1 )$$

where Pₛ and Pₒ are the input and output powers, respectively. As the level voltages are defined by the capacitor voltages, to maintain voltage balance of all levels in steady state, the average capacitor currents must equal zero. The capacitor currents for the circuit of FIG. 13 are:

$${I}_{C 1} = {I}_{s} - {I}_{o} , and \\ {I}_{C 2} = {I}_{s} . \qquad ( B2 )$$

This shows that the circuit 1300 of FIG. 13 does not maintain voltage balance in steady state as the capacitor currents do not equal zero for non-zero input and output currents. I_{C2} will always be positive since Iₛ, in the context of this analysis, is positive. Iₒ will be greater than Iₛ as this analysis considers this converter to be operating in step-down buck mode and I_{C1} will always be negative. As a result of this, V_{C2} will be steadily increasing and V_{C1} will be steadily decreasing, and the converter of FIG. 13 can be considered unbalanced in steady state. This imbalance can be considered a result of excess power Pₑ applied to each capacitor:

$${P}_{e , C 1} = {V}_{C 1} ( {I}_{s} - {I}_{o} ) \\ {P}_{e , C 2} = {V}_{C 2} {I}_{s} . \qquad ( B3 )$$

where P_{e,C1} and P_{e,C2} represent the power that needs to be removed from each capacitor in order to achieve voltage balance in steady state. As the capacitor voltages are considered to always be positive, P_{e,C2} will always be positive and P_{e,C1} will always be negative. C2 has positive excess power and C1 has negative excess power. It can be seen that, given the above relationships, P_{e,C2} and P_{e,C1} are equal in magnitude but opposite in sign, that is:

$${V}_{C 1} ( {I}_{s} - {I}_{o} ) = - {V}_{C 2} {I}_{s} , and \\ {P}_{e , C 1} = - {P}_{e , C 2} . \qquad ( B4 )$$

Therefore, in order to maintain capacitor voltage balance, the positive excess power from C2 can be transferred to C1 to compensate for both the negative excess power within C1 and the positive excess power within C2. This power transfer has the effect of neutralizing the capacitor currents, resulting in average capacitor currents equaling zero and voltage balance in steady state being achieved. The equations for average capacitor currents can be adjusted to reflect this power transfer, namely,

$$\begin{matrix}0 = {I}_{C 1} = {I}_{s} - {I}_{o} + {i}_{e 1} \\ 0 = {I}_{C 2} = {I}_{s} + {i}_{e 2} ,\end{matrix} \qquad ( B5 )$$

$$\text{where:}$$

$$\begin{matrix}{P}_{trans} = {P}_{e , C 1} = - {P}_{e , C 2} \\ {i}_{e 1} = {P}_{trans} / {V}_{C 1} \\ {i}_{e 2} = - {P}_{trans} / {V}_{C 2} , and \\ 0 = {P}_{e , C 1} + {P}_{e , C 2}\end{matrix} \qquad ( B6 )$$

Through this power transfer (via a power transfer link defined between C1 and C2) voltage balance in steady state is achieved. Furthermore, as equal power is removed from the upper capacitor C1 and added to the lower capacitor C2, the law of conservation of energy is upheld. The amount of power that needs to be transferred between C1 and C2 is strictly a product of input/output voltages and currents and can be seen in the ratio of:

$$\vert \frac{{P}_{trans}}{{P}_{o}} \vert = \vert \frac{{I}_{s} - {I}_{o}}{{I}_{o}} \vert = \vert \frac{{V}_{s} - {V}_{o}}{{V}_{s}} \vert \leq 1. \qquad ( B7 )$$

The amount of power that needs to be transferred, Pₜᵣₐₙₛ, will always be less than the output power of the converter Pₒ as Vₛ−Vₒ≤Vₛ and |Iₛ−Iₒ|≤Iₒ. This is an important result as it implies that converters of this topology do not need to convert the entire input and output power Pₒ but rather just a conversion ratio dependent fraction of Pₒ. This effect can be demonstrated through a practical implementation of a capacitive power transfer scheme for the 2-capacitor circuit of FIG. 13.

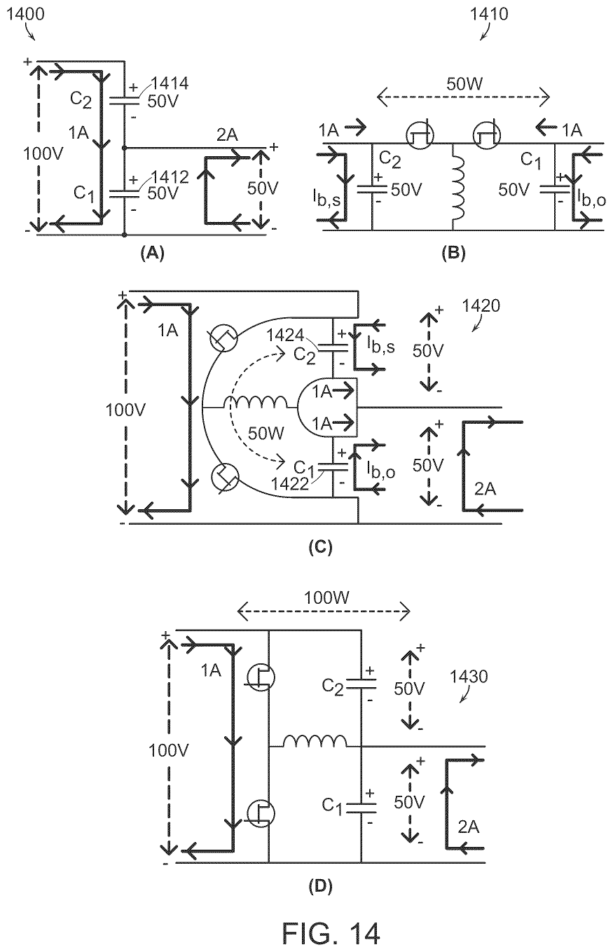

Although the capacitive power transfer to balance the circuit of FIG. 13 can be realized through different embodiments, an example scheme to do so is illustrated using a buck-boost converter scheme, illustrated in FIG. 14 which implements a 50 W buck-boost converter that is reconfigured into a 100 W half-bridge converter. The circuit diagrams of FIG. 14 show how a buck-boost converter can be connected within the stacked capacitor topology so that it effectively transfers power between C1 and C2. Particularly, circuit 1400 depicts the proposed stack capacitor topology (without the buck-boost power transfer scheme) that was discussed in relation to FIG. 13, while circuit 1410 is a 50 W buck-boost converter that is used to share power between the upper capacitor C2 (1414) and the lower capacitor C1 (1412). The two circuits 1400 and 1410 are folded into a combined buck-boost and stacked capacitor implementation, as depicted in circuit 1420, resulting in the 100 W half-bridge converter of circuit 1430.

The circuit 1420 also illustrates the current flows that are used to create the 100 W converter. To demonstrate the power transfers of the stacked capacitance topology, consider the following example. The complete converter has input values of Vₛ=100V and Iₛ=1 A, output values of Vₒ=50V and Iₒ=2 A, and an overall power Pₒ=100 W. The buck-boost converter, used for transferring power between capacitors C1 and C2 (marked as capacitors 1422 and 1424 in the completed folded converter circuit 1420 of FIG. 14) has input values of V_{b,s}=50V and I_{b,s}=A, output values of V_{b,o}=50V and I_{b,o}=1 A, and an overall power P_{b,o}=50 W. Thus, in the half bridge implementation of FIG. 14, the stacked capacitor topology handles less power than the total power flow.

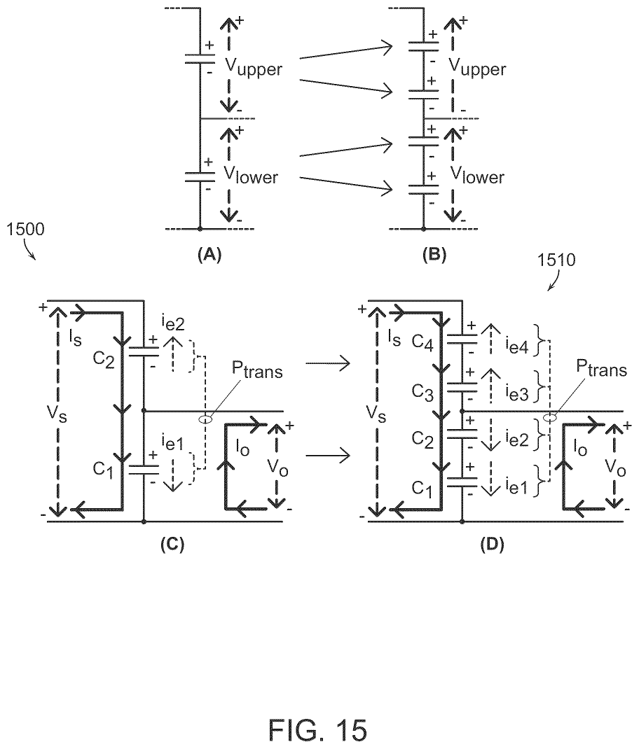

The model derived above for power transfer in a 2-capacitor topology for a 2-level converter can be expanded to N-level converter (since each of the capacitor in the 2-capacitor topology can be split into any arbitrary number of series capacitors). The process of expansion to N-levels begins with splitting each capacitor of FIG. 13 into two series capacitors, resulting in a converter of k=4 series capacitors and N=5 levels. An example implementation of such a splitting process is provided in FIG. 15, in which a 2-capacitor 2-level converter 1500 is split into a 4-capacitor 4-level converter 1510.

Analysis of this 4-capacitor converter follows the same process as the analysis of the 2-capacitor converter of FIG. 13. As noted, the converters of the stacked capacitors approaches described herein need to adhere to the laws of conservation of energy outlined above. The capacitors' currents due to externalities Iₛ and Iₒ are:

$$\begin{matrix}{i}_{C 1} = {I}_{S} - {I}_{O} , \\ {i}_{C 2} = {I}_{S} - {I}_{O} , \\ {i}_{C 3} = {I}_{S} , \\ {i}_{C 4} = {I}_{S} ,\end{matrix} \qquad ( B8 )$$

and the excess power within each capacitor for voltage balance is:

$$\begin{matrix}{P}_{e , C 1} = {V}_{C 1} ( {I}_{S} - {I}_{O} ) , \\ {P}_{e , C 2} = {V}_{C 2} ( {I}_{S} - {I}_{O} ) , \\ {P}_{e , C 3} = {V}_{C 3} {I}_{S} , \\ {P}_{e , C 4} = {V}_{C 4} {I}_{S} .\end{matrix} \qquad ( B9 )$$

It can be seen that the upper capacitors C3 and C4 have the same values for excess powers Pₑ and capacitor currents i_{C}. This is also true for the lower capacitors C1 and C2. The distinction between upper and lower capacitors can be made, and excess powers within the upper and excess powers within the lower capacitors combined. Thus:

$$\begin{matrix}{P}_{e , upper} = {P}_{e , C 3} + {P}_{e , C 4} = {I}_{S} {V}_{upper} \\ {P}_{e , lower} = {P}_{e , C 1} + {P}_{e , C 2} = ( {I}_{S} - {I}_{O} ) {V}_{lower} ,\end{matrix} \qquad ( B10 )$$

where the upper and lower voltages Vᵤₚₚₑᵣ and V_{lower} are

$$\begin{matrix}{V}_{upper} = {V}_{C 3} + {V}_{C 4} \\ {V}_{lower} = {V}_{C 1} + {V}_{C 2} .\end{matrix} \qquad ( B11 )$$

The total power needed to be transferred from the upper capacitors to the lower capacitors to maintain voltage balance in steady state is then Pₜᵣₐₙₛ=−P_{e,lower}=P_{e,upper}. An equivalency can then be drawn between the excess powers of the 4-capacitor converter and the excess powers of the 2-capacitor converter. For a given input/output voltage/current, the excess powers within the upper capacitors of both the 4-capacitor and the 2-capacitor converters are equal. The same is true for both sets of lower capacitors. This effect can be leveraged, and it can be seen that the magnitude of the required capacitance power transfer to maintain voltage balance in steady state does not change with the number of series capacitors in the stack (and therefore the number of levels). Furthermore, the number of capacitors below the output node does not need to equal the number of capacitors above the output node.

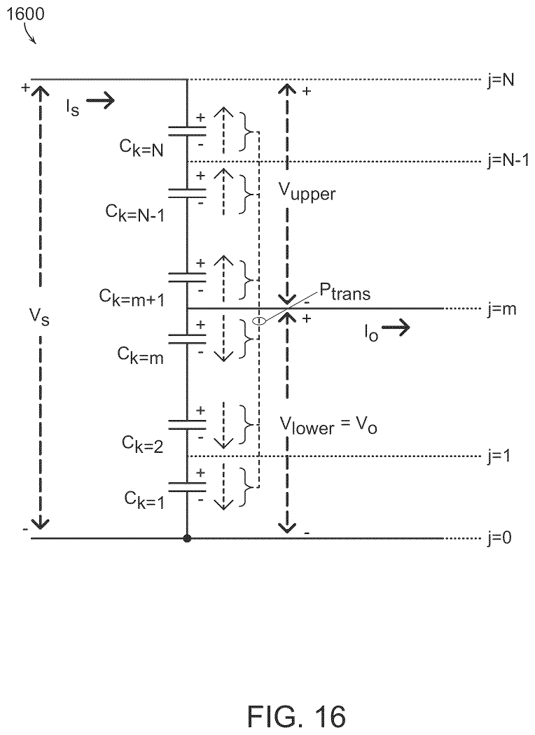

The theory behind the 2-capacitor and 4-capacitor converter can then be generalized for a converter of k-capacitors and N-levels. A generalized example of an N-level converter 1600 is depicted in FIG. 16. Nodes are numbered with the notation j and capacitors with the notation k. The output node is taken at node j=m, and capacitors 1<k<m belong to the set of lower capacitors, while capacitors m+1<k<N−1 are the upper capacitors. The capacitor currents due to Iₛ and Iₒ externalities are:

$$\begin{matrix}{I}_{c , lower} = {I}_{S} \\ {I}_{c , upper} = {I}_{S} - {I}_{O} .\end{matrix} \qquad ( B12 )$$

The excess powers are found in a similar manner as previously defined, namely:

$$\begin{matrix}{P}_{lower} = {\sum }_{k = 1}^{m} {i}_{ck} {V}_{ck} = {I}_{S} {V}_{upper} \\ {P}_{upper} = {\sum }_{k = m + 1}^{N - 1} {i}_{ck} {V}_{ck} = ( {I}_{S} - {I}_{O} ) {V}_{lower} .\end{matrix} \qquad ( B13 )$$

It is worth noting that the excess powers of the above generalized N-level converter match both the excess powers of the 4-capacitor converter and the 2-capacitor converter. The same relationship between the necessary power transfer for voltage balance Pₑ and the power of the converter Pₒ can be made, resulting in:

$$\begin{matrix}{P}_{O} = {I}_{S} {\sum }_{k = 1}^{N - 1} {V}_{ck} = {I}_{O} {\sum }_{k = 1}^{m} {V}_{ck} \\ {P}_{trans} = {I}_{S} {\sum }_{k = 1 + m}^{N - 1} {V}_{ck} = ( {I}_{S} - {I}_{O} ) {\sum }_{k = 1}^{m} {V}_{ck} .\end{matrix} \qquad ( B14 )$$

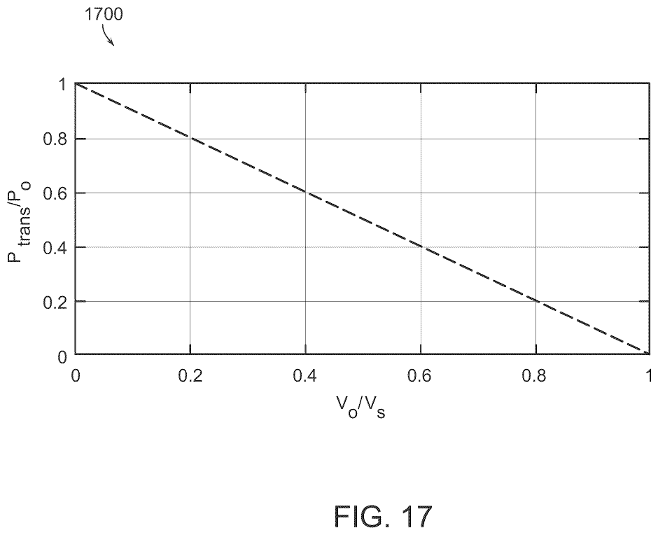

Two equivalent ratios of Pₜᵣₐₙₛ/Pₒ can then be found:

$$\begin{matrix}\vert \frac{{P}_{trans}}{{P}_{O}} \vert = \vert \frac{{I}_{S} {\sum }_{k = 1 + m}^{N - 1} {V}_{ck}}{{I}_{S} {\sum }_{k = 1}^{N - 1} {V}_{ck}} \vert = \vert \frac{{V}_{upper}}{{V}_{S}} \vert \\ \vert \frac{{P}_{trans}}{{P}_{O}} \vert = \vert \frac{{I}_{O} {\sum }_{k = 1}^{m} {V}_{ck}}{{I}_{O} {\sum }_{k = 1}^{m} {V}_{ck}} \vert = \vert \frac{{I}_{S} - {I}_{O}}{{I}_{O}} \vert\end{matrix} \qquad ( B15 )$$

where the Pₜᵣₐₙₛ/Pₒ ratio for the N-capacitor converter are the same as the ratio for 2-capacitor converter. The Pₜᵣₐₙₛ/Pₒ ratio as a function of the voltage conversion ratio Vₒ/Vₛ can be seen in FIG. 17. The above results show that Pₜᵣₐₙₛ does not depend on the number of levels. Furthermore, as can be seen in FIG. 17, the relationship between Pₜᵣₐₙₛ and conversion ratio Vo/Vₛ is linear and always less than 1 over the entire output voltage range. This has the implication that component stresses, for a given input/output voltage and power level, do not change with the number of levels. Therefore, this converter can be considered linearly scalable to N-levels with respect to both component quantities and component stresses.

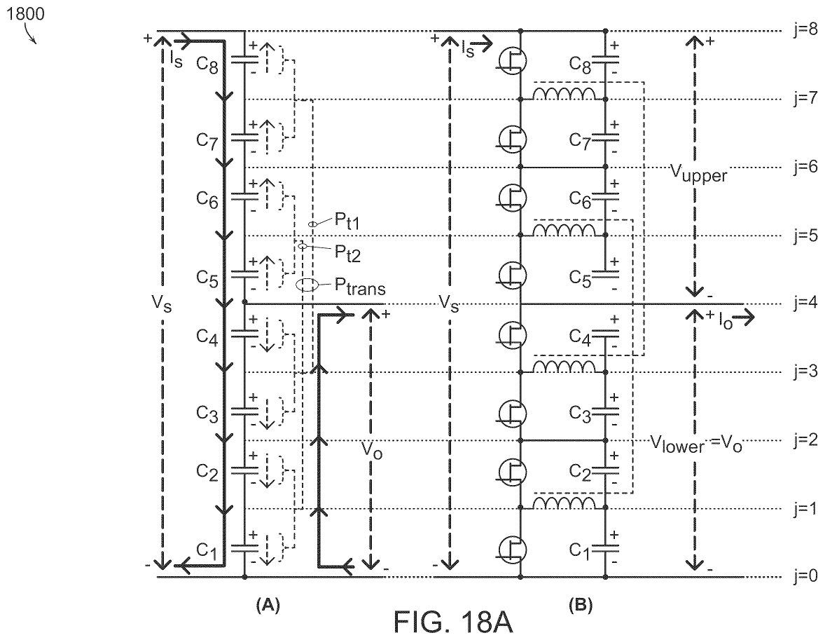

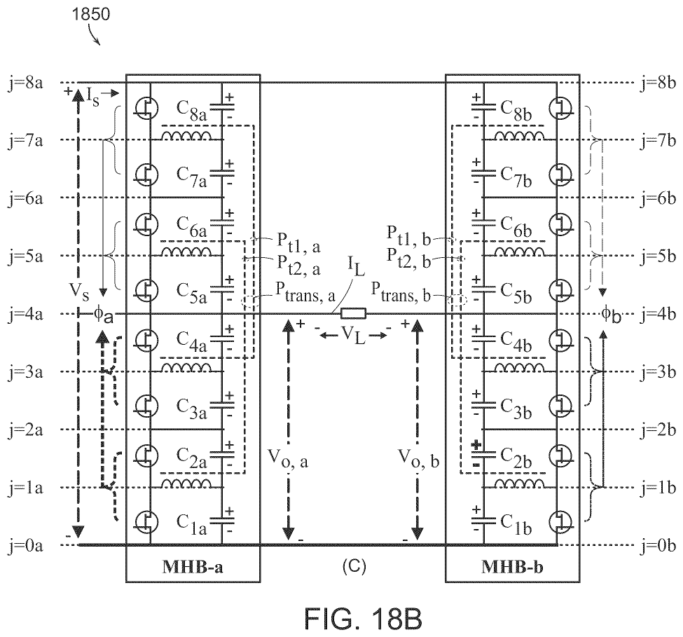

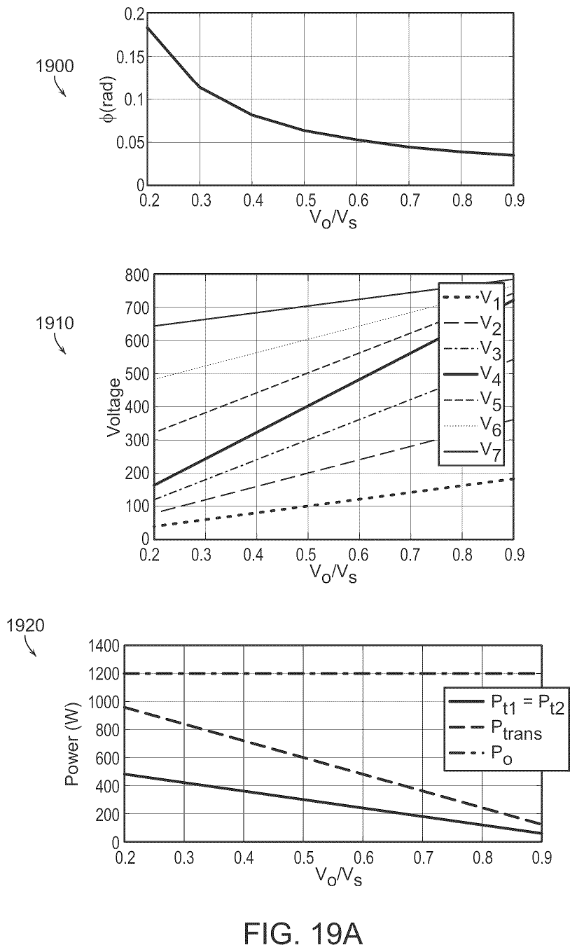

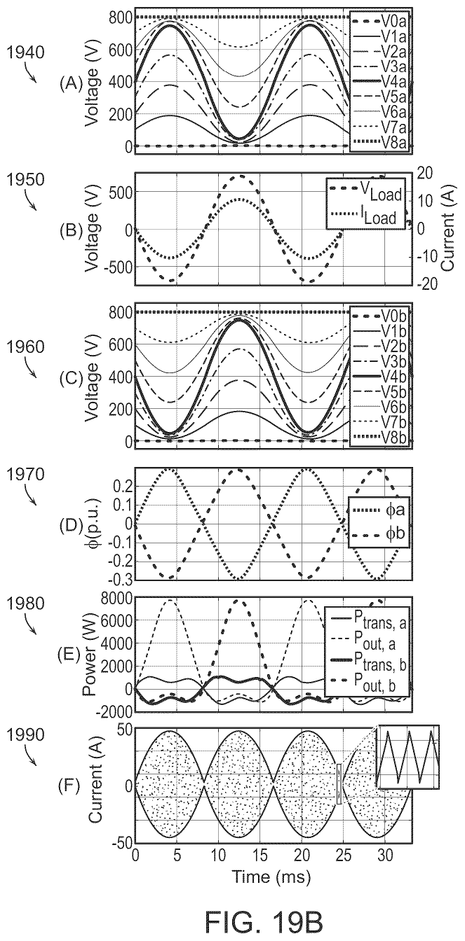

Different methods/techniques for implementing the capacitive power transfer links may be used. Two such methods are described herein. An example technique to implement a capacitive power transfer link is based on utilizing dual active half bridges to link capacitances together. An example circuit diagram 1800 for this approach is shown in FIG. 18A, which shows an 8-capacitor, 8-level converter, and an arrangement of multilevel dual active half bridge (DAHB) implementation to control capacitive power transfer. Each DAHB services a set of 4 capacitors, 2 upper capacitors and 2 lower capacitors. It is important to note that each side of the DAHB is on opposite sides of the output node. This is because power must be moved from the upper capacitors into the lower capacitors. Moving power from capacitors in a cascading (not exclusively from upper to lower) scheme will induce circulating currents. The duty cycle of every half-bridge is set to D=0.5. All half bridges, implemented herein for testing and evaluation, operate with the same parameters, and switching states are synced together. The synchronization of switching states is not necessary for functionality but was done for the sake of convenience. The phase difference ϕ, normalized to the switching period, between opposing sides of all DAHBs is the same. A PI controller was implemented to find the required phase difference ϕ between DAHBs to achieve a desired reference Vₒ. The voltage Vₒ was then varied from 0.2 Vs to 0.9 Vs, the results of which can be seen in FIG. 19A which includes a graph 1900 showing normalized phase difference ϕ between opposing sides of the DAHBs as a function of conversion ratio, a graph 1910 showing level voltages as a function of conversion ratio, and a graph 1920 showing power flows within the converter as function of conversion ratio.

In the implementation of the circuit of FIG. 18A, all the capacitors had the same value of C=200 μF. The leakage inductance of each coupled inductor, referred to as the primary, was Lₗₖ=4 μH. The turns ratio of each coupled inductor was n=1, and the switching frequency was set 250 kHz. Throughout the sweep of the output voltage the input/output power of the converter is held constant at Pₒ=1.2 kW with the input voltage Vₛ=800V. It can be seen from the graph 1910 of FIG. 19A that the voltages of each capacitor, and therefore the voltages of each level, ideally splits the full input voltage in conjunction with the output voltage. The capacitors above the output node evenly split the voltage Vₛ−Vₒ, and the capacitors below the output node evenly split the voltage Vₒ.

The phase difference ϕ between sides of the DAHBs can be seen in the graph 1900 of FIG. 19A. The power transfer over each inductive can be calculated according to:

$${P}_{L} = \frac{{V}_{C , upper} {V}_{C , lower}}{16 {f}_{sw} n {I}_{lk}} ϕ ( 1 - ϕ ) , \qquad ( B16 )$$

where P_{L} is the power transferred over an inductive coupling, V_{C,upper} is the voltage of a single upper capacitor, V_{C,lower} is the voltage of a single lower capacitor. Peak power transfer occurs at ϕ=0.5.

The power transfer per inductive coupling and total power transfer over all inductive couplings are shown in the graph 1920 of FIG. 19A. It can be seen that the predicted total power transfer and the measured (simulated) total power transfer align, and the power internally converted by the power converter (Pₜᵣₐₙₛ) is less than the output power Pₒ.

FIG. 18B includes a circuit diagram 1850 for a multilevel Full-Bridge (MFB) converter that is used for DC/AC conversion operations. Here too the MFB implementation used a leakage inductance of Lₗₖ=4 μH, capacitance values of C1-8=12 μF, coupled inductor turns ratio of n=1, input voltage Vₛ=800V, and switching frequency f_{sw}=250 kHz. Results of the DC/AC operations are provided in FIG. 19B, which include a graph 1940 showing individual level voltages for the MHB-a comprising the left half of the MFB, a graph 1950 showing the load voltage and current, a graph 1960 showing individual level voltages for MHB-b (the right half of the MFB, a graph 1970 ϕₐ and ϕ_{b} for MHB-a and MHB-b, respectively, a graph 1980 showing power transfer behavior for the MFB, and a graph 1990 showing the leakage inductor Lik current. The results illustrated in FIG. 19B demonstrate bidirectional power flow, as shown in the graph 1950 of FIG. 19B where the polarity of the load current alternates and power flows both in and out of each MHB. Ideal voltage splitting is maintained throughout the AC cycle and the control of ϕₐ and ϕ_{b} are effective in achieving the reference output AC waveforms. It can also be seen that the output power of each MHB Pₒᵤₜ is always greater than the internal amount of power than what needs to be converted Pₜᵣₐₙₛ to maintain capacitor voltage balance. Lastly, the leakage inductor current for a single DAHB is shown.

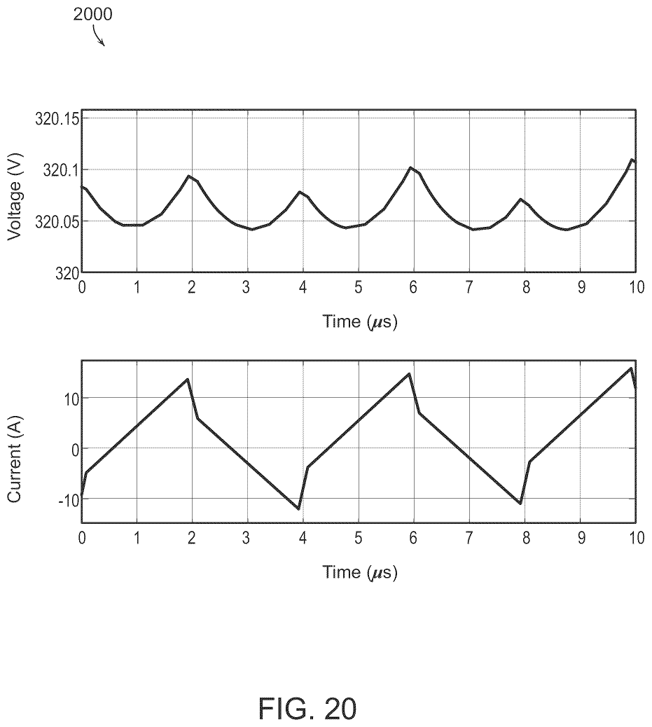

Lastly, the continuous time values of the converter operating with an effective conversion ratio of Vₒ/Vₛ=0.4 can be seen in FIG. 20. Typical DAHB inductor current and capacitor voltage ripples can be noted, showing that each DAHB, when used in this configuration, operates in the same manner as typically DAHBs. In this manner, the predicted results of the for the operation of the converter are validated. It can be seen that converters of this topological family do not need to convert the full output power, but rather just move a proportionally smaller amount of power from the upper set of capacitors to the lower set of capacitors. As this amount of power is proportional to the difference between input and output voltages, this topology can be considered as a new family of differential power converters.

Thus, as discussed herein, the proposed stacked capacitor multilevel topology is linearly scalable to N-levels and can function bidirectionally in both DC/DC and DC/AC modes of operation. This topology can be controlled through a potentially simple control scheme. The capacitive power transfer mechanism can be controlled through a single parameter (e.g., the phase difference ϕ between opposing sides of the DAHBs). Lastly, the amount of power that needs to be converted, or transferred, internally to the converter is less than the output power of the converter, an attribute that is unique to this multilevel topology.

In a second example embodiment, a framework for an adaptive power converter topology family, that can be defined through software for all combination of input and output requirements, is provided. This includes buck, boost, and buck/boost operations, with and without input to output isolation. Furthermore, this framework provides methods for multilevel interpretations, allowing for it to be applied to converters of arbitrarily high voltage levels. The framework includes a canonical switching cell upon which all converter types can be derived by selecting the corresponding input and output nodes of the cell. The canonical switching cell can be vertically stacked to achieve a multilevel interpretation of the buck, boost, and buck/boost converters. The control complexity does not increase when vertically stacked. The multilevel converter built on the proposed framework has linear component quantity, voltage stress, and current stress scaling and can be analyzed as a single canonical switching cell through a recursive approach. Thus, this example framework presents an interpretation of the dual active half bridge (DAHB) as a canonical switching cell upon which all converter input and output (buck, boost, buck/boost) characteristics can be achieved both with and without isolation. Furthermore, this canonical switching cell can be stacked in a linear manner, resulting in a multilevel interpretations of this topological framework.

Through reconfiguration and/or stacking of the canonical switching cell, buck, boost, and buck/boost of arbitrary voltage and current levels for isolated or non-isolated applications can be derived. Such reconfiguration can be achieved through software definition and reconfiguration of a single converter or converter topology. The proposed framework can be leveraged to take the place, or be used as a source of derivation, for any power converter for all applications.

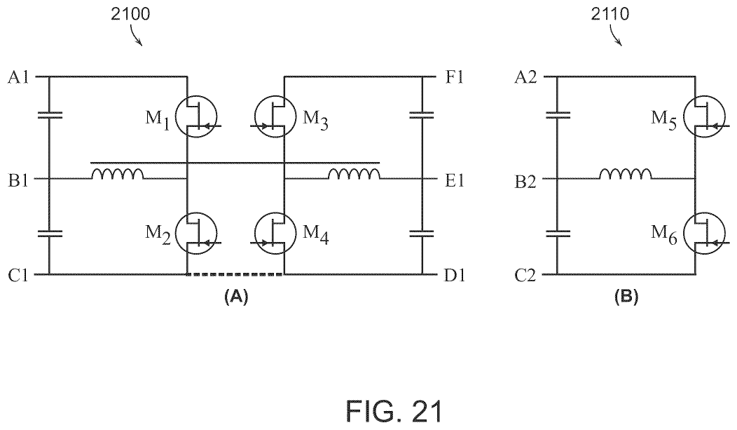

FIG. 21 includes circuit diagrams 2100 and 2110 of canonical switching cells. Specifically, the circuit 2100 is an isolated canonical switching cell (DAHB), buck/boost interpretation, while the canonical circuit 2110 is a non-isolated canonical switching cell (half-bridge), buck interpretation.

Consider the circuit 2100 upon which the overarching topology is built. This switching cell is widely known as the dual active half bridge (DAHB). The DAHB depicted in the circuit diagram 2100 can be considered the isolated version of the canonical switching cell, and the circuit of diagram 2110 which is topologically identical to a half-bridge converter, can be considered to be the non-isolated version of the canonical switching cell. The non-isolated canonical switching cell can be derived from its isolated counterpart. This can be seen visually as nodes A2, B2, C2 of the circuit 2110 align with nodes A1, B1, C1 of the converter circuit 2100 of FIG. 21 if there is no power transferred across the inductive coupling.

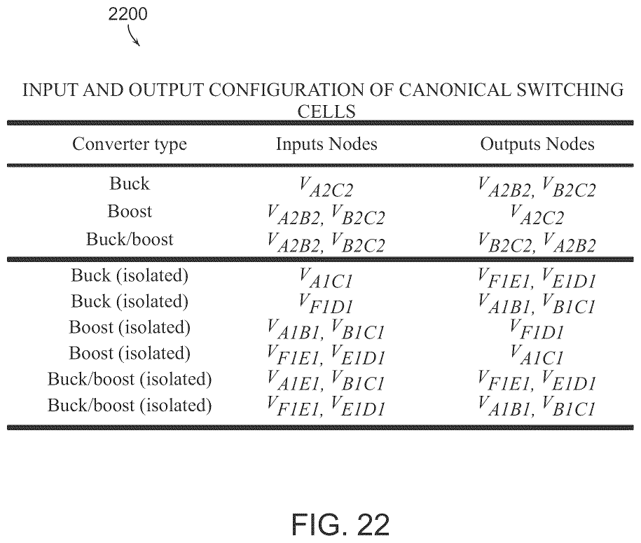

It is worth noting that the converter circuit 2100 operates and retains identical characteristics as a DAHB, and that circuit 2110 retains identical characteristics as a half-bridge. This includes the characteristic that the ratio of capacitor voltages can be controlled to be set to any arbitrary value. Furthermore, depending on how the input and output nodes are configured, both the isolated and non-isolated canonical switching cells can act as any of the three typical power converter types (buck, boost, and buck/boost), as can be seen from table 2200 of FIG. 22.

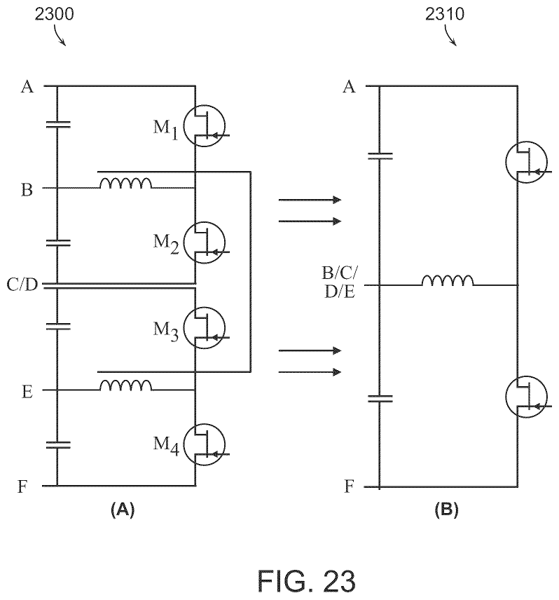

Circuit 2300 of FIG. 23 shows a reconfiguration of the circuit of 2100, through connection of nodes C1 and D1, into a stacked multilevel non-isolated topology, buck interpretation. The circuit 2300 can also be considered a multilevel topology, and can be expanded to an arbitrary N number of levels. Circuit 2310 shows a non-isolated canonical switching cell buck interpretation equivalent of the circuit 2300.

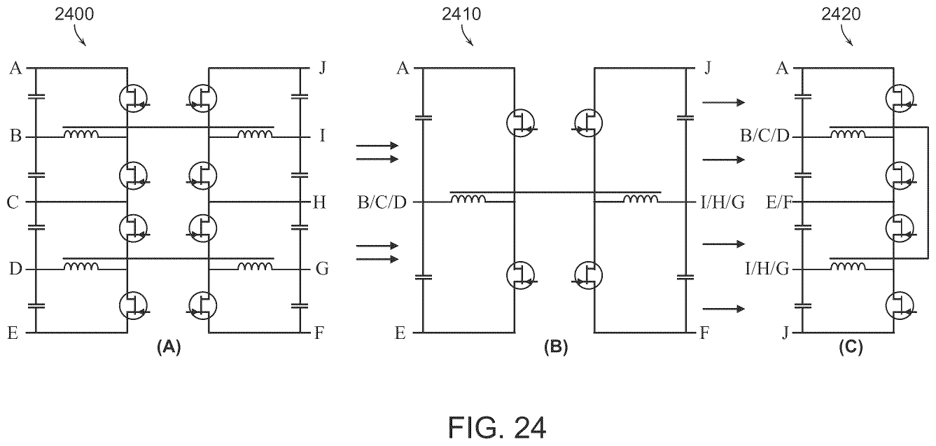

In a similar manner to the process taken to achieve the circuits of FIG. 23, the canonical switching cells of FIG. 21 can be vertically stacked to achieve a multilevel topology, with input/output characteristics similar to those of the canonical switching cell. The non-isolated cell can be stacked into a multilevel converter. An isolated multilevel topology can be achieved through simply stacking isolated cells. FIG. 24 includes circuit diagrams illustrating the stacking of non-isolated canonical switching cells to achieve a multilevel converter. The circuit 2400 is a multilevel converter with an isolated topology, buck/boost interpretation. The circuit 2400 includes four levels arranged into two stacked isolated switching cells. This isolated multilevel converter is simply two DAHBs placed on top of each other. The circuit 2400 can also be interpreted as a single DAHB, as illustrated in circuit 2410 of FIG. 24 which illustrates the implementation as a canonical switching cell equivalent of the circuit 2400. Circuit 2420 is a reconfigured iteration of circuit 2410 into a stacked non-isolated multilevel buck interpretation. For a given input/output voltage and current, the sum of the power transferred over the inductive couplings of circuit 2410 is equal to the power transferred over the inductive coupling of the circuit 2310 of FIG. 23. Likewise, the capacitor and switch voltage stresses of the converter 2400 of FIG. 24 are split by two when compared with the converter 2410.

Similar to the process illustrated in FIG. 23, the isolated multilevel circuits of FIG. 24 can be reconfigured and stacked again, resulting in the converter circuit 2420. The converter circuit 2420 is a non-isolated multilevel topology, similar to that shown in FIG. 23, which is both composed of canonical switching cells and can be interpreted as a canonical switching cell itself. This lends the proposed topological framework to a recursive approach where a single canonical switching cell can be stacked and reconfigured into a larger multilevel converter, but can function in the same manner as the single canonical switching cell that it is composed of.

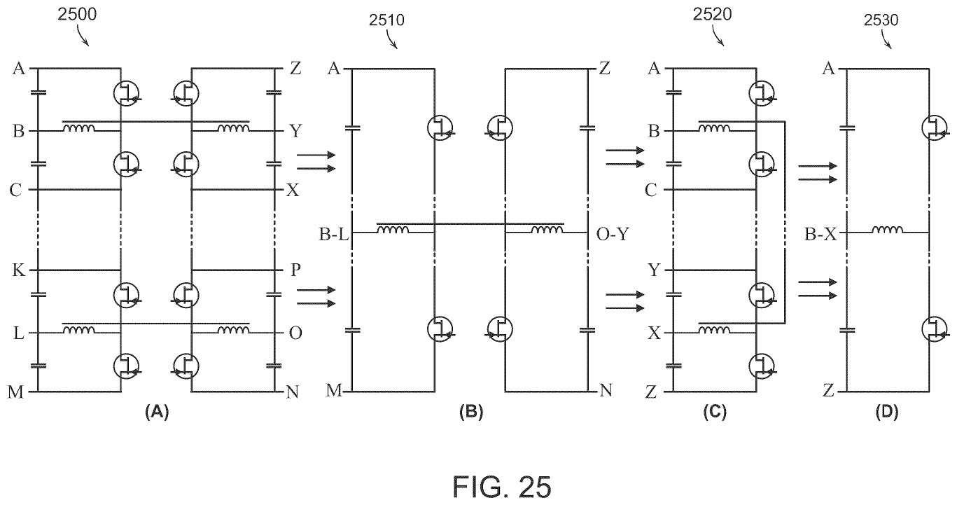

Furthermore, these topologies discussed herein can be expanded to an arbitrary N levels. Expanding the isolated canonical switching cell involves simply stacking additional cells on top of each other to achieve the desired number of levels which can be seen in FIG. 25, which includes a converter circuit 2500 with a stacked N level isolated topology, buck/boost interpretation, a converter circuit 2510 with an isolated canonical switching cell equivalent of the circuit 2500, a converter circuit 2520 which is a reconfiguration of the circuit 2500 and 2510 into a multilevel buck interpretation, and a converter circuit 2530 which is a non-isolated canonical switching cell equivalent of the circuit 2520. More particularly, similar to the converter circuits of FIG. 24, the N-level converter circuit 2500 of FIG. 25 can also be interpreted as a canonical switching cell (as illustrated by converter circuit 2510 of FIG. 25). The isolated circuits 2500 and 2510 of FIG. 25 can then be reconfigured into a non-isolated multilevel topology of N-levels as seen in the circuit 2510. This non-isolated multilevel topology can also be interpreted as a non-isolated canonical switching cell, as shown in the circuit 2530.

As noted, each canonical switching cell can control the voltages of its capacitors to an arbitrary ratio. For the multilevel multi-cell interpretation, this allows for the entire voltage (V_{AZ} for the non-isolated topology of the circuit 2520), V_{AM} and VAN for the isolated topology of the circuit 2510 to be distributed across the capacitors in any ratio, allowing for linear component stress scaling with N. As the component quantities also scale linearly with N, this topological framework can be considered linearly expandable with respect to both component quantities and component stresses, which is ideal for multilevel applications with very high input and output voltages. The parameters that can be adjusted to control cell voltages and power flows are the duty cycles D of each half bridge and the total power transferred over each inductive coupling Pₜᵣₐₙₛ. For the sake of analytical simplicity, the duty cycles can all be assumed as D=0.5 as this will ensure the capacitors within each half bridge have equal voltage stress. Therefore, Pₜᵣₐₙₛ can exclusively be used to adjust the operating point of the converter.

For the isolated converter, calculating the output voltage as a function of Pₜᵣₐₙₛ is straightforward as the entirety of the output power is passed through the inductive couplings. It can be seen that:

$$\begin{matrix}{V}_{out} = \frac{{P}_{trans}}{{I}_{out}} , \\ {P}_{trans} = {\sum }_{i}^{k} {P}_{Li} ,\end{matrix} \qquad ( B17 )$$

where k is the number of inductive couplings and P_{Li} is the power transferred over each individual inductive coupling. If the power transferred over each inductive coupling is equal, then:

$$\begin{matrix}{P}_{Li} = {P}_{L} \\ {P}_{trans} = k {P}_{Li} .\end{matrix} \qquad ( B18 )$$

In this manner the output voltage Vₒᵤₜ can be controlled through the sum of the power transferred over the inductive couplings. Finding the output voltage Vout as a function of Pₜᵣₐₙₛ for the non-isolated converter is less straightforward as only a portion of the output power needs to be transferred over the inductive coupling. The portion of the output power that needs to be transferred over the inductive coupling changes with the conversion ratio Vow/Vin of the converter and is equal to:

$$\frac{{P}_{trans}}{{P}_{out}} = 1 - \frac{{V}_{out}}{{V}_{i n}} . \qquad ( B19 )$$

Simple algebraic manipulation provides Vₒᵤₜ as a function of Pₜᵣₐₙₛ

$${V}_{out} = {V}_{i n} ( 1 - \frac{{P}_{trans}}{{P}_{out}} ) , \qquad ( B20 )$$

where Pₜᵣₐₙₛ is the sum of power transferred across all inductive couplings. For the non-isolated topology, it is important that opposing sides of each DAHB canonical cell are on opposing sides of the output node, as power needs to be transferred from above the output node to below the output node to maintain capacitor voltage balance in steady state. The power transferred over a single inductive coupling P_{L} (for both the non-isolated and isolated) cases can be calculated with

$${P}_{L} = \frac{{V}_{CL} {V}_{CR}}{16 {nL}_{lk}} ϕ ( 1 - ϕ ) , \qquad ( B21 )$$

where ϕ is the phase difference in switching cycles between opposing sides of each DAHB, normalized to the switching period. V_{CL} is the sum of capacitor voltages on one side of the DAHB and V_{CR} is the sum of capacitor voltages on the opposite side. The parameter n is the turns ratio of the coupled inductor and Lₗₖ is its leakage inductance referred to one side. It is worth noting that Equation (B21) is not unique to this topology and holds true for all DAHB's.

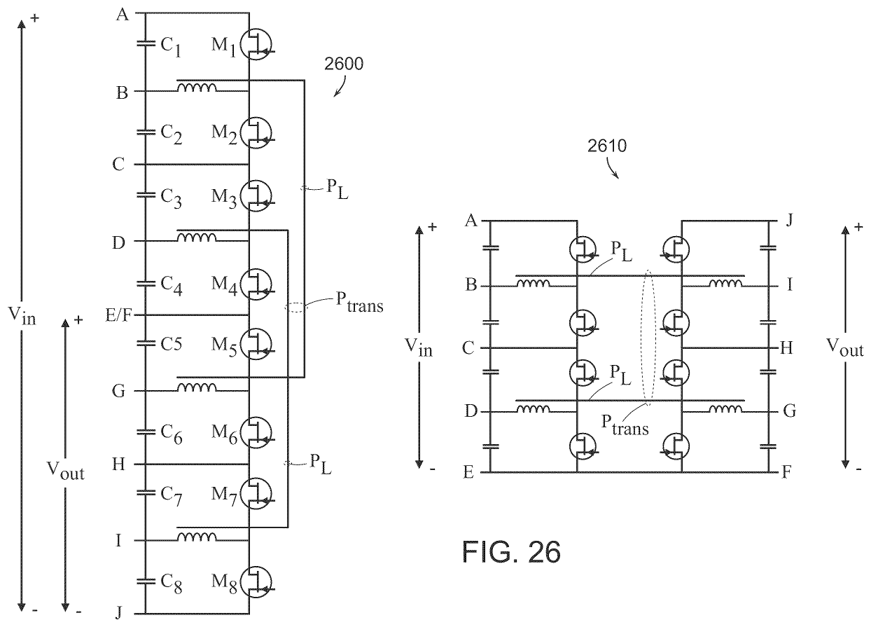

The proposed topology using canonical switching cells was validated through high-fidelity simulation of the non-isolated circuit 2600 of FIG. 26, showing a buck interpretation non-isolated multilevel converter, and the isolated circuit 2610 of FIG. 26, providing a buck/boost interpretation of an isolated multilevel converter.

For the non-isolated circuit 2600, the input voltage was applied across nodes V_{AJ} and the output was taken across nodes V_{E/F,J}. The isolated circuit 2610 input was applied across nodes V_{AJ} and output taken across V_{JF}. For both circuits the input voltage has a value Vᵢₙ=800V. All capacitances had the same value of 68 μF. The leakage inductance of each coupled inductor was 4 μH with a turns ratio of n=1. The switching frequency was held constant at F_{sw}=250 kHz. The duty cycle of all half-bridges was set to a constant value of D=0.5. The phase difference ϕ, normalized to the switching period, was configured to be the same for all DAHBs. A single PI controller was implemented to find the required phase difference ϕ to achieve a desired output voltage Vow.

The output power Pₒᵤₜ was held constant at 1.2 kW for both circuits. A resistive load was applied that changed value over the output voltage sweep to maintain a constant output power. For the non-isolated circuit, the output voltage was swept from 0.25Vᵢₙ≤Vₒᵤₜ≤0.75Vᵢₙ. The isolated circuit output voltage was swept from 0.5Vᵢₙ≤Vₒᵤₜ≤1.5Vᵢₙ.

The voltage results for the tested circuits showed that the levels (and the capacitors) have ideal voltage splitting. This is beneficial for multilevel topologies, as this ensures voltage stresses across the stack of components are evenly distributed and no single switch or capacitor sees a higher voltage than necessary. This allows for control and conversion of voltages higher than the rating of any individual component. The power results showed that the output power Pₒᵤₜ is effectively supported by the power transfer through the inductive couplings. For the isolated case, all output power flows through the inductive couplings. For the non-isolated case, only a proportion of the output power flows through the inductive couplings. This is because the inductive couplings do not need to support the whole output current, but only the amount of power necessary to maintain capacitor voltage balance in steady state. As a result, the amount of power that is converted, Pₜᵣₐₙₛ, is less than the output power Pₒᵤₜ, an attribute unique to this converter. Lastly, the inductor current results show that each DAHB, when configured into the proposed topological framework, still retains functional characteristics of a typical DAHB. The predicted results developed in the above equations for the canonical switching cell topologies matched the simulated results.

Thus, the topological framework developed herein shows that the proposed canonical switching cells can be reconfigured to achieve a power converter of any arbitrary input, output, voltage, current, and isolation requirements. A single cell can be stacked vertically, without any extra topological connections and linear component quantities and stresses, to achieve a high voltage multilevel converter. Cells can also be stacked horizontally to increase current handling capabilities. Furthermore, the control complexity does not increase with the number of cells, as all steady state output voltages can be achieved by adjust a single variable (#). This framework can be used to create power converters controlled through software configuration, which can allow for a single converter design to be used for any application through software reconfiguration.

Accordingly, in some variations of the voltage converter systems described herein, each of the plurality of voltage converter cells defines a configurable canonical switching cell, with the configurable canonical switching cell being one of, for example, an isolated canonical switching cell with a controllable dual active half bridge (DAHB) converter circuit, or a non-isolated canonical switching cell with a controllable half bridge (HB) converter circuit. In such embodiments, each half bridge of the isolated canonical switching cell or the non-isolated canonical switching cell includes two capacitors, two respective switches, and an inductive coupling, each capacitor being electrically coupled at one of its respective terminals to one gate of the respective switch and coupled at another of its respective terminals to a common terminal of the indictive coupling. The inductive coupling is electrically coupled at its other terminal to respective second gates of the two switches. The canonical switching cell includes configurable input and output nodes that control operability of the configurable canonical switching cell as one of, for example, a buck converter, a boost converter, or a buck/boost converter.

Turning now to a third example embodiment of a multi-level voltage converter system, a stacked capacitor multilevel topological framework for the Manhattan configuration is analyzed. Increased voltage is achieved through the series connection of capacitors. Converter performance is defined through the control of the amount of power shared between capacitors. This enables the voltage across the entire set of series capacitors to be arbitrarily distributed amongst each individual capacitance, allowing for the control and conversion of voltages higher than the rating of any individual component, which is a necessity for any multilevel topology. Voltage balance can be maintained in steady state and component quantities scale linearly with the number of levels.

As noted, the Manhattan Configuration is a multilevel topological framework with linear component quantity and stress scaling to N-levels. It is composed of a center stack of capacitors where each capacitor defines a single level of the converter. The functionality of the converter is controlled through the movement of power between capacitors in the center stack. It can be shown that the amount of power that needs to be moved between these capacitors to maintain voltage balance in steady state is less than the output power of the converter, denoting the differential aspect of this topological framework. Four capacitive power transfer methods are discussed as well as state space equations for each that can be used for future control formulations.

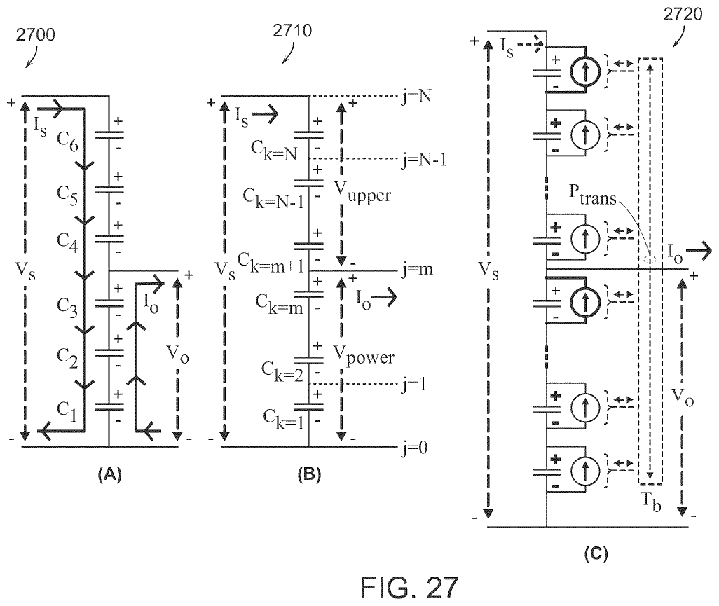

The Manhattan Configuration is defined by a set of series capacitors where each capacitor represents an additional level of the entire multilevel converter. The generalized Manhattan configuration can be seen in FIG. 27 showing a converter circuit 2700 with a 6-level implementation, a converter circuit with N-level implementation, and a circuit 2720 showing the capacitive power transfer scheme with connectivity of Tb. In the following analysis, for the sake of brevity the discussion will consider the converters to always be operating in step-down buck mode. However, the analysis is applicable for all other voltage converter types.

Analysis of the circuits 2700 and 2710 begins with the law of conservation of energy:

$${V}_{upper} {I}_{C , u} = - {V}_{lower} {I}_{C , l} , \\ {P}_{e , upper} = {P}_{e , lower} = {P}_{trans} \qquad ( B22 )$$

where the excess powers in the upper and lower, P_{e,upper} and P_{e,lower}, are equal in magnitude but opposite in sign. This is a convenient result as it implies that capacitor voltage balance in steady state can be achieved by internally sending excess power of the quantity Pₜᵣₐₙₛ from the upper capacitors to the lower capacitors, cancelling out the entirety of the excess powers in the process.

The capacitive power transfer can be visualized in the circuit 2720 of FIG. 27 where T_{b} is a connectivity matrix that defines the capacitive power transfer links. The power transfer between capacitances can be considered as current sources in parallel with each capacitor where the role of each current source is to support capacitor voltage balancing.

A state space model with respect to capacitor voltages can then be defined. Iₛ and Iₒ can be considered external current flows, and the nomenclature iₑ=[Iₛ, Iₒ]′ is ascribed. The relationship between capacitor current and capacitor voltage is:

$${dV}_{c} = \frac{{I}_{c}}{C} dt \qquad ( B23 )$$

where I_{c} is the total capacitor current and C is the capacitance value. I_{c} can be split into two components, the capacitor current due to externalities iₑ, and the capacitor current due to internal capacitive power transfer links i_{b}. Thus:

$${dV}_{c} = \frac{{i}_{e} + {i}_{b}}{C} dt . \qquad ( B24 )$$

The equation for capacitor voltage of (B24) can then be reconfigured into a state space formulation of:

$${V}_{c}^{+} = {V}_{c} + \frac{{T}_{s}}{C} {T}_{b} {i}_{b} + \frac{{T}_{s}}{C} {T}_{e} {i}_{e} , \qquad ( B25 )$$

with a constraint of V_{c}T_{b}i_{b}=0.

This state space model can be used as a foundation to formulate an optimized control method. The constraint represents the limitation that the sum of the powers into each capacitor that comes from the internal capacitive power transfer mechanisms must equal zero. V_{c} is a vector of capacitor voltages V_{c}=[V_{C,1}, V_{C,2}, . . . V_{C,N}]′. Tₛ is the sample interval of the controller upon which this state space model runs. Tₑ is a topology matrix that represents the connectivity of the input and output nodes and when multiplied with iₑ results in the individual capacitor currents due to externalities Iₛ and Iₒ. For reference, the topology matrix Tₑ of FIG. 27 is:

$${T}_{e} = [ \begin{matrix}1 & 0 \\ 1 & 0 \\ 1 & 0 \\ 1 & - 1 \\ 1 & - 1 \\ 1 & - 1\end{matrix} ] \qquad ( B26 )$$

Tₑ also represents the direction of current flow of the external input and output currents. This shows how it is necessary to transfer power from cells above the output node to cells below the output node to maintain capacitor voltage balance in steady state. The final components of the state space model of Equation (B25) are Tb and Ib, which jointly represent the internal capacitive power flows. Tb is a connectivity matrix that defines which capacitors are linked together and can share power with each other, and Ib is a vector that denotes the amount of power that gets shared across each capacitive power transfer link. Tb and Ib are unique to each capacitive power transfer scheme.

As noted, a capacitive power transfer scheme is necessary to maintain capacitor voltage balance in steady state. The exact method of power transfer is not crucial for the functionality of the topology but will impact the overall converter performance. Four example methods of capacitive power transfer are discussed below. They include an example 8-capacitor 8-level converter that is used to demonstrate each capacitive power transfer scheme.

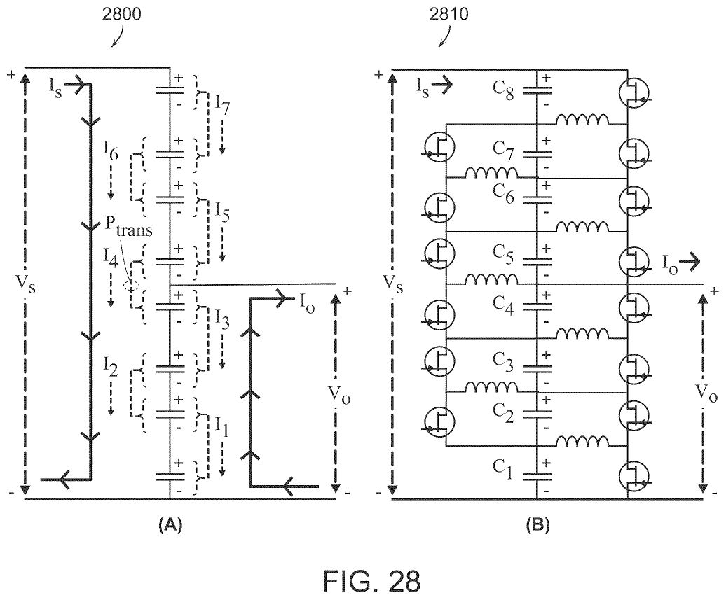

The first capacitive transfer scheme to be considered is based on a Half-Bridge (HB) configuration. Half-bridges (HB) allow for power transfer between two adjacent capacitors in the center capacitance stack. By interleaving half bridges along the stack, all capacitors are connected together in a cascading manner. FIG. 28 includes a converter diagram 2800 of an 8-level half-bridge implementation of the Manhattan converter circuit showing the internal power flow diagram, while circuit 2810 shows the full circuit schematic of this HB implementation. This HB circuit has a connectivity matrix Tb and link current vector Tb of:

$${I}_{b} = [ \begin{matrix}{I}_{1} \\ {I}_{2} \\ {I}_{3} \\ {I}_{4} \\ {I}_{5} \\ {I}_{6} \\ {I}_{7}\end{matrix} ] , {T}_{b} = [ \begin{matrix}1 & 0 & 0 & 0 & 0 & 0 & 0 \\ - 1 & 1 & 0 & 0 & 0 & 0 & 0 \\ 0 & - 1 & 1 & 0 & 0 & 0 & 0 \\ 0 & 0 & - 1 & 1 & 0 & 0 & 0 \\ 0 & 0 & 0 & - 1 & 1 & 0 & 0 \\ 0 & 0 & 0 & 0 & - 1 & 1 & 0 \\ 0 & 0 & 0 & 0 & 0 & - 1 & 1 \\ 0 & 0 & 0 & 0 & 0 & 0 & - 1\end{matrix} ] \qquad ( B27 )$$

It can be seen from the above representations of I_{b} and T_{b} that each HB is considered to remove power from one capacitor and transfer it to another (for the topmost HB of circuits 2800 and 2810 of FIG. 28, positive power flow is considered as power removed from C8 and sent to C7). This capacitive power transfer scheme has the benefit of not requiring any inductive couplings, however, its cascading nature results in circulating currents, the entirety of which pass through the center HB that straddles the output node. This is because each capacitor must support the current of its adjacent capacitors. In the circuits of FIG. 28, the power needed to support C1 must come from the upper capacitors and pass through C4, C3 and C2 before it reaches C1. Likewise, power needed to support C2 must pass through C4 and C3 before it reaches C1. This results in nonlinear component stress scaling with the number of levels. For this reason it is not recommended to be used outside of high conversion ratio and low power applications.

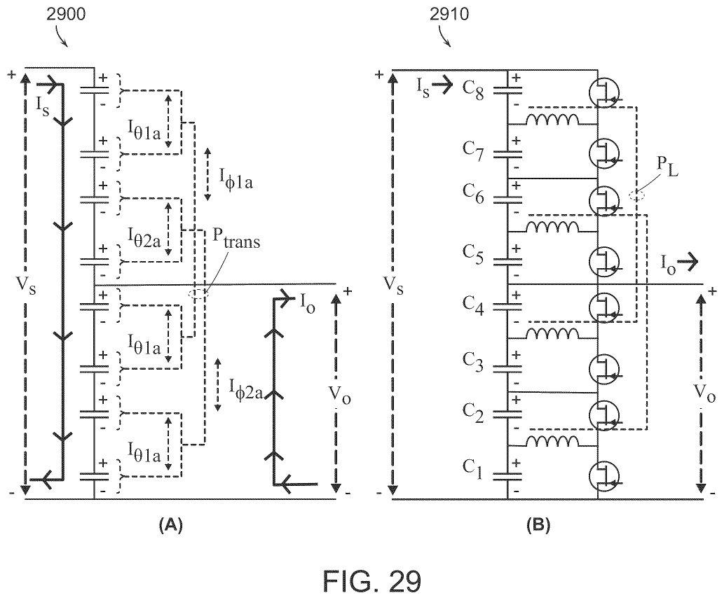

A second capacitive transfer scheme to be considered is based on dual active half bridges (DAHB) that allow for the power transfer from a set of two adjacent capacitors to another set of two adjacent capacitors across an isolated inductive coupling. One set of two adjacent capacitors belongs to the set of upper capacitors and the complementary set of two adjacent capacitors belongs to the set of lower capacitors. FIG. 29 includes diagrams of the DAHB-based capacitive transfer control implementation, with diagram 2900 showing the internal power flow of the implementation, and diagram 2910 showing the complete circuit diagram for a DAHB-based capacitive transfer implementation.

The DAHB circuit has a connectivity matrix T_{b} and link current vector I_{b} of

$${I}_{b} = [ \begin{matrix}{I}_{ϕ1} \\ {I}_{θ1 a} \\ {I}_{θ1 b} \\ {I}_{ϕ2} \\ {I}_{θ2 a} \\ {I}_{θ2 b}\end{matrix} ] , {T}_{b} = [ \begin{matrix}1 & 1 & 0 & 0 & 0 & 0 \\ 1 & - 1 & 0 & 0 & 0 & 0 \\ 0 & 0 & 0 & 1 & 1 & 0 \\ 0 & 0 & 0 & 1 & - 1 & 0 \\ - 1 & 0 & 1 & 0 & 0 & 0 \\ - 1 & 0 & - 1 & 0 & 0 & 0 \\ 0 & 0 & 0 & - 1 & 0 & 1 \\ 0 & 0 & 0 & - 1 & 0 & - 1\end{matrix} ] \qquad ( B28 )$$

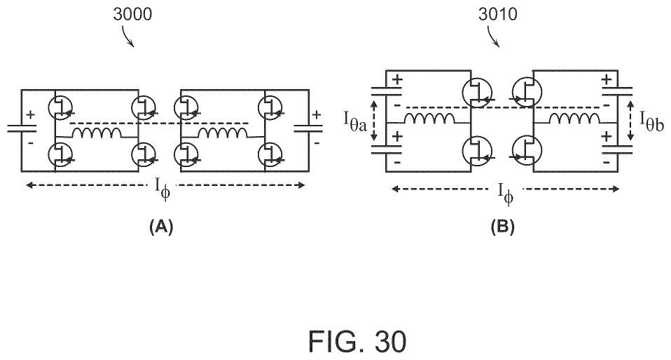

It is important to note the ascribed functionality of each DAHB. Each DAHB services a set of four capacitors. I_{ϕ} and I_{θ} represents the component of balancing capacitor current due to power flow across the inductive coupling and power flows within each individual half bridge, respectively. This can be visualized in circuit 3010 of FIG. 30. Transferring power over inductive couplings results in the elimination of the circulating currents present in the HB capacitive power transfer scheme. This is because power can flow directly from the upper set of capacitors to the lower set of capacitors without having to travel through any intermediate set of capacitors. This results in linear component stress scaling with number of levels.

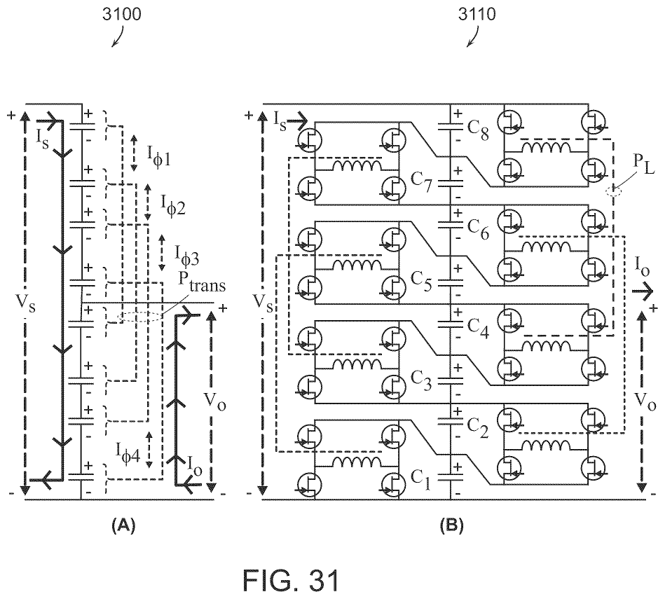

A third capacitive transfer scheme to be considered is based on a dual active full-bridges (DAFB) configuration to allow for power transfer between two capacitors across an isolated inductive coupling. Each DAFB services two capacitors, one upper capacitor and one lower capacitor. This allows for direct transfers of excess powers from an upper capacitor to a lower capacitor. FIG. 31 includes diagrams of the DAFB-based capacitive transfer control implementation, with diagram 3100 showing the internal power flow of the implementation, and diagram 3110 showing the complete circuit diagram for a DAFB-based capacitive transfer implementation.

This DAFB circuit has a connectivity matrix T_{b} and link current vector I_{b} of

$${I}_{b} = [ \begin{matrix}{I}_{ϕ1} \\ {I}_{ϕ2} \\ {I}_{ϕ3} \\ {I}_{ϕ4}\end{matrix} ] , {T}_{b} = [ \begin{matrix}1 & 0 & 0 & 0 \\ 0 & 1 & 0 & 0 \\ 0 & 0 & 1 & 0 \\ 0 & 0 & 0 & 1 \\ - 1 & 0 & 0 & 0 \\ 0 & - 1 & 0 & 0 \\ 0 & 0 & - 1 & 0 \\ 0 & 0 & 0 & - 1\end{matrix} ] \qquad ( B29 )$$

Each value in I_{b} represents the power transferred over each inductive coupling. This can be visualized in the circuit 3000 of FIG. 30. It is important to note the connectivity of each DAFB in this example. As shown in FIG. 31, it is not strictly necessary to connect the inductive couplings in an alternating approach. As long as each inductive coupling traverses the output node the functionality of this capacitive power transfer scheme is maintained (an outer-inner approach will also work). If this is not the case, then circulating currents identical to those of the HB example will be induced.

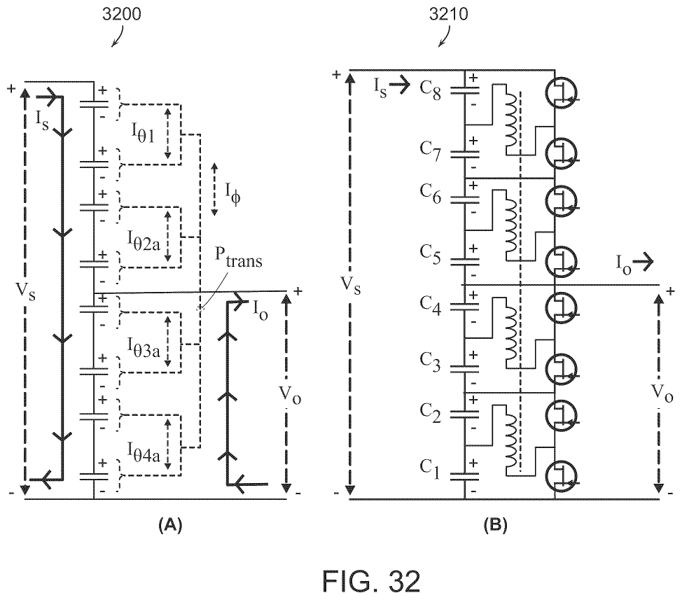

A fourth capacitive transfer scheme uses a common inductive bus through which power flows from the upper set of capacitors to the lower set of capacitors. This configuration can be implemented with DAHB or DAFB control configurations. FIG. 32 includes diagrams of the DAHB-based capacitive transfer control implementation with a shared common inductive bus, with diagram 3200 showing the internal power flow of the implementation, and diagram 3210 showing the complete circuit diagram for a DAHB-based capacitive transfer implementation using the common inductive bus.

The DAHB implementation of the common inductive bus has a connectivity matrix T_{b} and link current vector I_{b} of:

$${I}_{b} = [ \begin{matrix}{I}_{ϕ} \\ {I}_{θ1} \\ {I}_{θ2} \\ {I}_{θ3} \\ {I}_{θ4}\end{matrix} ] , {T}_{b} = [ \begin{matrix}1 & 1 & 0 & 0 & 0 \\ 1 & - 1 & 0 & 0 & 0 \\ 1 & 0 & 1 & 0 & 0 \\ 1 & 0 & - 1 & 0 & 0 \\ - 1 & 0 & 0 & 1 & 0 \\ - 1 & 0 & 0 & - 1 & 0 \\ - 1 & 0 & 0 & 0 & 1 \\ - 1 & 0 & 0 & 0 & - 1\end{matrix} ] \qquad ( B30 )$$

It is also worth noting that any mixture of the three (3) types of capacitive power transfer mechanisms (HB, DAHB, and DAFB), both with and/or without a common inductive bus, can be used in a single converter. The only requirement is that whatever method is chosen can send sufficient power from the upper set of capacitors to the lower set of capacitors. As long as there is a path for each upper capacitor to send power to the lower set of capacitors and a path for each lower capacitor to receive power from the set of upper capacitors, capacitor voltage balance can be maintained in steady state.

One method of measuring the dynamic performance of each capacitive power transfer scheme is to calculate the theoretical maximum output voltage slew rate of each implementation. When the output voltage increases, the upper capacitors must discharge and the lower capacitors must charge through their respective capacitive power transfer links, and vice versa. This can potentially be a bottleneck if the links saturate. To demonstrate this, each of the four cases is considered with obfuscated power transfer links. The maximum power that can be transferred across each of these links is set to an arbitrary maximum of 1 kW per link. An input voltage Vₛ of 800V is applied with a desired output voltage Vₒ transient from 200V to 600V.

The same circuit parameters used in the earlier discussion are again used. The slew rate is normalized to the number of links. Using the equation for energy stored in a capacitor, namely:

$${E}_{cap} = \frac{1}{2} {CV}^{2} , \qquad ( B31 )$$

it can be calculated that the set of upper capacitors needs to lose 1088 J of energy and the set of lower capacitors needs to gain 1088 J of energy. Individually, each upper capacitor needs to lose 272 J of energy and each lower capacitor needs to gain 272 J of energy. The HB scheme suffers a strong bottleneck as a single link I₄ serves to transfer all the power from the set up upper capacitors to the set of lower capacitors. This results in a time of 1.088 s with a slew rate of 368V/s to complete the output step. It is also important to note that the total power transferred over the inductive couplings is greater than the required power transfer due to the cascading nature of the power transfer links. For the example used in this exercise, I₁ transfers 272 J of energy, I₂ transfers 2*272 J, I₃ transfers 3*272 J, etc., with the end result being that 4352 J of energy in total is transferred across the couplings.

The DAHB and DAFB schemes do not have an individual bottleneck link as power transfer is evenly split amongst all the inductive couplings. However, as the DAFB scheme has 2× the number of links as the DAHB scheme, it can complete the transient step twice as fast as the DAHB scheme. This results in a slew rate of 736V/s for the DAHB scheme and 1472 for the DAFB scheme.

Lastly, for the common inductive coupling case, it can be seen that it suffers from the same bottleneck as the HB case with all the power being transferred across a single link. However, as there is no cascading of links, the total power transferred over all links is equal to the total power transfer required to maintain capacitor voltage balance.

Thus, for the third example embodiment, the stacked plurality of voltage converter cells may define a stacked arrangement of capacitors, with each capacitor of the stacked arrangement of capacitors being connected to a respective controllable switching circuit comprising one or more switching devices configured to controllably transfer power between the each capacitor and an adjacent capacitor in the stacked arrangement of capacitors. In such implementations, each respective controllable switching circuit may include one of, for example, a half-bridge circuit, a dual active half bridge circuit, a dual active full bridge circuit, or a dual active circuit connected to a common inductive bus connectable to other controllable switching circuits connected to the capacitors of the stacked arrangement of capacitors.

In a fourth example embodiment, a multilevel power converter topology, that can be expanded to an arbitrary N number of levels, is provide. This example topology is modular in nature, and includes groupings of three degrees-of-freedom dual active half bridge (3D-DAHB) switching cells that can be stacked and reconfigured to achieve any desired number of levels. Each DAHB can move power between any of its four associated capacitors, allowing for stacked DAHBs to distribute voltages arbitrarily around all capacitors in the stacked configuration, resulting in a multilevel topology of arbitrary level voltages. Component quantities and component stresses scale linearly with the number of levels. Internal power flows are exclusively a product of input/output parameters and not the number of levels.

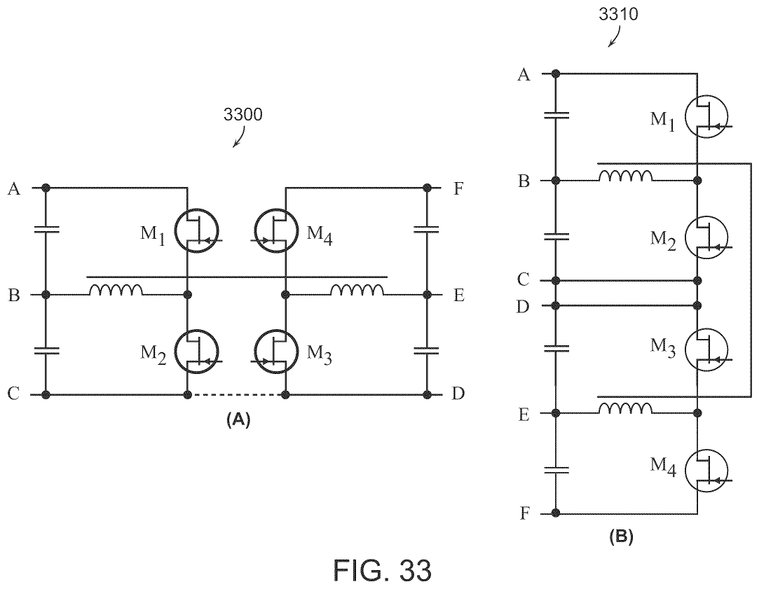

The topology of a 3D-DAHB unit cell is provided in FIG. 33, which includes an isolated DAHB converter circuit 3300, and a DAHB reconfigured and stacked to create non-isolated multilevel converter circuit 3310. The unit cell is the same as the dual active half-bridge (DAHB), where there are two half-bridges that share an inductive coupling. Important to note is the isolation between both half-bridges, the characteristics of which are leveraged in the stacking of unit cells to create a multilevel topology, which can be seen in the diagram of the circuit 3310 of FIG. 33. Configuring the single unit cell into a multilevel topology involves connecting nodes C and D together across the isolation barrier and “folding” the inductive coupling to create a set of series stacked capacitors. The set of series stacked capacitors is the basis upon which this multilevel topology is constructed.

Characteristics of the DAHB allow for the voltages of each capacitor within the DAHB to be controlled to any arbitrary ratio with the caveat that the total stored power within these capacitors does not change. This functionality persists when the DAHB is reconfigured from the circuit 3300 into the stacked topology illustrated in the circuit 3310 of FIG. 33. For the circuit 3310, input can be applied across nodes A and F and the output can be taken across nodes C/D and F. In this manner the input voltage stresses can be split across the series combination of the four capacitors that compose the center capacitance stack. The output voltage is likewise split along the two capacitors across which the output voltage is taken. Furthermore, the voltage seen by each switching device is split in an identical manner as the voltage split along the center capacitance stack. This allows for the single DAHB to effectively be used as a multilevel topology as the converter's input and output voltages can be higher than the voltage ratings of any individual switching device or capacitor.

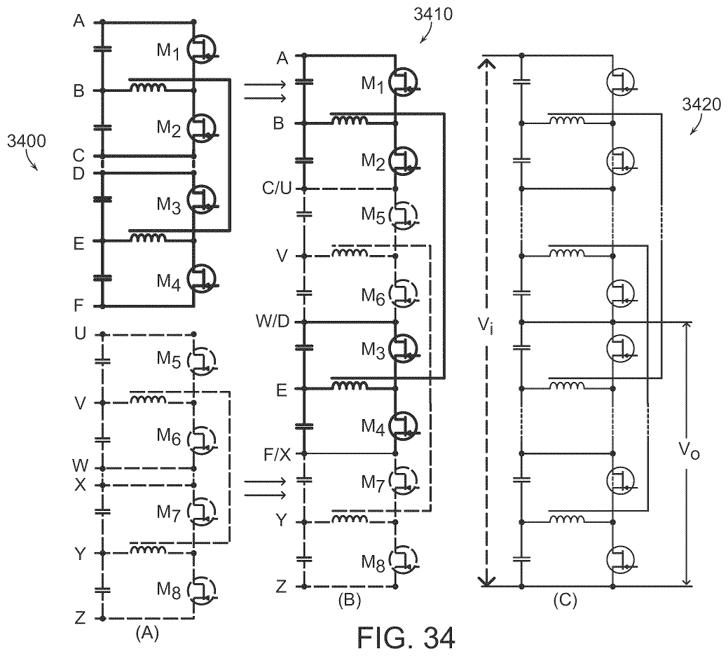

The stacking of multiple unit cells into a multilevel topology with increased number of levels (and therefore an increased number of series capacitors in the center capacitance stack) follows a similar process and can be seen in FIG. 34. More particularly, FIG. 34 includes circuit diagrams with examples showing the stacking of unit cells to create a multilevel topology, including circuit 3400 showing two DAHB unit cells, and circuit 3410 showing the placement and connectivity of the two DAHB unit cells of the circuit 3400 to create a 9-level converter.

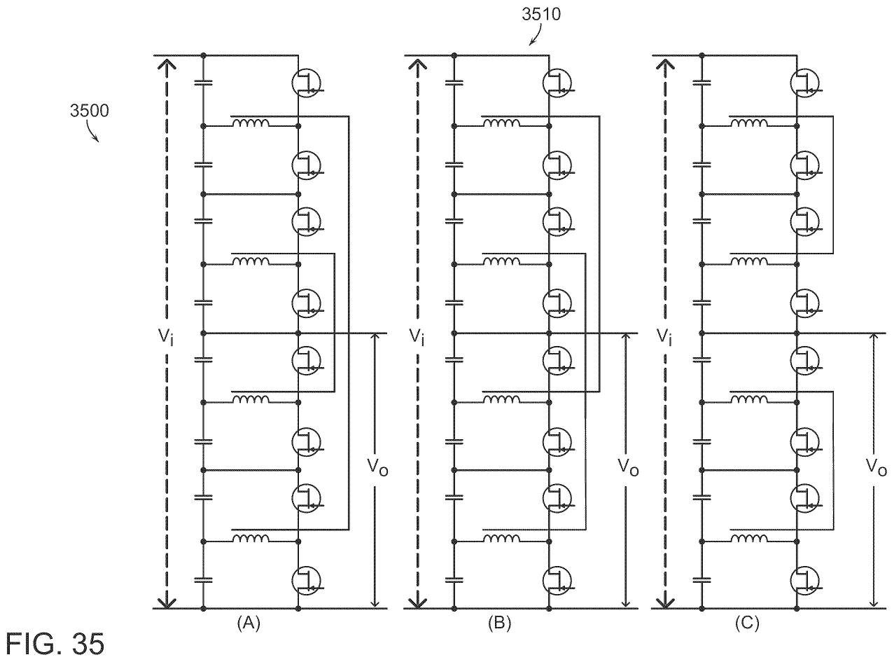

Multiple half bridges (HB) are connected in series to increase the number of levels in the center capacitance stack. The inductors of each HB are then coupled in pairs, creating a set of stacked DAHB unit cells. It is important to note, however, that the inductive coupling of each DAHB unit cell must cross the output node. There are multiple allowable coupling schemes, the quantity of which increases as the number of DAHB unit cells increases. The two allowable coupling schemes for a 9-level (8-capacitor) converter of the proposed topology are shown in FIG. 35 as circuits 3500 and 3510. This is a necessary condition to meet as internal power flows require that power from the HB cells above the output node be transferred to the HB cells below the output node to maintain power balance in steady-state.

The inductive coupling scheme allows for the circulating currents present in the Manhattan HB topology to be eliminated entirely. Although component quantities scale linearly in the Manhattan HB topology, due to the circulating currents the component stresses do not, and as a result scaling to N-levels is technically feasible but practically impossible. The circulating currents in the Manhattan HB topology are required to maintain capacitor voltage balance in steady-state. The inductive couplings of the proposed Manhattan DAHB topology allow for the necessary power flows to maintain capacitor voltage balance in steady state without circulating currents, resulting in complete linear scaling to N-levels in both component quantity and component stresses.

Analysis of the proposed topology first begins with analysis of the DAHB unit cell. As it is possible to transfer power in and out of any capacitor within a DAHB, the inductive coupling and switches can be removed and replaced with current sources in parallel with each capacitor. In this type of DAHB model power is conserved and the sum of all the powers from each current source is zero. This model does not consider any external current inputs or outputs as these are treated as separate mechanisms. Like the DAHB unit cell, this model can be stacked to become representative of a stacked capacitor multilevel converter.

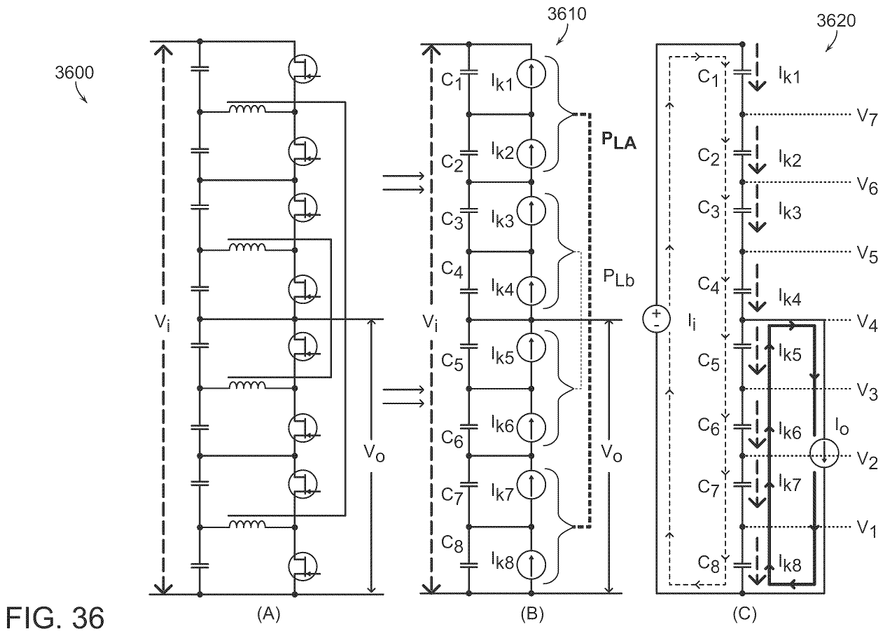

This topology can be expanded to an arbitrary N number of levels. For the sake of brevity, the analysis will focus on a converter with N=9 number of levels comprising eight (8) series capacitors in the center stack. The 9-level converter of the proposed Manhattan DAHB topology is illustrated in FIG. 36, which includes a circuit diagram 3600 of a complete 9-level DAHB converter, a diagram 3610 of a simplified current source model representation of the converter depicted in the circuit diagram 3600, and a circuit diagram 3620 showing the capacitor currents within the simplified model depicted in the circuit diagram 3610.

Thus, for the fourth example of multi-stacked voltage converter cells topology, the stacked plurality of voltage converter cells may include one or more groupings of three degrees-of-freedom dual active half bridge (3D-DAHB) switching cells, with each of the one or more groupings of 3D-DAHB switching cells including four capacitors. In such examples, each of the one or more groupings of 3D-DAHB switching cells is configured to controllably move power between any of the respective four capacitors to achieve specified voltage levels at one or more of the four capacitors. In such examples of the fourth example topology of the proposed voltage converter system, the stacked plurality of voltage converter cells comprises one or more groupings of three degrees-of-freedom dual active half bridge (3D-DAHB) switching cells, each of the one or more groupings of 3D-DAHB switching cells comprises four capacitors. In such examples, each of the one or more groupings of 3D-DAHB switching cells may be configured to controllably move power between any of the respective four capacitors to achieve specified voltage levels at one or more of the four capacitors.

Derivation starts with defining the capacitor voltages. The change in voltage within a capacitor as a function of its current can be calculated with:

$$\frac{{dV}_{c} ( t )}{dt} = \frac{1}{C} {i}_{c} ( t ) , \qquad ( B32 )$$

where i_{c}(t) is the capacitor current, Vₑ(t) is the capacitor voltage, and C is the capacitor capacitance. The current into each capacitor is shown in the circuit diagram 3620 of FIG. 36. Analytically, these currents can be used in conjunction with Equation (B32) to calculate

$$\frac{{dV}_{c} ( t )}{dt}$$

to obtain:

$${\dot{V}}_{c} = {C}^{- 1} ( {I}_{k} + {T}_{k} {I}_{u} ) \qquad ( B33 )$$

where \dot{V}_{c} is a vector capacitor voltage deltas

$${\dot{V}}_{c} = {[ \frac{{dV}_{C 1} ( t )}{dt} , \frac{{dV}_{C 2} ( t )}{dt} , … , \frac{{dV}_{C 18} ( t )}{dt} ]}^{′} ,$$

C is a matrix of capacitances C=diag[C₁, C₂, . . . , C₈]′, Iₖ is a vector of currents transferred over the inductive coupling of the DAHB I_{K} [I_{K1}, I_{K2}, . . . , I_{K8}]′, Iᵤ represents the external current flows Iᵤ=[Iᵢ, Iₒ]′, and Tₖ is a topology matrix that represents the connectivity of the input and output nodes. For the 8-capacitor converter considered in this analysis, the connectivity matrix can be represented as follows:

$${T}_{k} = [ \begin{matrix}1 & 0 \\ 1 & 0 \\ 1 & 0 \\ 1 & 0 \\ 1 & - 1 \\ 1 & - 1 \\ 1 & - 1 \\ 1 & - 1\end{matrix} ] \qquad ( B34 )$$

Tₖ also represents the direction of current flow of the external input and output currents. This shows how it is necessary to transfer power from cells above the output node to cells below the output node to maintain capacitor voltage balance in steady state. The output current exclusively draws power from the capacitors below the output node as seen in the circuit diagram 3620 of FIG. 36, necessitating inductive couplings that span the output node and transfer power from the upper capacitors to the lower capacitors to compensate for the output current and maintain capacitor voltage balance.

The DAHB unit cells transfer internal power over the inductive coupling, and as stated previously, all powers contained in Iₖ must sum to zero. However, this is not wholly the case, as the power transferred in each unit cell DAHB must also be conserved and sum to zero. A constraint on the internal currents Iₖ is developed that maintains the internal power flow:

$${I}_{k} {V}^{- 1} {T '}_{u} = 0 \qquad ( B35 )$$

where V is a matrix of capacitor voltages V=diag[V_{C1}, V_{C2}, . . . , V_{C8}]′, and Tᵤ is a topology matrix that represents how the inductive couplings are paired. For the 8-capacitor converter considered in this analysis:

$${T}_{u} = [ \begin{matrix}1 & 0 \\ 1 & 0 \\ 0 & 1 \\ 0 & 1 \\ 0 & 1 \\ 0 & 1 \\ 1 & 0 \\ 1 & 0\end{matrix} ] \qquad ( B36 )$$

where the values in the first column of Tu represent the capacitors that inductive coupling P_{LA} can share power with, and the values in the second column represent the capacitors the second inductive coupling P_{LB} can share power with. The constraint imposed by Equations (B35) and (B36), not only does it ensure that the internal power flows as a whole follow the law of conservation of energy, but also ensures that that the individual DAHB unit cells do not also violate the law of conservation of energy.

For steady state operation, vector \dot{V}_{c} can be set to zero as the capacitor voltages do not change in steady state. In conjunction with Equation (B33), for vector \dot{V}_{c} to equal zero, the term \dot{V}_{c}=C⁻¹(Iₖ+TₖIᵤ) needs to equal zero with Iₖ=−TᵤIᵤ, as C⁻¹ term can be removed. This term is also not present in any constraint, suggesting that the capacitance value does not impact the steady state operation. It can be seen that Iₖ₁₋₄=−Iᵢ, and Iₖ₅₋₈=−Iᵢ+Iₒ is the only solution to Iₖ=−TᵤIᵤ. Therefore, the constraint of Equation (B35) dictates the allowable capacitor voltages and not the allowable internal current flows (which are dictated by the input and output currents of the converter).

Characteristics of the DAHB unit cell allow for the voltage across the center capacitor stack of the converter to be set to any arbitrary ratio of the input voltage Vᵢ. There are multiple allowable values for these sets of voltages that satisfy the constraint of Equation (B35). One allowable set is the one that represents ideal voltage splitting across the capacitors. To maintain the minimum voltage stress of each capacitor (and therefore also each capacitor's associated switch) across the entire output voltage range 0<Vₒ<Vᵢ, the capacitors below the output node must evenly split the output voltage Vₒ and the capacitors above the output node must evenly split the voltage Vᵢ−Vₒ. Analytically, this can be represented as:

$$\begin{matrix}{V}_{C 1 - 4} = \frac{1}{4} ( {V}_{i} - {V}_{o} ) \\ {V}_{c 5 - 8} = \frac{1}{4} {V}_{o}\end{matrix} \qquad ( B37 )$$

The voltages of Equation (B37) in conjunction with the currents noted above satisfy the constraint of Equation (B35) as well as the steady state requirement of Equation (B33) with \dot{V}_{C} set to zero. In this manner the capacitor voltages maintain balance during steady state operation through the power shared over the inductive couplings which are injected into each capacitor as Ik.

As discussed previously, this topology can be expanded to an arbitrary N-levels. Switching cells can be stacked ad infinitum given all inductive couplings cross the output node. While the relationship developed above for the 9-level converter implementation are applicable to expansion of this topology to N-levels, the topological matrices of Tₖ and Tᵤ need to be adjusted. The topological matrix Tᵤ represents the current that flows into each capacitor due to external currents Iᵢ and Iₒ with positive notation denoting positive current into the capacitor. The number of rows is equal to the number of series capacitors in the center capacitor stack and the number of columns is equal to two. The first column represents the input current Iᵢ into each capacitor. As the current Iᵢ will flow into all capacitors with the same direction, this column is simply all ones. The second column represents the current Iₒ into each capacitor, which flows out of capacitors exclusively below the output node and corresponds to a value of (−1) for these capacitors. Under the present analysis the output is taken at the center node and the generalized form of Tᵤ reflects this:

$${T}_{u} = [ \begin{matrix}1 & 0 \\ 1 & 0 \\ ⋮ & ⋮ \\ 1 & 0 \\ 1 & - 1 \\ ⋮ & ⋮ \\ 1 & - 1 \\ 1 & - 1\end{matrix} ] \qquad ( B38 )$$

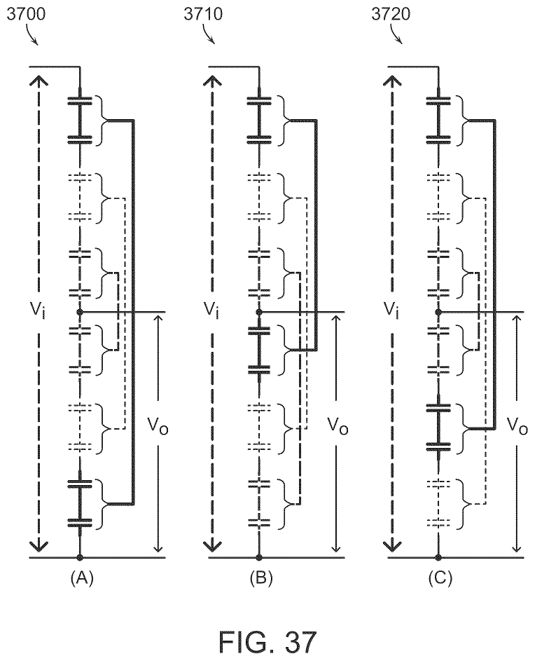

The topological matrix Tₖ represents the connectivity of the inductive couplings. The number of columns is equal to the number of inductive couplings and the number of rows is equal to the number of capacitors. From top to bottom, the first column represents the inductive coupling of the of the first half-bridge, the second of the second half-bridge, and the n^{th} of the n^{th} half-bridge above the output node. The values in each column represent the capacitors that can share power across the column's respective inductive coupling, with a 1 denoting that power can be shared across this inductive coupling and a 0 denoting that power is not shared across this inductive coupling. For the example inductive coupling converters 3700, 3710, and 3720 shown in FIG. 37, the respective Tₖ connectivity matrices are:

$${T}_{k}^{A} = [ \begin{matrix}1 & 0 & 0 \\ 1 & 0 & 0 \\ 0 & 1 & 0 \\ 0 & 1 & 0 \\ 0 & 0 & 1 \\ 0 & 0 & 1 \\ 0 & 0 & 1 \\ 0 & 0 & 1 \\ 0 & 1 & 0 \\ 0 & 1 & 0 \\ 1 & 0 & 0 \\ 1 & 0 & 0\end{matrix} ] , {T}_{k}^{B} = [ \begin{matrix}1 & 0 & 0 \\ 1 & 0 & 0 \\ 0 & 1 & 0 \\ 0 & 1 & 0 \\ 0 & 0 & 1 \\ 0 & 0 & 1 \\ 1 & 0 & 0 \\ 1 & 0 & 0 \\ 0 & 1 & 0 \\ 0 & 1 & 0 \\ 0 & 0 & 1 \\ 0 & 0 & 1\end{matrix} ] , {T}_{k}^{C} = [ \begin{matrix}1 & 0 & 0 \\ 1 & 0 & 0 \\ 0 & 1 & 0 \\ 0 & 1 & 0 \\ 0 & 0 & 1 \\ 0 & 0 & 1 \\ 0 & 0 & 1 \\ 0 & 0 & 1 \\ 1 & 0 & 0 \\ 1 & 0 & 0 \\ 0 & 1 & 0 \\ 0 & 1 & 0\end{matrix} ] \qquad ( B39 )$$

The equation for \dot{V}_{c} can be applied to the general N-level converter with

$${\dot{V}}_{c} = {[ \frac{{d V}_{C 1} ( t )}{d t} , \frac{{d V}_{C 2} ( t )}{d t} , … , \frac{{d V}_{C N} ( t )}{d t} ]}^{'} ,$$

C=diag [C₁, C₂, . . . , C_{N}]′, and Iₖ [Iₖ₁, Iₖ₂, . . . , Iₖₙ]. The constraint of Equation (B35) also persists with V=diag [V_{C1}, V_{C2}, . . . , V_{CN}]′. Given these methods of expansion, and using a similar analysis setup as previously discussed, and with ideal voltage splitting across the capacitors, it can be seen that the power that needs to be transferred across the inductive couplings and into each capacitor scales linearly with voltage. For a given input/output voltage, the total power transferred over all inductive couplings is constant regardless of the number of levels. Furthermore, the sum of voltage and current stresses of all switching devices is constant for a given input/output voltage and does not change with the number of levels. In this way linear component stress scaling with Nis achieved.

Thus, for the fourth example embodiment, of multi-level converter topologies, reconfiguration and stacking of DAHB switching cells can be used to create a multilevel topology. A single cell can be stacked vertically, without any extra topological connections to create a multilevel converter. Multiple DAHB switching cells can be stacked to create a multilevel converter of N-levels. Voltage balance can be maintained during steady state, lending this topology to both DC/DC and AC/DC operation. Component quantities, component stresses, and circuit complexity scale linearly, which lends this topology to an easily expandable and adaptable dynamic multilevel environment.

A fifth example embodiment of a voltage converter system with a stacked topology of voltage converter cells is the stacked dual-active-half-bridge DC/DC differential power converter. In this proposed approach, a DC/DC converter is implemented as a Dual-Active-Half-Bridge (DAHB) that has been folded across its galvanic isolation and stacked upon itself. The differential aspect of this converter comes from the fact that the power exchanged between these capacitors to maintain voltage balance in steady state is less than the total power flow of the converter. The DAHB of the proposed converter is its capacitive power transfer mechanism. As will become apparent below, a closed-loop control scheme can be used to control power transfer. Description of this topology will be done with respect to a basic 4-capacitor DC/DC configuration of the Manhattan topology with the capacitive power transfer mechanisms implemented with a Dual-Active-Half-Bridge (DAHB).

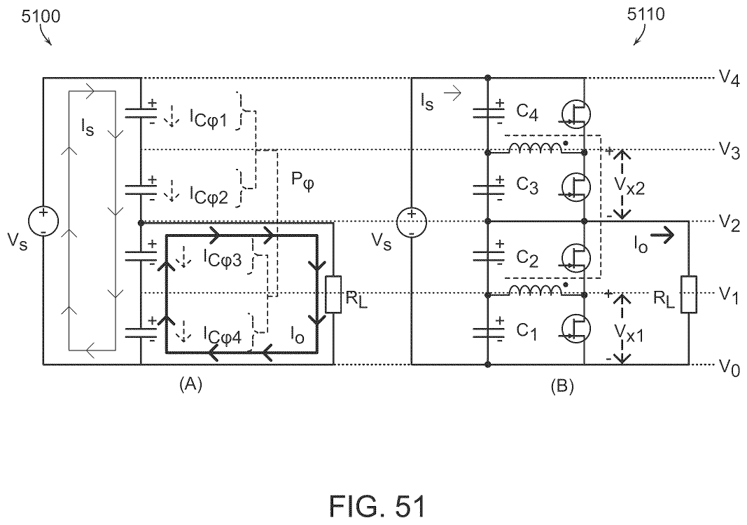

As noted above, the Manhattan Topology includes of a set of series stacked capacitors where power can be moved between capacitors (e.g., based on controlled actuation of switched-based control circuitry). FIG. 51 includes circuit diagrams 5100 and 5110 of the topology of the proposed stacked Dual-Active-Half-Bridge Differential Power Converter. The diagram 5100 illustrates the capacitor currents and capacitive power transfer scheme, while the diagram 5110 provides a complete circuit topology of the DAHB differential power converters. The output voltage Vₒ is taken at the center of the capacitance stack and the load resistance R_{L} is applied across V2 to V0. The input voltage Vₛ is applied across V4 to V0. In the diagram 5100 P_{ϕ} represents the power transfer over the inductive coupling of the DAHB and is derived according to:

$$\begin{matrix}{P}_{ϕ} = K ( {V}_{C 1} + {V}_{C 2} ) ( {V}_{C 3} + {V}_{C 4} ) ζ , \\ K = \frac{{N}_{p}}{{N}_{S} 8 {f}_{s w} {L}_{l k}} , \\ ζ = \{ \begin{matrix}\vert ϕ \vert ( 1 - \vert ϕ \vert ) & for ϕ \geq 0 \\ - \vert ϕ \vert ( 1 - \vert ϕ \vert ) & for ϕ \leq 0\end{matrix}\end{matrix} \qquad ( B40 )$$

where V₁₋₄ are the voltages of C₁₋₄, f_{sw} is the switching frequency, ϕ is the normalized phase difference between switching cycles of the primary and secondary sides of the DAHB. Lₗₖ, Nₚ, and Nₛ are the leakage inductance, primary turns number, and secondary turns number, respectively, of the DAHB transformer. The quantity of power that needs to move from the upper set of capacitors (C3 and C4) to the lower set of capacitors (C1 and C2) to maintain capacitor voltage balance is equal to:

$${P}_{ϕ , ss} = {P}_{o} \frac{{V}_{s} - {V}_{o}}{{V}_{s}} = {P}_{o} \frac{{V}_{C 3} + {V}_{C 4}}{{V}_{C 1} + {V}_{C 2} + {V}_{C 1} + {V}_{C 2}} \qquad ( B 41 )$$

As the output voltage Vₒ will always be less than the input voltage Vₛ, Equation (B41) shows that the power required to be moved between capacitors to maintain voltage balance in steady state P_{ϕ,ss} will always be less than the output power Pₒ, hence the differential connotation of the proposed configuration. It should be noted that for the purposes of the analysis, the capacitances values are considered to be equal with C=C1=C2=C3=C4.

The duty cycles on both sides of the DAHB are set to be 0.5. This has the implication that the capacitor voltages and currents on each side of the DAHB are equal. This can be explicitly written as V_{C1}=V_{C2}, I_{C1}=I_{C2}, V_{C3}=V_{C4}, and I_{C3}=I_{C4}. The individual capacitor currents due to the capacitive power transfer scheme are then:

$$\begin{matrix}{I}_{C ϕ 4} = {I}_{C ϕ 3} = \frac{1}{C} K ( {V}_{C 1} + {V}_{C 2} ) ζ \\ {I}_{C ϕ 2} = {I}_{C ϕ 1} = \frac{1}{C} K ( {V}_{C 3} + {V}_{C 4} ) ( - ζ )\end{matrix} \qquad ( B42 )$$

The dynamic equations for the four capacitor voltages can then be found considering

$$C \frac{{d V}_{c}}{d t} = {I}_{C}$$

and summing the capacitor currents as drawn in diagram 5100 of FIG. 51 as:

$$\begin{matrix}\frac{{d V}_{C 4}}{d t} = \frac{{d V}_{C 3}}{d t} = \frac{1}{C} K ( {V}_{C 1} + {V}_{C 2} ) ζ + \frac{1}{C} {I}_{s} , \\ \frac{{d V}_{C 2}}{d t} = \frac{{d V}_{C 1}}{d t} = \frac{1}{C} K ( {V}_{C 3} + {V}_{C 4} ) ( - ζ ) + \frac{1}{C} ( {I}_{s} - {I}_{o} )\end{matrix} \qquad ( B44 )$$

where the output current Jo is equal to (V_{C1}+V_{C2})/RL. The input current Iₛ can be found considering the law of conservation of energy as:

$${I}_{s} = P \frac{{( {V}_{1} + {V}_{2} )}^{2}}{{R}_{L} ( {V}_{1} + {V}_{2} + {V}_{31} + {V}_{42} )} . \qquad ( B45 )$$

The above two equations (B44) and (B45) represent a non-linear system with load dependencies. It can be noted that the rightmost terms of Equation (B44) are a product of exclusively the load condition, and as R_{L}→∞ these terms will be driven to zero. If the load parameters are known by the controller then these terms can be artificially driven to zero (for cases of R_{L}≠∞) with a feedforward term.

The output voltage of this converter is defined by controlling ϕ. The quantity ϕ controls the power flow across the inductive coupling, which is a function of both ϕ and the individual capacitor voltages as described in Equation (B40). ζ is used as a substitution for the ϕ terms to ease the computational burden. The relationship between ϕ and ζ can be found in Equation (B40).

The amount of power that needs to be transferred over the inductive coupling to maintain capacitor voltage balance in steady state can be calculated with Equation (B41) if either the load current Iₒ, converter power Pₒ, or load resistance R_{L} are known. The feedforward term ζ_{FF} can be found by setting Equation (B40) and Equation (B41) to equal to each other. This results in:

$${ζ}_{F F} = \frac{{V}_{o , ref}}{{V}_{s} K {R}_{L}} \qquad ( B46 )$$

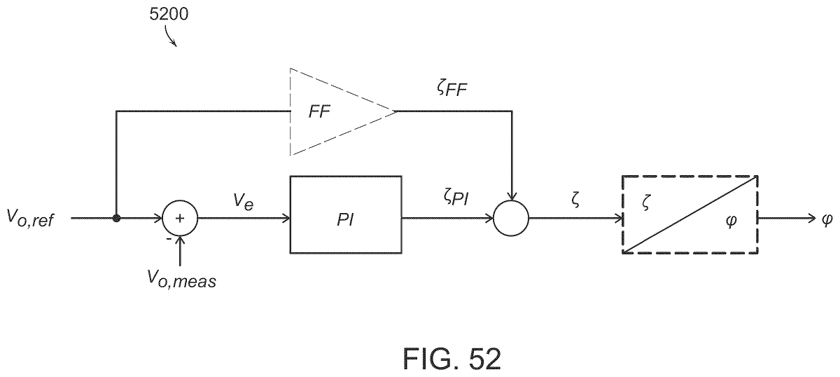

for the case where R_{L} is known. When Equation (B40) is used as a feedforward term in the control topology 5200 illustrated in FIG. 52, the PI controller only has to control the first term of Equation (B40) and any component nonidealities, eliminating the nonlinearities of Equation (B40) introduced by their load dependency. Lastly, solving the quadratic of Equation (B40) for ϕ and bounding ϕ between −0.5 and 0.5 provides the value of ϕ that is used to control the phase difference between opposing sides of the DAHB.

The converter circuit depicted in the diagram 5110 of FIG. 51 was implemented in hardware using TI LMG3422R030 GaN FETs and a TMS320F28388D microcontroller running with a control frequency of 20 kHz. The switching frequency f_{sw} was set to 1 MHz and the capacitors C₁₋₄ were 4 μF. The DAHB transformer was made from two FerroXcube E43/10/28 3F36 cores with four primary and four secondary turns of 2625/44 Litz wire. The resulting leakage inductance Lₗₖ and magnetization inductance L_{mag} was 0.42 μH and 65 μH, respectively. The load resistance RL is 33Ω and the input voltage Vₛ was 100V. PI gains of kₚ=0.002 and kᵢ=20 were used.

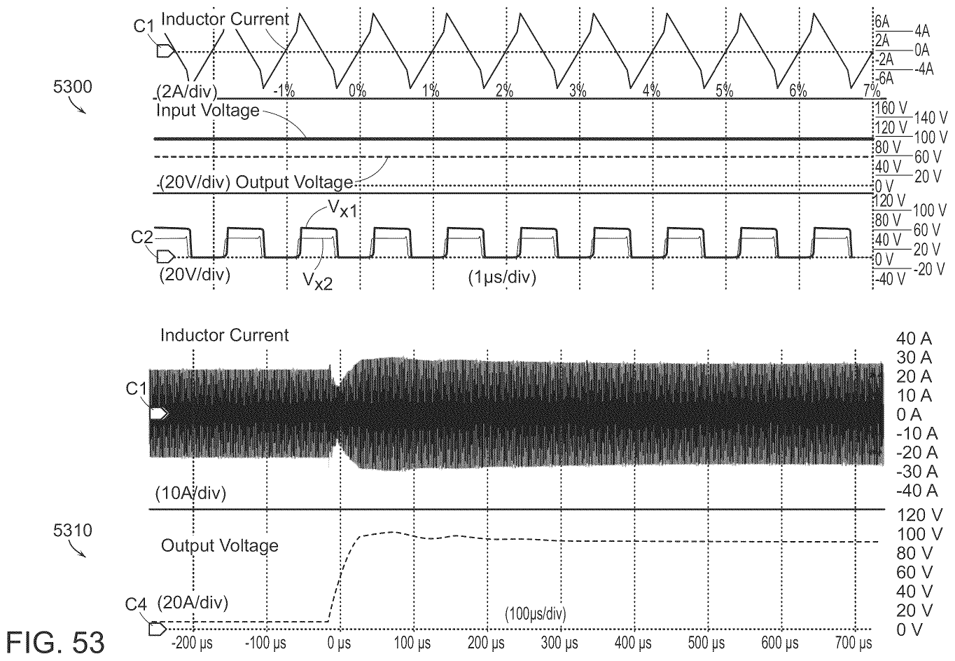

FIG. 53 includes graphs 5300 showing steady state operation with an output voltage of Vₒ of 60V. The load current was 1.83 A, the output power was 110 W, and the power transferred between capacitors over the inductive coupling was approximately 44 W with a ϕ of 0.065. FIG. 53 further includes a graph 5310 showing a transient voltage step from 10V to 90V (which is 10%-90% of Vₛ). Minimal overshoot is noted with an initial rise time of approximately 25 μs.

Thus, the implementations of FIGS. 51-53 show the feasibility of the stacked DAHB implementation of the Manhattan Topology as a DC/DC converter. Functionality and differential power conversion were experimentally confirmed.

Accordingly, in various examples of the fifth example controllable voltage conversion implementation based on a stacked plurality of voltage conversion cells, a DC-DC voltage converter controlled using a DAHB circuitry is provided. Under this approach, the stacked plurality of voltage converter cells is electrically coupled to a DC voltage input source. The voltage converter system is configured to provide a DC output voltage, and the one or more controllers include one or more dual active half bridge (DAHB) switch-based control circuitries coupled to stacked capacitors of the stacked plurality of converter cells, with the one or more DAHB switch-based control circuitries configured to controllably maintain in steady state voltage balance with total power moving between the stacked capacitors being less than the total output power.

Next, the controllability of different configurations of the Manhattan Topology will be discussed. As noted, the Manhattan Topology is a multilevel power converter topology that is defined by a set of series stacked capacitors where each capacitor establishes a voltage level. The functionality of the converter is built around the transfer of power between these capacitors. The methodology, quantity, and connectivity of the capacitive power transfer scheme is not specific to the Manhattan Topology. Different topology configurations will have different capacitive power transfer connectiveness. A completely connected topology is not necessary for a fully controllable converter (where capacitor voltage balance of any arbitrary ratio can be maintained in steady state). For some practical implementations of the Manhattan topology, it is also not feasible to connect all capacitive power transfer links together. Different link topologies will result in different levels of controllability. The analysis below discusses three different link topologies: a fully controllable topology, a partially controllable topology, and a modification to the partially controllable topology that results in a fully controllable topology. Converter state-space models, controllability theory, and control diagrams are provided. Experimentation and evaluation of tested implementations have validated the controllability analysis for Manhattan Topology power converters that use the three different link topologies in DC/DC mode.

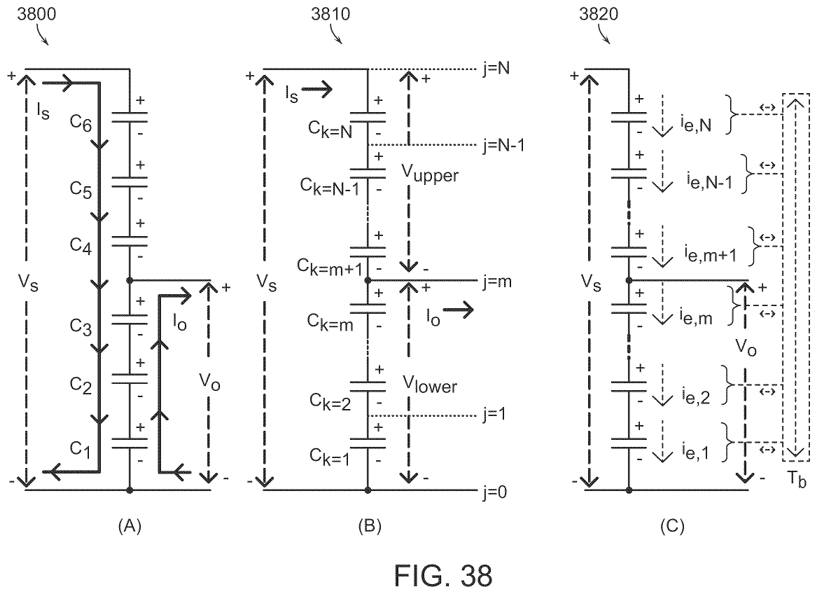

The basic Manhattan topology power converter with obfuscated capacitive power transfer links in which all capacitors are linked together is illustrated in FIG. 38, and includes a circuit diagram 3800 for a 6-level, a circuit diagram 3810 implementation for an N-level implementation, and a circuit diagram 3820 showing the power transfer scheme with connectivity of Tb for the N-level implementation. Having all capacitors linked together is not always practical or convenient, and is not explicitly necessary. The topology can be used as a multi-input multi-output power converter with multiple control states that all scale with the number of levels, as discussed herein.

The state-space model considers the capacitor voltages as states and begins with defining the relationship between capacitor voltage and current, as follows:

$${d V}_{c} = \frac{{I}_{c}}{C} dt , \qquad ( B47 )$$

where V_{c} is the capacitor voltage, C is the capacitance value, and I_{c} is the total capacitor current. As can be seen in FIG. 38, there are multiple mechanisms that define the total capacitor current. Equation (B47) can be modified to reflect this and results in:

$${dV}_{C} = \frac{{i}_{e} + {i}_{b}}{C} dt , \qquad ( B48 )$$

where iₑ is the current due to the externalities of input current Iₛ and output current Iₒ where iₑ=[Iₛ, Iₒ]′. i_{b} is the current due to internal capacitive power transfer links. iₑ and iₒ will change for different configurations of the Manhattan topology. Topology matrices T_{b} and Tₑ are included to make allowances for these different configurations of capacitive power transfer links and input/output node configurations, respectively.

The complete state space formulation can then be written as:

$${V}_{C}^{+} = {V}_{C} + \frac{{T}_{S}}{C} {T}_{b} {i}_{b} + \frac{{T}_{S}}{C} {T}_{e} {i}_{e} , \qquad ( B49 )$$

with a constraint of V_{c}T_{b}i_{b}=0. This constraint denotes that the power transferred internally within the capacitive power transfer links is conserved. Tₛ is the sample interval of the controller and is defined by the practical controller implementation (and not the circuit itself). The state-space model can be used to determine the controllability of the system it describes.

Gleaning controllability (and observability) from a state-space model is straightforward and well-known process. For a given state-space model of the form of

$${x}^{+} = Ax + Bu , \qquad ( B50 )$$

a controllability matrix C can be derived as:

$$C = [ B \vert AB \vert {A}^{2} B \vert … \vert {A}^{n - 1} B ] , \qquad ( B51 )$$

where n is the rank of A. If the system is fully controllable then all of the columns of C will be linearly independent and its rank will be full. In the context of the state-space model, C can be rewritten as:

$$\overline{C} = [ I \vert {IT}_{b} \vert {I}^{2} {T}_{b} \vert … \vert {I}^{n - 1} {T}_{b} ] , \qquad ( B52 )$$

where I is the identity matrix. This shows that the controllability of the topology depends wholly on T_{b} and not on any other element within the state-space of Equation (B49) or its constraint V_{c}T_{b}i_{b}=0. Lastly, in the context of this converter, the rank does not need to be full as the sum of the capacitor voltages is controlled by the input voltage Vᵢₙ and this is not reflected in the state-space model. Instead, for full controllability, the rank of C̅ must be one less than full. This is written explicitly as rank(C̅)=n−1, where n is conveniently equal to the number of capacitors in the center capacitance stack of the converter.

Three different configurations of the Manhattan topology are next discussed. The configurations were chosen to demonstrate the fully controllable case, the partially controllable case, and a modification to the partially controllable case to make it fully controllable. A basic 4-capacitor 4-level center capacitor stack is used for all configurations to maintain simplicity and consistency.

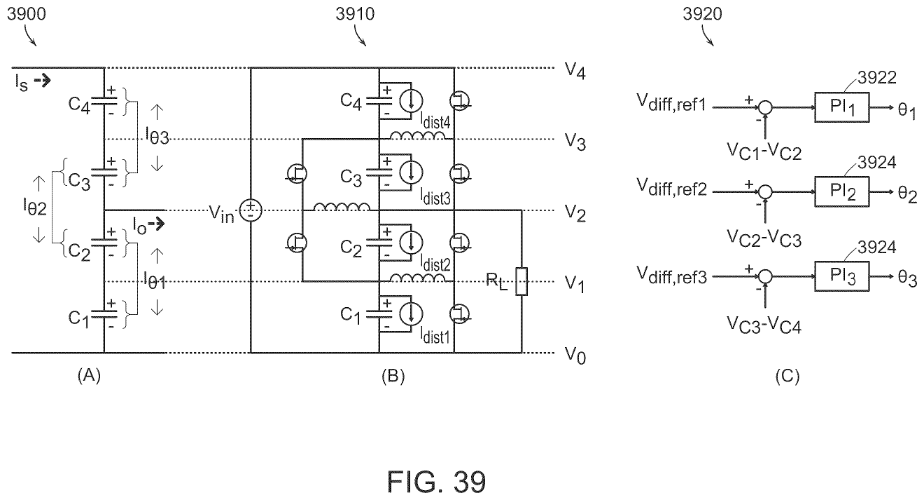

The first of the three configurations is shown in FIG. 39 which includes diagrams of a fully controllable example Manhattan topology comprising three half-bridge capacitive power transfer links. The diagram includes circuit diagram 3900 showing the internal power flow of the 4-capacitor Manhattan converter, the full circuit diagram 3910, drawn with disturbance current sources (used for validation), and including controllable switches to control the capacitive power flow, and a control topology diagram 3920 illustrating the proportional integral (PI) controllers 3922, 3924, and 3926 that use measurements of the capacitors' voltages to control the switching of at least some of the switches shown in the diagram 3910 (e.g., to derive phase differences between the activation signaling to actuate pairs of switches in a way that maintains the capacitors' voltage difference for various capacitor pairs at some reference value).

The configuration of FIG. 39 has a topology matrix T_{b1} and link power transfer quantities i_{b1} of:

$${i}_{b 1} = [ \begin{matrix}{I}_{θ 1} \\ {I}_{θ 2} \\ {I}_{θ 3}\end{matrix} ] , \qquad ( B52 )$$

$${T}_{b 1} = [ \begin{matrix}1 & 0 & 0 \\ - 1 & 1 & 0 \\ 0 & - 1 & 1 \\ 0 & 0 & - 1\end{matrix} ]$$

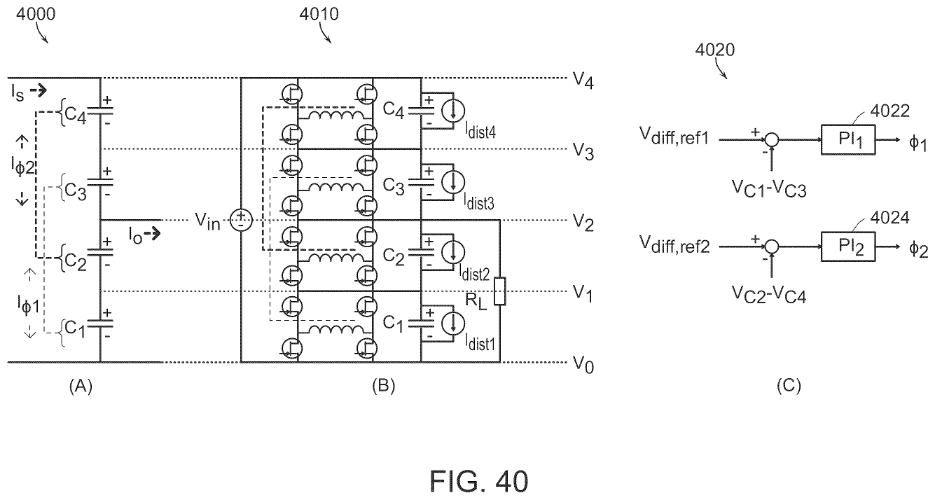

The second configuration is shown in FIG. 40 which includes diagrams of a partially controllable example Manhattan topology comprising two dual-active-full-bridge (DAFB) capacitive power transfer links. The diagrams include circuit diagram 4000 showing the internal power flow diagram, the full circuit diagram 4010, drawn with disturbance current sources (used for validation), and includes controllable switches to control the capacitive power flow, and a control topology diagram 4020 illustrating the proportional integral (PI) controllers 4022 and 4024 that use measurements of the capacitors' voltages to control the switching of at least some of the switches shown in the diagram 4010 (in a manner similar to that discussed above in relation to, for example, FIGS. 11 and 39). In the second configuration of the Manhattan converter one required capacitive power transfer link is missing which results in partial controllability. The topology illustrated in FIG. 40 has topology matrix T_{b2} and link power transfer quantities i_{b2} of:

$${i}_{b 1} = [ \begin{matrix}{I}_{ϕ 1} \\ {I}_{ϕ 2}\end{matrix} ] , \qquad ( B53 )$$

$${T}_{b 1} = [ \begin{matrix}1 & 0 \\ 0 & 1 \\ - 1 & 0 \\ 0 & - 1\end{matrix} ]$$

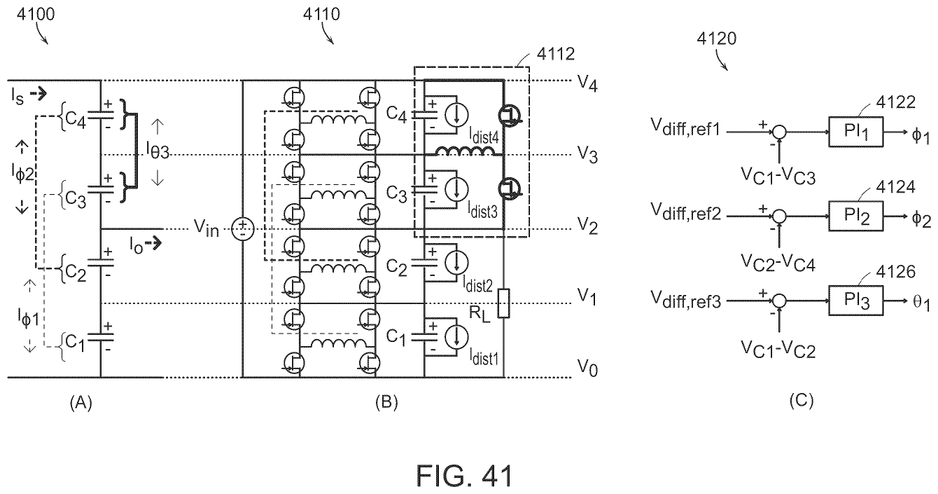

The third example controllability configuration relates to a modification to the partially controllable case that allows for it to become fully controllable. The third configuration is shown in FIG. 41 which includes diagrams of a Manhattan configuration with two dual active full bridge and one half-bridge capacitive transfer links. The diagrams of FIG. 41 include a circuit diagram 4100 showing the internal power flow diagram, a full circuit diagram 4110, drawn with disturbance current sources (used for validation), and includes controllable switches to control the capacitive power flow, and a control topology diagram 4120 illustrating the proportional integral (PI) controllers 4122, 4124, and 4126 that use measurements of the capacitors' voltages to control the switching of at least some of the switches shown in the diagram 4110 (in a manner similar to that discussed above in relation to, for example, FIGS. 11, 39, and 40). This modification of the controllable topology of the configuration of FIG. 41 relative to the configuration of FIG. 40 is the inclusion of an additional half-bridge, within the dashed box 4112. The additional half-bridge is connected in a strategic location that provides a necessary power transfer link between two adjacent capacitors. The third configuration depicted in FIG. 41 has a topology matrix T_{b3} and link power transfer quantities i_{b3} of:

$${i}_{b 3} = [ \begin{matrix}{I}_{ϕ 1} \\ {I}_{ϕ 2} \\ {I}_{θ 1}\end{matrix} ] , \qquad ( B54 )$$

$${T}_{b 1} = [ \begin{matrix}1 & 0 & 1 \\ 0 & 1 & - 1 \\ 1 & 0 & 0 \\ 0 & - 1 & 0\end{matrix} ]$$

The controllability matrix C̅₁ resulting from T_{b1} of configuration 1 has rank 3, implying full controllability. The controllability matrix C̅₂ resulting from T_{b2} of configuration 2 has rank 2, implying partial controllability. Lastly, the controllability matrix C̅₃ resulting from T_{b3} of configuration 3 has rank 3, implying full controllability.

The controllability of the different configurations discussed herein (and depicted in FIGS. 39, 40, and 41) was validated through high fidelity simulation. Validation included a two-step process. The first step was for the converter to reach a steady state operating point from a zero initial condition. During this time to reach a steady state operating point the disturbance current sources I_{dist1-4} were set to 0. The second step in the validation was for the disturbance current sources I_{dist1-4} to activate and produce a disturbance on each capacitor voltage. This shows the converter's ability to compensate and maintain the reference steady state operating point.

As was illustrated in FIGS. 39-41, Proportional Integral (PI) control is used to control operations of the converters. Each module typically has its own controller (e.g., a half-bridge is a single module and a DAFB is a single module) and all PI controllers are generally identical. The V_{diff} references (as shown in the circuits 3920, 4020, and 4120) are all set to 0, implying that the target state is an even split of the input voltage Vᵢₙ across all four capacitors (V_{C1}=V_{C2}=V_{C3}=V_{C4}=0.25Vᵢₙ). It is worth noting that this is an unoptimized control scheme and is used to demonstrate controllability and not control performance. The disturbance current sources I_{dist1-4} have values of I_{dist1}=20 A, I_{dist1}=−3 A, I_{dist1}=−15 A, and I_{dist1}=10 A. These are arbitrary values and all disturbance current sources activate at t=0.12 s and are the same for each of the three configurations.

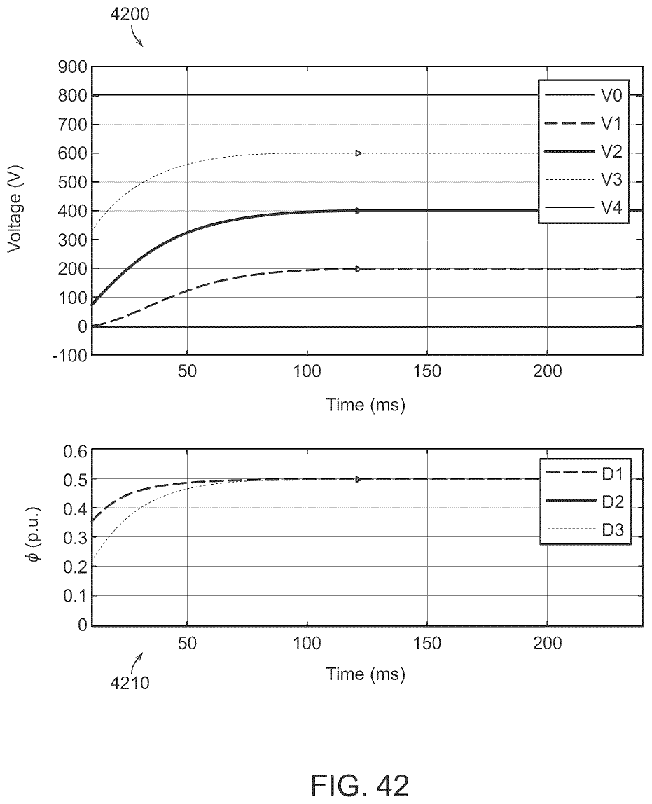

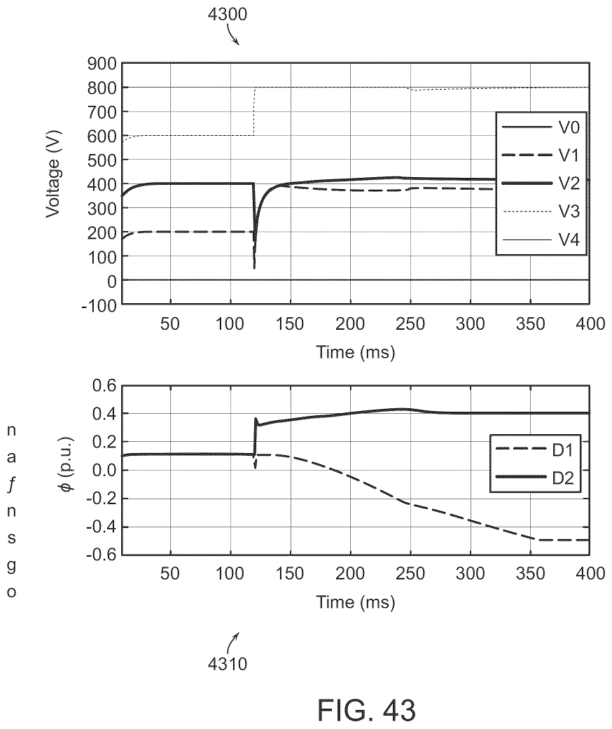

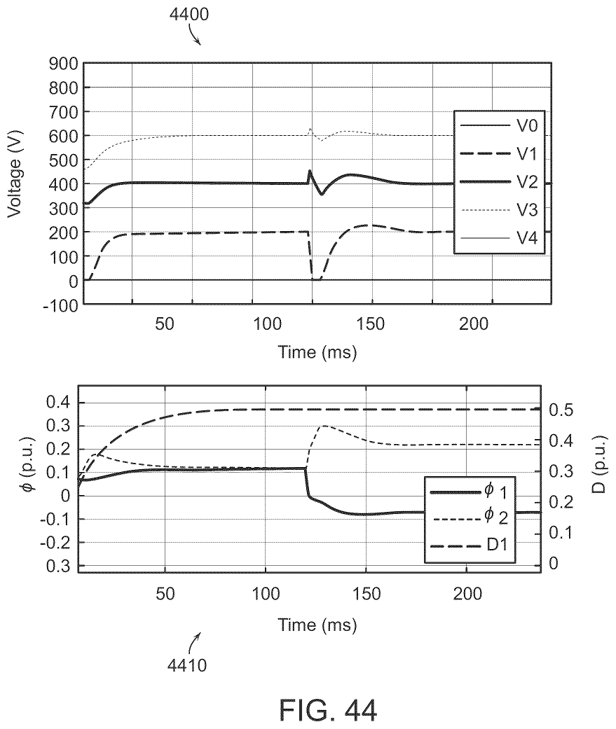

All the configurations that were tested had the circuit parameters of C=30 μF, L=20 μH, and switching frequency F_{sw}=100 kHz. All transformers had a 1:1 turns ratio, leakage inductance equal to L, and coupling coefficient of 1. The input voltage was Vᵢₙ=800V and the load resistance is R_{L}=40Ω. FIG. 42 shows the capacitors' voltage levels (at graph 4200) and module duty cycles (at graph 4210) of Configuration 1 (depicted in FIG. 39) during the initial settling and the introduction of the disturbances. It can be seen that the steady state operating point is successfully achieved and the duty cycles settle on an expected value of 0.5. The introduction of the disturbances cause some fluctuations but the steady state operating point is maintained. Full controllability is achieved. FIG. 43 shows the capacitors' voltages levels (at graph 4300) and normalized phase differences ϕ (at graph 4310) for configuration 2 (depicted in FIG. 40) during both the initial settling period and the introduction of the disturbances. This configuration achieves the steady state operating point. This can be attributed to the identical PI controllers, as during the initial settling period both DAFBs are effectively doing the same thing. However, this configuration fails when the disturbances are introduced. This is because this configuration is not fully controllable and lacks the ability to transfer power between the DAFBs. The result of this is that one DAFB supports the whole input voltage and the voltage of the other DAFB is driven to zero. The fix for Configuration 2 is to add a method for power transfer between the two DAFBs. One way is to include an additional half-bridge module that connects the two DAFBs, which results in Configuration 3 (depicted in FIG. 41). FIG. 44 shows at graph 4400 the capacitors' voltage levels, and normalized phase differences ϕ, and duty cycle D (at diagram 4410) of this configuration. It can be seen that the steady state operating point is achieved and that the disturbances do cause fluctuations but ultimately the operating point is maintained. The addition of this strategically placed half-bridge allows for full controllability.

Thus, in the controllability approaches to control power transfer through stacked capacitors arranged in a stacked plurality of voltage converter cells of the voltage converter systems described herein, the configuration of series connected capacitors comprises n capacitors, with n being an integer greater than 1, and the one or more controllers comprise n−1 controllable switching modules to control power transfer between respective different capacitors pairs defined by the series connected capacitors. In such embodiments, each of the n−1 controllable switching modules may include one or more of, for example, a half-bridge circuit, a dual active half bridge circuit, a dual active full bridge circuit, and/or a dual active circuit connected to a common inductive bus connectable to other controllable switching circuits. Each of n−1 controllable switching modules is configured to derive, using a proportional integral (PI) controller, switch actuation signals based on voltage levels measured at the respective different capacitors pairs.

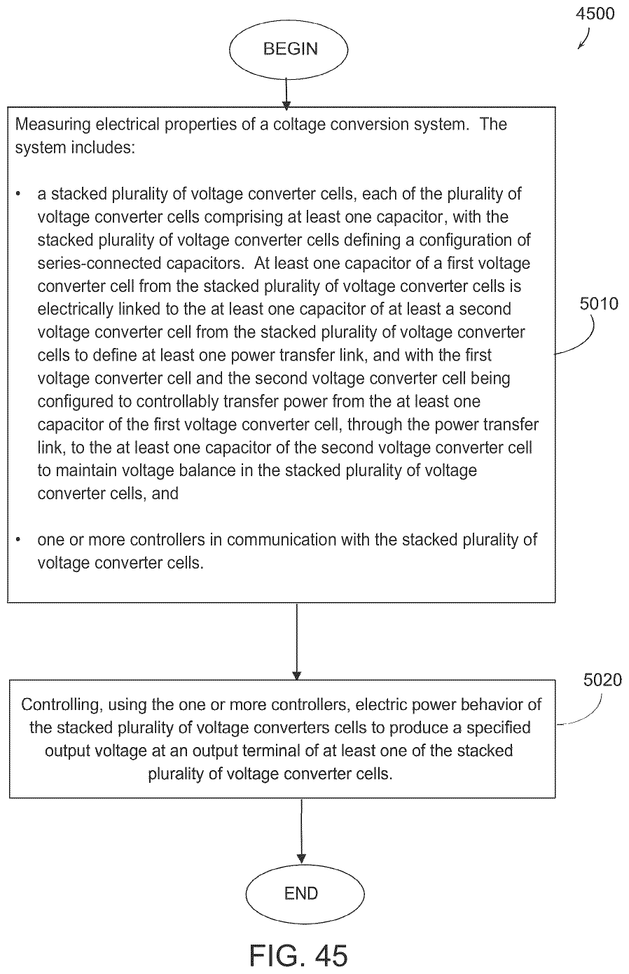

With reference now to FIG. 45, a flowchart of an example voltage conversion procedure 4500 is shown. The procedure includes measuring 4510 electrical properties (using voltmeters, amperemeter, and any other type of sensor tool to measure electrical properties) of a voltage conversion system (such as any of the voltage conversion circuits shown and discussed herein). Such a voltage conversion system includes a stacked plurality of voltage converter cells, with each of the plurality of voltage converter cells comprising at least one capacitor, with the stacked plurality of voltage converter cells defining a configuration of series-connected capacitors, and with the at least one capacitor of a first voltage converter cell from the stacked plurality of voltage converter cells being electrically linked to the at least one capacitor of at least a second voltage converter cell from the stacked plurality of voltage converter cells to define at least one power transfer link. In such an arrangement the first voltage converter cell and the second voltage converter cell are configured to controllably transfer power from the at least one capacitor of the first voltage converter cell, through the power transfer link, to the at least one capacitor of the second voltage converter cell to maintain voltage balance in the stacked plurality of voltage converter cells. The voltage conversion system (at least some of whose electrical properties are being measured) further includes one or more controllers in communication with the stacked plurality of voltage converter cells.

The procedure 4500 additionally includes controlling 4520, using the one or more controllers (e.g., switching based control circuits whose gates are actuated by actuating signal produced by control units implemented using, for example a proportional integral unit) electric power behavior of the stacked plurality of voltage converters cells to produce a specified output voltage at an output terminal of at least one of the stacked plurality of voltage converter cells.

Controlling the electric power behavior of the stacked plurality of voltage converters cells may include controlling power transfer between respective capacitors of at least two neighboring voltage converters cells, from the plurality of voltage converters cells, to maintain the voltage balance of the stacked plurality of voltage converter cells. In some examples, each of the plurality of voltage converter cells may define a configurable canonical switching cell, with the configurable canonical switching cell being one of, for example, an isolated canonical switching cell with a controllable dual active half bridge (DAHB) converter circuit, or a non-isolated canonical switching cell with a controllable half bridge (HB) converter circuit. The canonical switching cell may include configurable input and output nodes that control operability of the configurable canonical switching cell as one of, for example, a buck converter, a boost converter, or a buck/boost converter.

The stacked plurality of voltage converter cells may include one or more groupings of three degrees-of-freedom dual active half bridge (3D-DAHB) switching cells, each of the one or more groupings of 3D-DAHB switching cells comprising four capacitors. Controlling the electric power behavior of the stacked plurality of voltage converters cells may include controlling power movement at the each of the one or more groupings of 3D-DAHB switching cells between any of the respective four capacitors to achieve specified voltage levels at one or more of the four capacitors.

The configuration of series-connected capacitors may include n capacitors, with n being an integer greater than 1, with the one or more controllers including n−1 controllable switching modules to control power transfer between respective different capacitors pairs defined by the series connected capacitors. In such examples, controlling the electric power behavior of the stacked plurality of voltage converters cells may include comprises deriving, using a dedicated proportional integral (PI) controller for each of the n−1 controllable switching modules, switch actuation signals to actuate the respective switches of the each of the n−1 controllable switching modules based on voltage levels measured at the respective different capacitors pairs.

### C) Stacked Multilevel Power Delivery System to Power a Load

The discussion above focused on electrical characteristics of various topologies for multi-level converters. This section considers implementations that use multilevel power delivery systems, and discusses, by way of an example, an application for powering a load (such as a multiphase motor).

There are many applications for inverters at higher voltage levels. Traction motor drives for electric vehicles are a common example. Increasing the operating voltage reduces the driving current and the associated copper volume and weight of interconnects. This issue is even more pronounced for electric airplanes, which are highly weight-sensitive.

Modem traction motor drives tend to increase the voltage levels to achieve high powers, high efficiency, and power density with reduced cabling requirements. However, high-voltage switching devices tend to have increased on-resistance and high switching losses. Additionally, directly switching high voltage can generate significant conducted and radiated EMI.

Disclosed are systems, methods, and other implementations (including hardware, software, and hybrid hardware/software implementations) directed to a power delivery system (which may be bidirectional), comprising multiple stacks of voltage converter cells, to deliver power to an interactive system (e.g., a load) or receive power from the interactive system. Each of the stacks may be configured to define a multilevel voltage conversion topology referred to as “Manhattan” topology (as detailed above). In example embodiments, the interactive system may be a load which is a multi-phase motor, and the power delivery system may include a software-defined multilevel inverter topology for use in motor drives. Each voltage converter cell can include elementary power conversion modules such as power FETs, filtering, and local control. The cells may be aggregated by software and/or hardware to form a multilevel topology demonstrating a simplified construction of a larger converter from component cells. Each cell may include local feedback to define its input/output behavior and damp internal resonances.

The cells forming the stacks may have local feedback to improve dynamic response. The cells can be implemented in different ways, including half and full bridge circuits, and as isolated topologies such as the Dual Active Full Bridge and Dual Active Half Bridge. Non-isolated implementation may also be used. Generally, the various topologies and configurations discussed in relation to FIGS. 1-45 can be incorporated into any application that uses a stacked column of capacitors to perform controlled voltage conversion Some implementations include voltage-isolated power transfer between non-adjacent cells, which reduces current stresses in the overall converter. As will discussed below in greater detail, the output of the stack may be taken from the center, which allows large output voltage dynamic range. The output may be a constant voltage, constant current, arbitrary current, or arbitrary voltage, or constant or arbitrary power source.

The solutions described herein propose inverter topologies comprising a series stack of modular cells. Electric inverters convert direct current (DC) voltage to alternating current (AC) voltage. Such inverters are responsible for controlling the speed and torque for electric motors found in most electronic devices used in transportation and appliances. Inverters operating at high voltages are useful for electric vehicles and planes, but increasing the operating voltage (e.g., using traditional approaches) involves a reduction in the current and an increase in the volume of materials used to construct these inverters. It is also to be noted that the embodiments described herein can be used for grid-tied inverters, and/or other types of voltage conversion applications (including AC-DC, DC-DC, or AC-AC conversion applications).

The technology described herein provides a methodology for constructing a stacked, high voltage inverters from a series of sub-converters called cells. The output of the stacks may be taken from the center allowing for large output voltage and dynamic range. Moreover, the output may be a constant voltage, constant current, arbitrary current, or arbitrary voltage, or constant or arbitrary power source. The methodology described herein can improve, by using multilevel inverter, the electrical properties of any application such as electric transportation vehicles, wind turbines, solar cells, grid storage batteries and other technologies involved with renewable energy. The cells used in the proposed topologies can use fast, efficient lower voltage switches, and can be stacked to support larger voltages. This improves overall efficiency while reducing costs. The topologies described herein are shown to be effective for a three-phase motor inverter. The proposed solutions may include local feedback around each stage, avoiding unwanted resonances and simplifying the design process.

The proposed solutions thus relate to a class of power conversion topologies constructed from series stacking of smaller converter cells, that includes, in some embodiments, voltage-isolated (or non-isolated) power transfer between non-adjacent cells reducing current stresses in the overall converter. The proposed solutions allow for large output voltage dynamic range, and allow for multiple types of output voltage and current, including constant or arbitrary. The primary trade-offs in multilevel architectures are a higher component count, and increased control complexity. Different multilevel architectures have different characteristics, particularly relating to scaling the number of stages. The topology presented here has linear component count scaling and full control over all voltages down to DC. One disadvantage of the technology is the generation of large inductor currents close to the center of the stack.

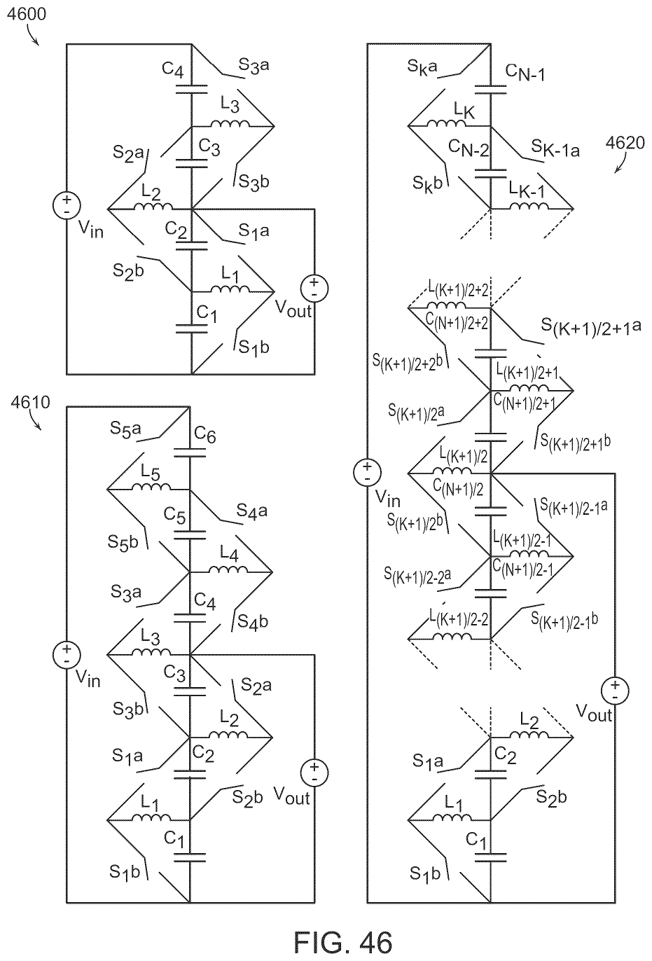

As also discussed above, the generalized topology of converters used with the various implementations detailed below is shown in diagram 4620 of FIG. 46, which includes a multilevel converter for K cells and N levels, with N=K+2. Circuit diagram 4600 illustrates a Manhattan multilevel converter with 3 cell and 5 level, while circuit diagram 4610 illustrates a Manhattan multilevel converter with 5 cells and 7 levels. In the implementations described that use multilevel converter topologies such as those illustrated in FIG. 46, the output is taken at the center node, which is defined as the node having the same number of series capacitors above it as below it. This topology is unique in that it can be expanded to an arbitrary N levels with component quantities scaling linearly. Individual cells in a converter circuit can be individually controlled using, for example, a local feedback-based controller (e.g., similar to the controllable converter implementation 1100 depicted in FIG. 11).

The stacked cell nature of the topology depicted in FIG. 46 eliminates the need for a bulk capacitance between the input and reference or between the output and reference. The series combination of the cell capacitances serves to support both the input and output nodes as well as the voltages within each cell. The individual capacitor voltages can be controlled as a function of, for example, the duty cycles of each unit cell, allowing for the voltage across the entire stack to be balanced across the cells arbitrarily. This enables the control and conversion of voltages higher than the voltage rating of any individual semiconductor or passive component. The output voltage is the sum of the capacitor voltages between the output node and reference. The ability to balance the capacitor voltages to any ratio allows rail-to-rail output.

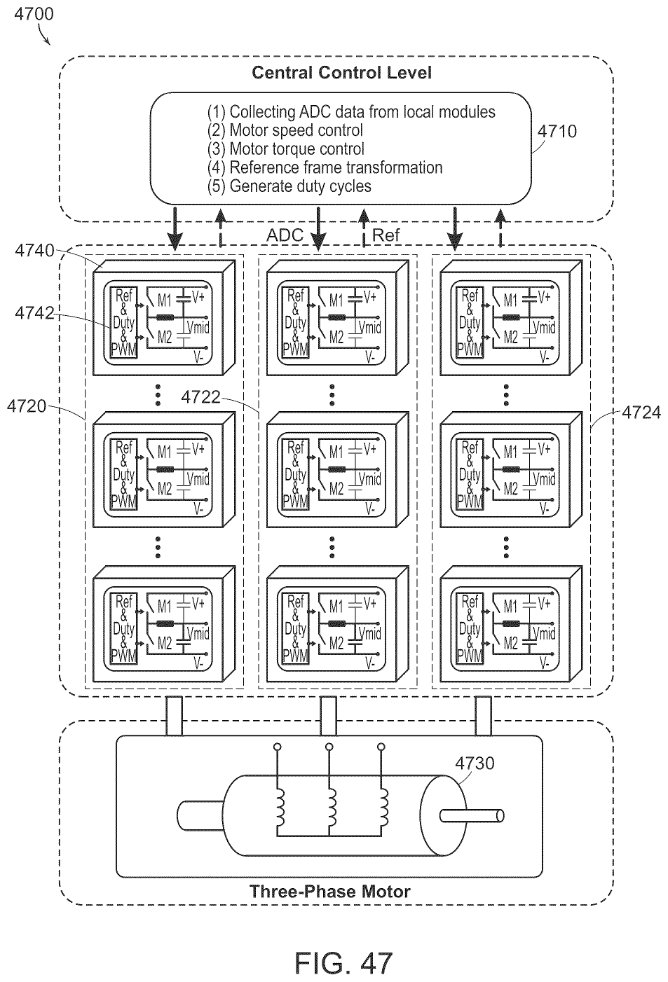

FIG. 47 is a schematic diagram of a software-defined stacked control system (architecture) 4700 for a motor application. A central controller 4710 is configured with several functions to manage the power modules. First, the ADC measures and samples voltages and currents from the local modules. Second, the motor speed and torque are controlled in the dq reference frame by Park/Clarke transformations. Third, the generated references are distributed to the local power modules for duty cycle controlled PWM. This causes each stack to act as a single, unified inverter leg.

In some embodiments, each cell may have a local feedback loop. This provides high-bandwidth control of each capacitor voltage. The cell-level controller is given a reference, which sets the desired ratio between the top and bottom port voltages. Each cell has a second-order response, and can be controlled with an inner inductor current loop and outer voltage loop, or with more advanced control techniques such as Model Predictive Control (MPC). While the system could in theory be operated without local controllers by setting all off-center cell duty cycles to 50%, this could result in undesirable behavior. The balancing of the cell voltages would hold in steady state, but the dynamic response might be poor, significantly limiting overall bandwidth. As each unit cell contains an inductor and capacitor, if the cells were operated in open loops, these components would be prone to resonating, leading to instability. Passively damping this resonance would result in unacceptable restive loss and low bandwidth. These issues are avoided by the cell controllers, which actively damp the resonance while improving dynamic response time. This requires fast switching, so the control bandwidth can be sufficiently above the resonant frequency of the cell.

Fitting individual cells with local feedback controller allows the cells to be decoupled from each other. This significantly simplifies control of the stack. The number of cells in the stack can be scaled without significant changes to the design of the cell-level or top-level controllers. This allows design reuse between inverters of different voltage requirements and economies of scale for making the unit cells. For example, as illustrated in FIG. 47, a voltage converter cell 4740 of the multi-converter 4720, includes a “Ref & Duty & PWM” controller 4742 (also referred to as a “cell controller”) to control the electrical behavior of the cell 4740 (including to control the voltage levels at the capacitors of the cell 4740 through controlled adjustment of the duty cycles for the switches M1 and M2 of the cell 1040, achieved through controlled actuation of the switches M1 and M2). The controlled interactions of the various currents provided by the three multi-level converters coupled to the motor (achieved through the central controller 4710 and the individual controllers of the voltage converter cells to vary the voltage of the various cells in a desired manner) produces the desired motor behavior by the motor 4030.

In some embodiments, duty cycle computation can be performed at the central controller 4710. However, in some embodiments, the duty cycle computation to control the duty cycles of individual cells comprising the multi-level converters (of which there are three, namely, 4720, 4722, and 4724, for the example electrical-motor-based implementation of FIG. 47) can be done at respective individual controllers controlling one or more of the converter cells. As can be seen in the example of FIG. 47, each cell of the multi-level converters may include its own dedicated and localized controller (e.g., a PWN controller) to control the respective duty cycles for the switching devices of each cell. In some embodiments, the system 4700 may be implemented without a central controller, but with the individual cells each comprising their own respective controllers (be it a processor-based controller, a closed-loop controller, or otherwise). In some embodiments, other arrangement of multiple controllers to control the voltages of the multi-level conversion system may be used (e.g., an individual controllers for cells/nodes with adjustable duty cycles, with some or all of the other cells having fixed duty cycles controlled by a central/global controller). It is noted that in various examples, the proposed control architecture depicted in FIG. 47 may be used, in whole or in part, to control the converters discussed in relation to FIGS. 1-45 and/or any load connected to such converters.

Implementations such as the system illustrated in FIG. 47 may use the stacked topology (illustrated in FIG. 46) as an inverter. The centered output can swing from rail to rail while maintaining evenly distributed voltage stresses above and below. This voltage sharing allows the use of switches with lower voltage rating, as each must support only a fraction of the input voltage. MOSFET conduction loss grows faster than linearly with blocking voltage (and switching speed reduces), so overall conduction loss can be reduced by sharing voltage between several low-voltage switches rather than using a single high-voltage switch. For high-current applications, the lower device rating can allow the use of Silicon or Silicon Carbide MOSFETs, rather than IGBTs. IGBTs can have very low conduction loss at higher blocking voltage, but suffer from large turn-off “tail current” loss due to slow carrier recombination.

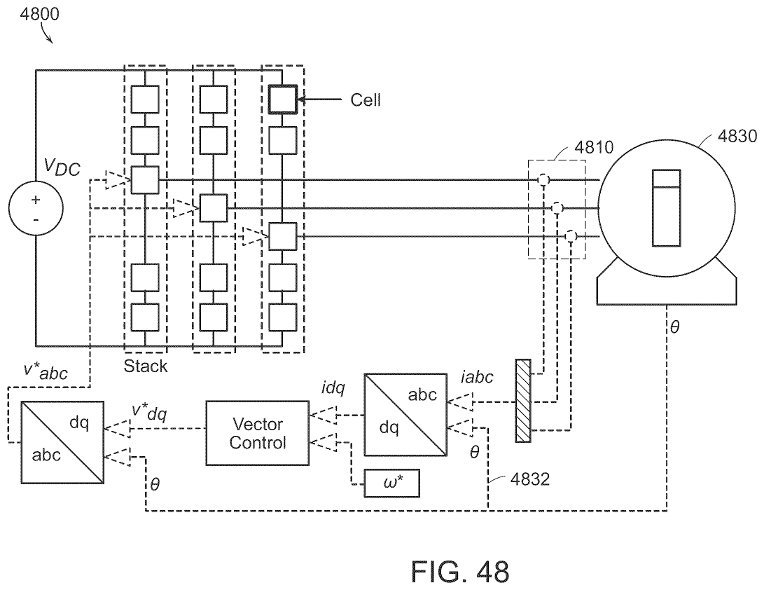

In an inverter application, the stack output can be controlled to follow a sinusoidal voltage or current reference. This reference may come from a top-level stack controller (which may be implemented similarly to the controller 4710 depicted in FIG. 47). FIG. 48 is a schematic diagram of an example top-level stack controller 4800 to control operation of a motor. The stack controller 4800 measures the inverter output (e.g., the currents or voltages at the outputs of the center cells of each stack, as measured at the electrical points within box 4810, powering the motor 4830) and any other desired variables (such as angle and speed for a motor drive, represented by the arrow 4832), and computes a reference input for the stack. The reference (e.g., represented by v_{abc}) directly controls only the center (output) cell. In various examples, the other cells are set to maintain a 1:1 voltage ratio between their top and bottom capacitors. Modulating the center stage reference trades voltage between the middle two capacitors. These voltage changes then propagate up and down the stack as the other cells enforce the 1:1 ratio. The cells adjacent to the middle cell mirror its voltages, and then the next cells, until all cells mirror the center cell. This ensures that all the capacitors above the output share the same voltage, as do all those below the output. The overall conversion ratio of the stack therefore matches the conversion ratio of the center cell. The fast local feedback loops and capacitive energy storage on each cell ensure that voltage balancing is maintained through transients. This allows the stacked low voltage devices to safely share the bus voltage.

The voltage sharing scheme above is simple to implement, but is not the only option. When the output voltage is not at either extreme, the cell voltages can be unbalanced while still remaining within their voltage rating. This extra flexibility can be leveraged to reduce inductor currents and the associated loss and component size. Taking advantage of this optimization requires a more complex control scheme. Rather than only controlling a single reference (to control the center cell), the controller would need to provide a reference to each cell. To save computation time on the controller, optimum reference values can be precomputed offline. The controller would then store a lookup table mapping the desired conversion ratio to the set of optimized cell voltage ratios.

To design a high-performance compensator to control the output of the inverter, it is useful to first construct a dynamic model of the stack. This is done by first describing the cell input/output behavior, then building the stack model from the cell models. In embodiments in which the cells each have their own local feedback control, it is the closed-loop cell transfer functions that are of interest. The local feedback loops make the individual cells well behaved, allowing the closed-loop behavior to be approximately described by simplified models. This simplifies the modeling of the stack dynamics significantly. This also allows abstraction of the details of the cell controller. Substitution of one cell control scheme for another should only affect parameter values of the simplified cell model, but not change its structure.

The construction of the dynamic model starts with the center cell, which is the only stage, in various embodiments, which is directly controlled by the top-level controller. The center cell has its input and output port loaded by the impedance of the rest of the stack. It will therefore be necessary to find this impedance. Once it is known, a transfer function can be constructed to model the reference-to-V_{bot} behavior of the center stage (and the complementary reference-to-Vₜₒₚ as well).

A transfer function for the stack can be constructed from two cell transfer functions. The first is Gᵣ(s), the reference-to-bottom voltage of the center cell. The 2^{nd} is Gᵥ(s), the top to bottom voltage transfer function of an off-center cell.

Thus:

$${G}_{r} ( s ) = \frac{{v}_{bot}}{{v}_{top}} , \qquad ( C1 )$$

$${G}_{v} ( s ) = \frac{{v}_{bot}}{{v}_{ref}} ,$$

The exact expressions for these transfer functions depend both on the specific implementation of the local cell feedback, and on the impedance loading each port. However, as each cell is a 2^{nd} order converter, if it is assumed that the local controller is well designed (high bandwidth with damped resonances), both transfer functions can be approximated in the following form. Q is the quality factor, which will be small for a well-designed cell. ω_{BW} is the closed-loop bandwidth of the cell in rad/s. Accordingly:

$$G ( s ) = \frac{1}{( 1 + \frac{s}{Q {ω}_{BW}} + \frac{{s}^{2}}{{ω}_{BW}^{2}} )} \qquad ( C2 )$$

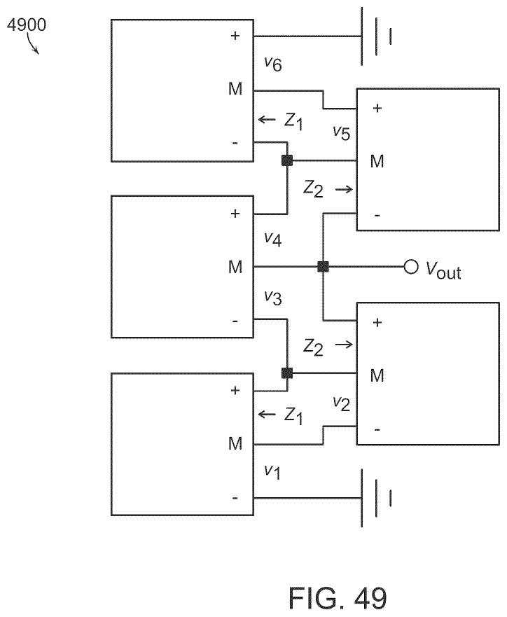

The overall converter transfer function is then built from the cell transfer functions. Gᵣ(s) defines the lower port voltage of the middle cell (v₃ in the example stacked converter configuration 4900 of FIG. 49). This is then the input to the next cell down, which has its bottom voltage defined by Gᵥ(s). Therefore, in FIG. 49, v₂(s)=Gᵥ(v₃). This process continues until the bottom of the stack is reached. After simplifying, for a cell n cells below the center, the bottom voltage vₙ(s) is:

$${v}_{n} ( s ) = {G}_{v}^{n} {G}_{r} {v}_{ref} \qquad ( C3 )$$

Finally, the output voltage is found by summing the port voltages from ground, namely:

$${V}_{out} = {v}_{1} + {v}_{2} + … + {v}_{n / 2} \qquad ( C4 )$$

Plugging Equation (C3) into Equation (C4) and simplifying gives:

$$\frac{{v}_{out}}{{v}_{ref}} = {G}_{r} ( {G}_{v}^{n} + {G}_{v}^{( n 1 )} + … + {G}_{v} + 1 ) \qquad ( C5 )$$

The impedances in the stack can also be approximated with a simple model by assuming that the local cell controllers are well designed, with high bandwidth and damped resonance. Consider a cell with no loading impedance other than the two internal capacitors. At low frequency, the cell feedback forces the two port voltages to match. Looking into the top port, the two capacitors appear in parallel as any change to the top capacitor voltage is mirrored on the bottom capacitor. Thus, the low-frequency asymptote of the impedance is a capacitor of value 2 C. This models the cells at the top and bottom of the stack. As the cell is well regulated, the transition between these asymptotic is smooth and occurs at the cell closed-loop bandwidth, where it appears approximately as a zero-pole pair. This gives a model of the input impedance of the top and bottom cells:

$${Z}_{in , end} = \frac{1}{s 2 C} ‖ ( 1 + \frac{s}{{ω}_{BW}} ) \qquad ( C6 )$$

The same argument extends to include any loading impedance Z_{load} connected to the bottom port, in which case the input impedance is 2 C in parallel with Z_{load}. This leads to the approximate impedance of:

$${Z}_{in} = [ ( \frac{1}{sC} ‖ {Z}_{load} ) ( 1 + \frac{s}{{ω}_{BW}} ) ] ‖ ( 1 + \frac{s}{{ω}_{BW}} ) \qquad ( C7 )$$

The next step is to solve for the input impedance of the half-stacks (which load the center cell). The bottom cell has impedance Z₁, calculated in Equation (C6). The next cell up has impedance Z₂, calculated using Equation (C7), where Z_{load}=Z₁. This pattern is repeated until the center cell is reached. By symmetry, cells of equal distance from the center have the same input impedance, so there is no need to separately calculate the impedances in the top half of the stack.

Thus, in various embodiments, a power delivery system is provided that includes multiple stacks of voltage converter cells, with each of the multiple stacks comprising one or more voltage converter cells comprising at least one energy storage device. In some examples, the one or more voltage converter cells comprising the at least one energy storage device may include a series arrangement of two capacitors inter-connected at a single common terminal. The power delivery system further includes one or more controllers in communication with the multiple stacks of voltage converter cells, the one or more controllers configured to control electric power behavior of the respective one or more voltage converter cells of the multiple stacks to cause controlled delivery of electric power by the multiple stacks of voltage converter cells, and an interactive system electrically connected to outputs of the multiple stacks of voltage converter cells, the multiple stacks of voltage converter cells configured for controllable bidirectional power flow to cause the multiple stacks of voltage converter cells to controllably deliver or receive electric power to or from the interactive system.

In some examples, the one or more controllers may include a central controller in electrical communication with the multiple stacks of voltage converter cells to control electrical currents produced by the multiple stacks of voltage converter cells to power the interactive system.

In some embodiments, the interactive system may include a multi-phase motor, with each of the multiple voltage converter stacks providing a respective phased current for one of multi-phase inputs of the multi-phase motor. In such embodiments, the one or more controllers may include a central controller configured to control duty cycles of one or more switching devices in the multiple stacks of voltage converter cells to produce the phased currents that result in one or more of a specified motor speed or a specified motor torque. In some examples, the one or more controllers may include an individual cell controller for each voltage converter cell of the multiple stacks of voltage converter cells, with the each voltage converter cell including two capacitors inter-connected at a common terminal. Each converter cell may include a switch-based control circuitry to control one or more of, for example, voltage level at the two capacitors and/or duty cycle of control signals to actuate respective switches of the switch-based control circuitry. The switch-based control circuitry and the capacitor arrangement for the each converter cell may be implemented according to one of, for example, a buck-boost converter configuration, a half-bridge converter configuration, a dual active half bridge converter configuration, a dual active full bridge converter configuration, or a dual active circuit connected to a common inductive bus connectable to other controllable switching circuits.

In some embodiments, the outputs of the multiple stacks of voltage converter cells may be provided at respective terminals of central converter cells of each of the multiple stacks of the voltage converter cells, with each of the respective terminals of the central cells being connected to a different one of the multi-phase inputs of the multi-phase motor. In such embodiments, the one or more controllers may include a central controller and respective individual controllers for each converter cell of the multiple stacks of voltage converter cells, with the central controller being configured to compute adjustable reference voltages based on a torque or a speed of the multi-phase motor, and based on measured electrical properties of the outputs of the multiple stacks of voltage converter cells, the computed adjustable references voltage being used by controllers of the center cells of the multiple stacks of voltage converter cells to adjust the output currents of the multiple stacks of converter cells. Individual controllers of non-central converter cells of the multiple stacks of converter cells may be configured to maintain a voltage ratio of 1:1 for the respective voltages of the capacitors of each of the non-central converter cells.

In some examples, at least one of the multiple stacks of voltage converter cells may include a plurality of voltage converter cells arranged as a stacked cascade of voltage converter cells, with each voltage converter cell in the at least one of the multiple stacks of voltage converter cells comprising two capacitors and sharing at least one capacitor with a neighboring voltage converter cell. The one or more controllers may include at least one controller configured to independently control the voltage levels of the at least one energy storage element of each of the plurality of voltage converter cells in the at least one of the multiple stacks of the voltage converter cells, to achieve a voltage balance for the plurality of voltage converter cells.

The one or more controllers may be configured to controllably actuate switching devices regulating the electric voltage levels of the one or more voltage converter cells of the multiple stacks of voltage converter cells, including to determine an adjustable duty cycle behavior for the switching devices of at least one converter cell of each of the multiple stacks of voltage converter cells.

To study the behavior of a motor drive connected to a stacked controller such as the one depicted in FIG. 46, a simulation has been conducted to demonstrate the topology's use as a motor drive. Three copies of the 3-cell topology and a top-level controller were modelled. The setup used was similar to the arrangement shown in FIG. 48. The system tracked a speed profile ω_{ref} and responded to bidirectional torque disturbances. The topology successfully produced the required waveforms, and the motor tracked the speed profile while rejecting the torque disturbances.

In various examples, the voltage converter system implemented in the proposed solutions may be adapted for bidirectional functionality. In such examples, the current in the converter can flow in both directions, with the one or more controllers controlling the direction of current flow (which can be changed/adjusted in real-time), and the general electric behavior of the converter system. Thus, by controlling current flow direction, the converter systems described herein can be configured to implement a step down DC/DC becomes a step up converter, or an AC/DC rectifier.

In further example embodiments, the voltage converter system, with its controllable bidirectionality functionality, may be adapted for motor regeneration and breaking. A motor drive can be used to slow down the motor, and capture the mechanical energy. The current direction can be reversed, and energy flows back from the motor into the DC bus, rather than being lost to heat. An example is breaking in an electric vehicle. This property can be used on any system in which the topology described herein is used as a motor drive.

In another example embodiment, the voltage converter system, with its controllable bidirectionality functionality, may be adapted for motor regeneration and breaking Step-down transformer elimination. Specifically, there are applications which require high power, high voltage DC. Normally (in the US) utility power is distributed to industrial buildings at about 13 kV AC, and is then stepped down to 480 AC for high power loads. High voltage DC systems then have to step up and rectify the 480 V to get to high voltage DC. It could be beneficial to connect the system directly to the 13 kV AC line. This eliminates the large 13 kV to 480 V, 60 Hz transformer and reduces the step-up needed. This system could act as the high-voltage AC/DC converter for such applications.

In additional example embodiments, the voltage converter system may be adapted for high-voltage, high power DC applications. For example, the voltage converter system can be used for high power RF (radio frequency) systems that use vacuum tubes to scale better to high power (pulsed systems, where the peak to average power may be 1,000×, require high-voltage DC, often in the 10-100 kV range). Other applications where the voltage converter system described herein may be used include high power RF include radio communications, RADAR transmitters, fusion plasma heating (and fusion type applications), particle accelerators, wind turbines, and so on.

In yet another example, the voltage converter system described herein may be used for HVDC transmission. Power grids can be connected with high-voltage DC links. This eliminates the need to synchronize the two grid frequencies. DC links are also more efficient for very long transmission lines, as they have no AC losses (which scale with length).

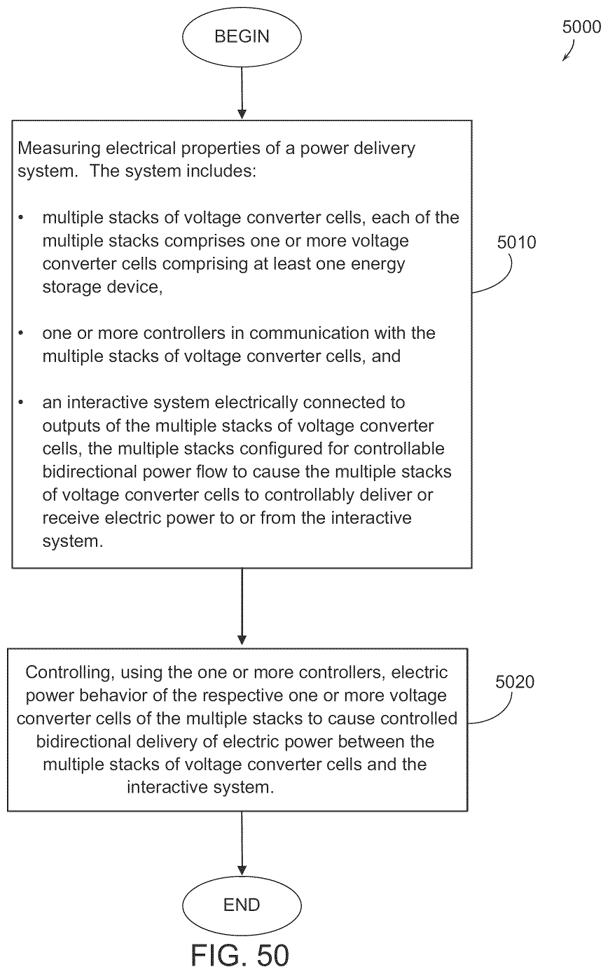

With reference next to FIG. 50, a flowchart of an example power delivery procedure 5000 is provided. The procedure 5000 includes measuring 5010 electrical properties (e.g., using a voltmeter, an amperemeter, or any other sensor device measuring a property indicative of electrical behavior of the multiple stacks of voltage converter cells and/or of the load) of a power delivery system that includes multiple stacks of voltage converter cells, each of the multiple stacks comprises one or more voltage converter cells comprising at least one energy storage device, one or more controllers in communication with the multiple stacks of voltage converter cells, and an interactive system electrically connected to outputs of the multiple stacks of voltage converter cells, the multiple stacks configured for controllable bidirectional power flow to cause the multiple stacks of voltage converter cells to controllably deliver or receive electric power to or from the interactive system. The procedure 5000 further includes controlling 5020, using the one or more controllers, electric power behavior of the respective one or more voltage converter cells of the multiple stacks to cause controlled bidirectional delivery of electric power between the multiple stacks of voltage converter cells and the interactive system. In some examples, the one or more voltage converter cells comprising at least one energy storage device may each include a series arrangement of two capacitors inter-connected at a single common terminal.

In some embodiments, the interactive system may include a multi-phase motor, with each of the multiple voltage converter stacks providing a respective phased current for one of multi-phase inputs of the multi-phase motor. In such embodiments, controlling the electric power behavior of the respective one or more voltage converter cells may include controlling electrical currents produced at outputs of the multiple stacks of voltage converter cells to provide respective phased currents to the multi-phase inputs of the multi-phase motor. Controlling the electrical currents may include controlling duty cycles of one or more switching devices in the multiple stacks of voltage converter cells to produce the phased currents that result in one or more of a specified motor speed or a specified motor torque.

Each converter cells may include two capacitors connected in series, and a switch-based control circuitry to control power transfer through the two capacitors. In such examples, controlling the electrical currents may include individually controlling each converter cell by controllably actuating the respective switch-based control circuitry of the each converter cell to control one or more of, or example, voltage level at the two capacitors, and/or duty cycle of control signals to actuate respective switches of the switch-based control circuitry. The switch-based control circuitry and the two series capacitors for the each converter cell may be implemented according to one of, for example, a buck-boost converter configuration, a half-bridge converter configuration, a dual active half bridge converter configuration, a dual active full bridge converter configuration, or a dual active circuit connected to a common inductive bus connectable to other controllable switching circuits. Controlling the electrical currents may include computing adjustable reference voltages based on a torque or a speed of the multi-phase motor, and based on measured electrical properties at the outputs of the multiple stacks of voltage converter cells, adjusting voltage levels at central converter cells of the multiple stacks of voltage converter cells based on the computed adjustable reference voltages, and maintaining voltage ratio levels between the respective capacitors of each non-central converter cell of the multiple stacks of voltage converter cells at a ratio of 1:1.

### D) Additional Embodiments

Performing the various techniques and operations described herein may be facilitated by a controller device (e.g., a processor-based computing device). Such a controller device may include a processor-based device such as a computing device, and so forth, that typically includes a central processor unit or a processing core. The device may also include one or more dedicated learning machines (e.g., neural networks) that may be part of the CPU or processing core. In addition to the CPU, the system includes main memory, cache memory and bus interface circuits. The controller device may include a mass storage element, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, the implementation of various controllable switching circuits (e.g., HB, DAHB, DAFB, etc.) to control power transfer between capacitors of a stacked voltage conversion topology (e.g., one implemented using a stacked series of capacitors). The storage device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

1. A voltage converter system comprising:
two or more Active Half Bridge (AHB) converter circuits, each of the two or more AHB converter circuits connected to one or more windings of a transformer, with each AHB converter circuit including one or more switches and one or more energy storage devices; and
one or more controllers to control electrical behavior of the two or more AHB converter circuits according to normalized switching functions representing switching states of switches of the two or more AHB converter circuits.

2. The voltage converter system of claim 1, wherein the two or more AHB converter circuits implement a dual active half bridge (DAHB) converter circuit with a primary side and a secondary side separated from the primary side by the transformer, the primary side comprising two primary side capacitors, two primary side controllable switching devices, and the secondary side comprising two secondary side capacitors, and two secondary side switching devices.

3. The voltage converter system of claim 2, wherein the electrical behavior of the DAHB converter circuit includes voltages and currents behavior for the two primary side capacitors and the two secondary side capacitors, wherein the voltages and currents behavior, and control signals to control behavior of the DAHB converter circuit, are computed as functions of values of the normalized switching functions.

4. The voltage converter system of claim 1, wherein the normalized switching functions define switching sequences for the two or more AHB converter circuits, and wherein the one or more controllers are configured to actuate the switches of the two or more AHB converter circuits according to the switching sequences.

5. The voltage converter system of claim 4, wherein the switching sequences are represented in permutation matrices.

6. The voltage converter system of claim 4, wherein the one or more switching sequences for the two or more AHB converter circuits are defined by duty cycles for switches of the two or more AHB converter circuits, and by adjustable phase shifts between switching events for the switches.

7. The voltage converter system of claim 1, wherein each of the two or more AHB converter circuits is represented as two half bridge converter circuits and a central dual active half bridge separating the two half bridge converter circuits, with the central dual active half bridge configured to transfer power across a transformer of the central dual active half bridge.

8. The voltage converter system of claim 1, further comprising one or more sensors deployed in the two or more AHB converter circuits to measure electrical characteristics of components of the two or more AHB converter circuits;
wherein the one or more controllers to control electrical behavior of the two or more AHB converter circuits are configured to:
determine a switching mode, from a plurality of switching modes under which the two or more AHB converter circuits operate, based, at least in part, on feedback data measured by the one or more sensors, the feedback data representative of electrical behavior of the two or more AHB converter circuits.

9. The voltage converter system of claim 8, wherein the one or more controllers to control electrical behavior of the two or more AHB converter circuits are further configured to:
derive expected electrical behavior of the two or more AHB converter circuits for a next period of operation of the two or more AHB converter circuits based, at least in part, on the determined switching mode for the two or more AHB converter circuits and at least some of the feedback data.

10. The voltage converter system of claim 9, wherein the one or more controllers to control electrical behavior of the two or more AHB converter circuits are further configured to:
determine duty cycle behavior and/or phase shift behavior for the switches during the next period of operation of the two or more AHB converter circuits based on the derived expected electrical behavior of the two or more AHB converter circuits.

11. The voltage converter system of claim 8, wherein the feedback data representative of the electrical behavior of the two or more AHB converter circuits comprises one or more of: voltage levels at one or more capacitors included in a circuit comprising the two or more AHB converter circuits, or current passing through an inductor included in the circuit comprising the two or more AHB converter circuits.

12. A voltage conversion method comprising:
measuring electrical characteristics of a voltage conversion system comprising:
two or more Active Half Bridge (AHB) converter circuits, each of the two or more AHB converter circuits connected to one or more windings of a transformer, with each AHB converter circuit including one or more switches and one or more energy storage devices, and
one or more controllers coupled to the two or more AHB converter circuits; and
controlling, using the one or more controllers, electrical behavior of the two or more AHB converter circuits according to normalized switching functions representing switching states of switches of the two or more AHB converter circuits.

13. The method of claim 12, wherein controlling the electrical behavior of the two or more AHB converter circuits comprises:
determining a switching mode, from a plurality of switching modes under which the two or more AHB converter circuits operate, based, at least in part, on feedback data measured by one or more sensors, the feedback data representative of the measured electrical characteristics behavior of the two or more AHB converter circuits.

14. The method of claim 13, wherein controlling the electrical behavior of the two or more AHB converter circuits further comprises:
deriving expected electrical behavior of the two or more AHB converter circuits for a next period of operation of the two or more AHB converter circuits based, at least in part, on the determined switching mode for the two or more AHB converter circuits and at least some of the feedback data.

15. The method of claim 14, wherein controlling the electrical behavior of the two or more AHB converter circuits further comprises:
determining duty cycle behavior and/or phase shift behavior for the switches during the next period of operation of the two or more AHB converter circuits based on the derived expected electrical behavior of the two or more AHB converter circuits.

16. The method of claim 13, wherein the feedback data representative of the electrical behavior of the two or more AHB converter circuits comprises one or more of: voltage levels at one or more capacitors included in a circuit comprising the two or more AHB converter circuits, or current passing through an inductor included in the circuit comprising the two or more AHB converter circuits.

17. The method of claim 12, wherein the two or more AHB converter circuits implement a dual active half bridge (DAHB) converter circuit with a primary side and a secondary side separated from the primary side by the transformer, the primary side comprising two primary side capacitors, two primary side controllable switching devices, and the secondary side comprising two secondary side capacitors, and two secondary side switching devices.

18. The method of claim 12, wherein the normalized switching functions define switching sequences for the two or more AHB converter circuits, and wherein controlling the electrical behavior of the two or more AHB converter circuits further comprises:
actuating the switches of the two or more AHB converter circuits according to the switching sequences.

19. The method of claim 18, wherein the switching sequences are represented in permutation matrices.

20. The method of claim 12, wherein each of the two or more AHB converter circuits is represented as two half bridge converter circuits and a central dual active half bridge separating the two half bridge converter circuits, with the central dual active half bridge configured to transfer power across a transformer of the central dual active half bridge.

21.-60. (canceled)
